(19) United States
(12) Patent Application Publication
(10) Pub. No.: US 2018/0051505 A1
(43) Pub. Date: Feb. 22, 2018

(54) Glass Door Apparatus

(71) Applicants: Teufelbeschlag GmbH, Turkenfeld (DE); Nana Wall Systems, Inc., Corte Madera, CA (US)

(72) Inventors: Christian Steigerwald, Greifenberg (DE); Alexandra Steigerwald, Greifenberg (DE)

(21) Appl. No.: 15/680,645

(22) Filed: Aug. 18, 2017

(30) Foreign Application Priority Data
Aug. 18, 2016 (DE) 10 2016 115 362.1

(51) Int. Cl. E06B 3/36; E06B 5/20; E06B 3/02; E06B 7/23; E06B 3/06; E06B 3/54

(52) U.S. Cl. CPC E06B 3/365; E06B 5/20; E06B 3/549; E06B 7/2301; E06B 3/06; E06B 3/02

(57) ABSTRACT

The invention provides a glass door apparatus with a right and a left glass door leaf (10, 100) and functional end caps (40a, 40b, 240a, 240b), which respectively have a protrusion (52a, 52b, 252a, 252b), which, with respect to a lateral front face of the functional end cap protrudes laterally outwards in a manner at least substantially parallel to a pane face of a glass pane of one glass door leaf as well as away from said glass pane, and/or a cavity (54a, 54b, 254a, 254b) which, with respect to said lateral front face, protrudes laterally inwards in a manner is at least substantially parallel to said pane face and towards said glass pane and which, in the opposite direction, opens laterally outwardly, and wherein, in the closed state of glass door apparatus, the protrusion and/or the cavity is/are overlapped with a complementary counterpiece of the other glass door leaf.

This application claims priority under the Paris Convention to German Patent Application No. 10 2016 115 362.1 filed on Aug. 18, 2016, which application is incorporated by reference.

### I. TECHNICAL FIELD

The present invention relates to a glass door apparatus for effectively preventing sound, wind and humidity to penetrate in an inner area, which is separated by the glass door apparatus from an outer area.

### II. BACKGROUND OF THE INVENTION

Glass door apparatuses (also called “whole glass installations”) are generally composed of glass door leaves with glass panes and floor-side and ceiling-side frame parts, which are connected to the glass panes and are used for hanging and/or guiding the glass panes on the ceiling and/or on the floor. Such glass door apparatuses are used, for example, for completely or partially delimiting a first area (for instance an inner area inside a building) from a second area (for instance an outer area outside the building).

It is desirable that the glass door apparatus in a state, in which it is closed (or at least partially closed) prevents penetration of noise from the second area into the first area in a possibly effective way. In particular, in cases where the glass door apparatus delimits an outer area from an inner area, it is also desirable that the glass door apparatus in above said closed state effectively prevents penetration of humidity (for instance hitting rain and similar) as well as wind or air currents (and therefore dust and smells, for example). There is also generally a continuous need for further improving the durability and reliability of glass door apparatuses.

### III. SUMMARY OF THE INVENTION

According to the invention, in one aspect, a glass door apparatus is provided, in which the penetration of sound, humidity and wind through the glass door apparatus is prevented.

According to this aspect of the present invention, a glass door apparatus is provided with: a right glass door leaf, which comprises a first (for instance rectangular) glass pane (or first glass plate), which defines a pane face, and which has a left glass pane edge, which extends at least substantially in a vertical direction, an upper glass pane edge, which extends at least substantially in a horizontal direction, and a lower glass pane edge, which extends at least substantially in a horizontal direction, an upper first glass door leaf frame part, which is engaged with the upper glass pane edge of the first glass pane, and a lower first glass door leaf frame part, which engages the lower glass pane edge of the first glass pane, and a left glass door leaf, which has a second (for instance rectangular) glass pane (or second glass plate), which defines a pane face and which comprises a right glass pane edge, which extends at least substantially in a vertical direction and which, in a closed state of the glass door apparatus, is near the left glass pane edge of the first glass pane, wherein the second glass pane further has an upper glass pane edge, which extends at least substantially in a horizontal direction, and has a lower glass pane edge, which extends at least substantially in a horizontal direction, wherein at least one of the upper first glass door leaf frame part and the lower first glass door leaf frame part has an oblong first frame body, defining a longitudinal axis, extends with its longitudinal axis along the glass pane edge belonging to the respective glass door leaf frame part of the upper and lower glass pane edges of the first glass pane and which has a left frame body longitudinal end, and has a first functional end cap, which covers the left frame body longitudinal end of the first frame body and which is horizontally positioned at the height of the left glass pane edge of first glass pane, defines a lateral outwards exposed front face (or lateral outwards exposed end face), and has a first protrusion, which, with respect to the lateral front face of first functional end cap, protrudes laterally outwards in a manner at least substantially parallel to the pane face of first glass pane and in a direction away from the first glass pane, and/or has a first cavity, which, with respect to the lateral front face of first functional end cap, protrudes laterally inwardly in a manner at least substantially parallel to pane face and in a direction towards the first glass pane (i.e., towards the inside of the functional end cap) and which, in the opposite direction, opens laterally outwards, and wherein, in the closed state of the glass door apparatus, the first protrusion and/or the first cavity of first functional end cap is/are overlapping with a respective complementary counterpiece of the left glass door leaf.

When, in the present application, reference is made to “at least substantially horizontal/vertical/parallel”, this includes, with reference to orientation and/or extension of parts of the glass door apparatus, small deviations, in particular small chamfers/inclined positions of these components.

Further, the upper first glass door leaf frame part may comprise an oblong upper first frame body, which defines a longitudinal axis, which extends with its longitudinal axis along the upper glass pane edge of first glass pane and has a left frame body longitudinal end, and a upper first functional end cap, which covers the left frame body longitudinal end of upper first frame body and which is horizontally positioned at level with the left glass pane edge of first glass pane, defines a lateral outwards exposed front face, and has a first protrusion which, with respect to lateral front face of upper first functional end cap, protrudes laterally outwards in a manner at least substantially in parallel to pane face of first glass pane as well as in a direction away from the first glass pane, and/or has a first cavity, which, with respect to the lateral front face of first upper functional end cap, protrudes laterally inwardly in a manner at least substantially in parallel to pane face as well as in a direction towards the first glass pane (i.e., towards the inside of the functional end cap) and which, in the opposite direction, opens laterally outwards.

Furthermore, the lower first glass door leaf frame part may also comprise an oblong lower first frame body, which defines a longitudinal axis, which extends with its longitudinal axis along the lower glass pane edge of first glass pane and has a left frame body longitudinal end, and a lower first functional end cap, which covers the left frame body longitudinal end of the lower first frame body and which is horizontally positioned at level with the left glass pane edge of first glass pane, defines a lateral outwards exposed front face, and has a first protrusion, which, with respect to the lateral front face of lower first functional end cap, protrudes laterally outwards in a manner at least substantially parallel to the pane face of first glass pane and in a direction away from the first glass pane, and/or has a first cavity, which, with respect to the lateral front face of first functional end cap, protrudes laterally inwardly in a manner at least substantially parallel to pane face and in a direction towards the first glass pane (i.e., towards the inside of the functional end cap) and which, in the opposite direction, opens laterally outwards, and wherein, in the closed state of the glass door apparatus, the first protrusion and/or the first cavity of first functional end cap (for instance the upper and lower first functional end caps) may overlap with a respective complementary counterpiece of the left glass door leaf.

The left glass door leaf may have an oblong weather strip (for instance of at least substantially transparent and UV-resistant material), which defines a weather strip longitudinal axis and which is positioned on the right glass pane edge of the second glass pane and extends with its weather strip longitudinal axis along the right glass pane edge of the second glass pane and which has a profiled cross section, wherein the profiled cross section has a first leg, which extends, at least substantially from the right glass pane edge of second glass pane in a manner at least substantially in parallel to the pane face of the second glass pane, laterally away from the second glass pane, so that, in the closed state of the glass door apparatus, the first leg overlaps the left glass pane edge of the first glass pane and by forming a corresponding complementary counterpiece of left glass door leaf, engages the first cavity of respective first functional end cap.

The weather strip may have an h-profile cross section, wherein the h-profile cross section has a central transverse web, which has a first and second transverse web end, wherein the first leg extends from the first transverse web end, a second leg, which extends from the first transverse web end of transverse web in opposite direction to the first leg, and overlaps the right glass pane edge of the second glass pane, and has a third leg, which extends from the second transverse web end in the same direction of the second leg, and overlaps the right glass pane edge of the second glass pane (therefore interacting in an overlapping and adjacent way with a inner wall of first cavity).

The respective (for instance the upper and/or lower) first functional end cap may also have a second cavity, which, with respect to the lateral front face of respective first functional end cap, protrudes laterally inwardly in a manner at least substantially in parallel to the pane face of first glass pane as well as in a direction towards the first glass pane (i.e., towards the inside of the functional end cap) and opens, in the opposite direction, laterally outwards and which, with respect to the pane face of first glass pane, is disposed opposite the first cavity of the respective first functional end cap, so that a first functional block may be formed between the first cavity and the second cavity of the respective first functional end cap, with which functional block, in the closed state of the glass door apparatus, the complementary counterpiece associated with the first cavity of respective first functional end cap may interact in an overlapping and adjacent way.

The first functional block may have a lateral outward exposed functional block front face, which may be aligned with a lateral front face of left glass pane edge of the first glass pane and may form an extension of the lateral front face of left glass pane edge (for instance forming a gap with the lateral front face of left the glass pane edge of glass pane or because the front face of functional block is aligned with the lateral front face of left glass pane edge).

The weather strip may optionally have an H-profile cross section, which (in addition to above said first to third legs) has a fourth leg, which extends from the second transverse web end in an opposed direction with respect to the third leg, and which, in the closed state of the glass door apparatus, overlaps the left glass pane edge of the first glass pane and which, by forming a further corresponding complementary counterpiece of the left glass door leaf, engages the second cavity of the respective first functional end cap (and therefore interacts, for example, with an inner wall of second cavity in an overlapping and adjacent way).

The weather strip may extend at least substantially along the major part of the longitudinal extension or along the entire longitudinal extension of the right glass pane edge of second glass pane. In the closed state of the glass door apparatus the weather strip may also extend at least substantially along the major part of the longitudinal extension or along the entire longitudinal extension of the left glass pane edge of the first glass pane. For instance, the second and third leg may extend at least substantially along the major part of the longitudinal extension or along the entire longitudinal extension of the right glass pane edge of the second glass pane. Moreover, the first and/or the fourth leg may at least substantially extend along the major part of the longitudinal extension or along the entire longitudinal extension of the left glass pane edge of the first glass pane. The first to fourth leg and the transverse web of the weather strip may also have the same length in the vertical direction.

The left glass door leaf may also comprise an upper second glass door leaf frame part, which engages the upper glass pane edge of the second glass pane, and a lower second glass door leaf frame part, which engages the lower glass pane edge of the second glass pane. The upper second glass door leaf frame part may comprise an oblong upper second frame body, which defines a longitudinal axis, which extends with its longitudinal axis along the upper glass pane edge of the second glass pane and a right frame body longitudinal end, and a upper second functional end cap, which covers the right frame body longitudinal end of the upper second frame body and which is horizontally positioned at level of right glass pane edge of second glass pane, defines a lateral front face, which is outwards exposed and which, in a closed state of the glass door apparatus, is near to the lateral front face of the upper first functional end cap, and has a functional end cap side face, which extends at least substantially in parallel to the pane face of the second glass pane (and for instance transversely to the upper glass pane edge of the second glass pane), wherein the complementary counterpiece associated with the first protrusion of the upper first functional end cap of the left glass door leaf may be formed by the side face of the functional end cap of the upper second functional end cap and, in the closed state of the glass door apparatus, the first protrusion of the upper first functional end cap may be overlapping with the functional end cap side face of the upper second functional end cap.

The lower second glass door leaf frame part may comprise an oblong lower second frame body, which defines a longitudinal axis, extends with its longitudinal axis along the lower glass pane edge of the second glass pane and has a right frame body longitudinal end, and have a lower second functional end cap, which cover the right frame body longitudinal end of the lower second frame body and which is horizontally at level of the right glass pane edge of the second glass pane, defines a lateral outwards exposed front face, which, in a closed state of the glass door apparatus, is near a lateral front face of the lower first functional end cap, and has a functional end cap side face, which extends at least substantially parallel to the face of the second glass pane (and for instance transversely to the lower glass pane edge of second glass pane), wherein the complementary counterpiece associated with the first protrusion of the lower first functional end cap of the left glass door leaf may be formed by the functional end cap side face of the lower second functional end cap, and, in the closed state of the glass door apparatus, the first protrusion of lower first functional end cap may be overlapping the functional end cap side face of the lower second functional end cap.

The upper second functional end cap may also have a second protrusion, which, with respect to the pane face of the second glass pane, is disposed opposite to the functional end cap side face and which, with respect to the lateral front face of the upper second functional end cap, protrudes laterally outwards in a manner at least substantially parallel to the pane face of the second glass pane and in a direction away from the second glass pane, and the upper first functional end cap may have a functional end cap side face (which for instance is outwardly exposed), which, with respect to the pane face of the first glass pane, is disposed opposite to the first protrusion of the upper first functional end cap and which extends at least substantially in parallel to the pane face of the first glass pane, and, in the closed state of the glass door apparatus, the second protrusion of the upper second functional end cap may be overlapping the functional end cap side face of the upper first functional end cap.

The lower second functional end cap may also have a second protrusion, which, with respect to the pane face of the second glass pane, is disposed opposite to the functional end cap side face and which, with respect to the lateral front face of the lower second functional end cap, protrudes laterally outwards in a manner at least substantially in parallel to the pane face of the second glass pane as well as in a direction away from the second glass pane, and the lower first functional end cap may also have a functional end cap side face (for example outwardly exposed), which, with respect to the pane face of the first glass pane, is opposite to the first protrusion of the lower first functional end cap and which extends at least substantially in parallel to the pane face of the first glass pane, and, in the closed state of the glass door apparatus, the second protrusion of the lower second functional end cap may overlap the functional end cap side face of the lower first functional end cap.

The complementary counterpiece or another complementary counterpiece associated with the first cavity of the upper first functional end cap of the left glass door leaf may also be formed by the second protrusion of the upper second functional end cap, and/or the complementary counterpiece or another complementary counterpiece associated with the respective first cavity of the lower first functional end cap of the left glass door leaf may also be formed by the second protrusion of the lower second functional end cap. The second protrusion of the respective second functional end cap may for example (for instance together with and at least substantially in parallel to the first leg of the weather strip or alternatively to the first leg of the weather strip) engage the first cavity and overlap the left glass pane edge of the first glass pane.

The respective (for example the upper and/or lower) second functional end cap may also comprise a first cavity, which, with respect to the lateral front face of the respective second functional end cap, protrudes laterally inwards in a manner at least substantially in parallel to the pane face of the second glass pane and in a direction towards the second glass pane (i.e., towards the inside of the functional end cap) and which, in an opposite direction, opens laterally outwardly, and may also comprise a second cavity, which, with respect to the lateral front face of the respective second functional end cap, protrudes laterally inwards in a manner at least substantially in parallel to the pane face of the second glass pane and in a direction towards the second glass pane (i.e., towards the inside of the functional end cap) and which opens, in an opposite direction, laterally outwardly and which, with respect to the pane face of the second glass pane, is disposed opposite the first cavity of the respective second functional end cap, so that a second functional block may be formed between the first and second cavity of the respective second functional end cap, wherein the second leg of the weather strip may engage the first cavity of the respective second functional end cap and the third leg of the weather strip may engage the second cavity of the respective second functional end cap.

The second functional block may have a lateral outwardly exposed functional end cap face, which may be aligned with a lateral front face of the right glass pane edge of the second glass pane and may form an extension of the lateral front face of the right glass pane edge (for instance for forming a gap with respect to the lateral front face of the right glass pane edge or due to the fact that the functional block front face is aligned with the lateral front face of the right glass pane edge).

In the closed state of the glass door apparatus, a gap formed between the respective first protrusion of the respective first functional end cap and the respective complementary counterpiece of the left glass door leaf in a direction transversal to the pane faces of the first and second glass panes may be smaller or equal to a fifth of an overlapping length of the respective first protrusion with the respective complementary counterpiece of the left glass door leaf and/or a gap formed between the first cavity of the respective first functional end cap and the respective complementary counterpiece of the left glass door leaf in a direction transversal to the pane faces of the first and second glass panes may be smaller or equal to a fifth of an overlapping length of the first cavity of the respective first functional end cap with the respective complementary counterpiece of the left glass door leaf.

In the closed state of the glass door apparatus, a gap between the second cavity of the respective first functional end cap and the further complementary counterpiece of the left glass door leaf transversal to the pane faces of the first and second glass panes may be smaller or equal to a fifth of the overlapping length of the second cavity of the respective first functional end cap with the further corresponding complementary counterpiece of the left glass door leaf.

In the respective first functional end cap at least one sealing element receiving vertical groove (for instance two sealing element receiving vertical grooves, for instance a first sealing element receiving vertical groove and a second sealing element receiving vertical groove), which extends at least substantially in parallel to the left glass pane edge of the first glass pane, protrudes laterally inwardly at the front face in a manner at least substantially in parallel to the pane face of the first glass pane as well as in a direction towards the first glass pane (i.e., towards the inside of the functional end cap) and which opens outwardly and laterally in the opposite direction and in which a sealing element (for instance a (Mohair) brush, a sealing lip, etc.) is received, which sealing element protrudes laterally outwardly from the sealing element of the respective first functional end cap in a manner at least substantially in parallel to the pane face of the first glass pane as well as in a direction away from the first glass pane, and which sealing element, in a closed state of the glass door apparatus, interacts in an abutting way with the left glass door leaf. The sealing element in the sealing element receiving vertical groove may for instance interact in an abutting way with the second functional end cap, which is opposite the respective first functional end cap (for instance facing the same).

In the respective second functional end cap, at least one sealing element receiving vertical groove (for instance two sealing element receiving vertical grooves, for instance a first sealing element receiving vertical groove and a second sealing element receiving vertical groove) is formed, which extends at least substantially in parallel to the right glass pane edge of the second glass pane, protrudes laterally inwardly at the front face in a manner at least substantially in parallel to the pane face of the second glass pane as well as in a direction towards the second glass pane (i.e., towards the inside of the functional end cap) and which opens outwardly laterally in the opposite direction and in which a sealing element (for instance a (Mohair) brush, a sealing lip, etc.) is received, which sealing element protrudes laterally outwardly from the sealing element receiving vertical groove of the respective second functional end cap in a manner at least substantially in parallel to the face of the second glass pane as well as from the second glass pane and which sealing element, in a closed state of the glass door apparatus, interacts in an abutting way with the first functional end cap, which is opposite the respective second functional end cap. The sealing element receiving vertical groove of the respective second functional end cap may for example be positioned in opposite to the sealing element receiving vertical groove of the respective first functional end cap with respect to the pane faces of the first and second glass panes.

The right glass door leaf may be a stationary leaf, a sliding leaf, a rotating leaf or a sliding-rotating leaf, and the left glass door leaf may be a stationary leaf, a sliding leaf, a rotating leaf or a sliding-rotating leaf

The protrusions and/or cavities may extend in the vertical direction along a portion of the vertical extension or at least substantially along the entire vertical extension of the respective functional end cap, in particular between an upper face and a lower face of the respective functional end cap. The functional end caps may for example be manufactured in one piece (i.e., monolithically or with a material coupling) or be made of individual parts which are mutually connected (for instance by screwing, welding, gluing, etc.) and may be made of a plastic material and/or a metallic material, such as aluminum material.

According to another aspect, which may be connected to the previous aspect of the present invention or may be combined with the same, or may be separate from it, the invention provides a glass door apparatus, whose durability and reliability are improved, by the fact that an actuating pin of an extractable (or extendible) sealing does not abut against a housing front side of a sealing (which for instance is also extendible or extractable) which is opposite the extractable sealing, instead abutting against an stop portion formed by an functional end cap, which may be massive, in order to prevent damage to the housing of the sealing opposing the extractable sealing, as well as to reduce the wear of the sealing. The durability and reliability of a glass door apparatus may also be improved by the fact that a sealing is securely and fixedly held on a functional end cap by means of a hooking element, by engaging a housing wall of the sealing from below.

According to the other aspect of the present invention, a glass door apparatus is provided with: a right glass door leaf, which has a first glass pane, which defines a pane face and which comprises a left glass pane edge, which extends at least substantially in a vertical direction, an upper glass pane edge, which extends at least substantially in a horizontal direction, and a lower glass pane edge, which extends at least substantially in a horizontal direction, a upper first glass door leaf frame part, which engages the upper glass pane edge of first glass pane, and a lower first glass door leaf frame part, which engages the lower glass pane edge of the first glass pane, and a left glass door leaf, which has a second glass pane, which defines a pane face and which comprises a right glass pane edge, which extends at least substantially in a vertical direction and which, in a closed state of the glass door apparatus, is near (e.g., adjacent to) the left glass pane edge of the first glass pane, an upper glass pane edge, which extends at least substantially in a horizontal direction, and which has a lower glass pane edge, which extends at least substantially in a horizontal direction, a upper second glass door leaf frame part, which engages an upper glass pane edge of the second glass pane, and a lower second glass door leaf frame part, which engages the lower glass pane edge of the second glass pane, wherein at least one of the upper first glass door leaf frame part and the lower first glass door leaf frame part may have: an oblong first frame body, defining a longitudinal axis, which extends with its longitudinal axis along the pane edge corresponding to the respective glass door leaf frame part among the upper and lower glass pane edges of the first glass pane and has a left frame body longitudinal end, a first functional end cap, by which the left frame body longitudinal end of the first frame body is covered, and which is horizontally positioned at level of left glass pane edge of first glass pane, defines a lateral outwardly exposed front face, defines a lateral rear face, which is positioned at a distance from the lateral front face in the direction towards the left frame body longitudinal end of the first frame body and is near (e.g., adjacent to) the left frame body longitudinal end of the first frame body, and has a sealing receiving groove, which is at least substantially parallel to the pane face of the first glass pane from the lateral front face to the rear face of first functional end cap and which opens at least substantially vertically outwardly and opens outwardly in a direction away from the lateral front face and in a direction away from the rear face of the first functional end cap, a first hook element, which is attached to the rear face of the first functional end cap and has a hooking element, a first sealing, which is at least partially positioned in the first frame body and is at least partially received in the sealing receiving groove of the first functional end cap and which has a first sealing housing which has a housing front side (for instance at level of left glass pane edge of first glass pane and which is at least substantially parallel to left glass pane edge of first glass pane) and has a housing longitudinal wall, which extends from the housing front side towards the first glass pane in a manner at least substantially parallel to the glass pane edge associated with the respective glass door leaf frame part among the upper and lower glass pane edges of the first glass pane and which extends at least substantially transversally to the pane face of the first glass pane, wherein the housing longitudinal wall of the first sealing housing is provided, at a distance from the housing front side of the first sealing housing, with a hooking element housing cavity, in which the hooking element of the first hook element engages or may engage by engaging the housing longitudinal wall of the first sealing housing from below (e.g., by reaching under or gripping under the housing longitudinal wall), in order to hold, in this way, the first sealing on the first functional end cap.

The first functional end cap may optionally have a stop portion (or abutment portion) protruding into the sealing receiving groove, the housing front side of first sealing housing may at least partially be overlapped by the stop portion of the first functional end cap at least substantially in a vertical direction, and the second glass door leaf frame part, which is adjacent to the first glass door leaf frame part, which has the first functional end cap, of the upper second and lower glass door leaf frame part, has: a oblong second frame body, defining a longitudinal axis, extending with its longitudinal axis along the corresponding of the upper and lower glass pane edge of second glass pane and has a right frame body longitudinal end, and a second sealing, formed as an extractable sealing (or also called extendible or deployable sealing), which second sealing is at least partially received in the second frame body and which has a second sealing housing, which has a housing front side, an extractable sealing profile, which in a non-extracted state, is received in the second sealing housing and which is at least substantially vertically extractable from the second sealing housing against an elastic reaction force in an outward direction, and an actuating pin which protrudes with respect to the housing front side of second sealing housing in an outward direction (for instance towards the first glass pane of right glass door panel) and which is movable (e.g., slidable), in order to cause, during its displacement, an at least substantially vertically directed extraction of the extractable sealing profile of second sealing against the elastic reaction force, wherein the glass door apparatus is configured in a way that the respective actuating pin of second sealing, during the closing process of the glass door apparatus, abuts against the corresponding stop portion formed by respective first functional end cap, in order to cause its displacement.

For example, the upper first glass door frame part may comprise: an oblong upper first frame body defining a longitudinal axis extending along its upper longitudinal axis along the upper glass pane edge of the first glass pane and having a left frame body longitudinal end, a upper first functional end cap, by which the left frame body longitudinal end of the upper first frame body is covered and which is arranged horizontally at the level of the left glass pane edge of the first glass pane, defines a lateral, outwardly exposed front face and a lateral rear face, which is disposed at a distance from the lateral front face in a direction towards the left frame body longitudinal end of the first frame body and is disposed adjacent to the longitudinal end of the first frame body, and has a sealing receiving groove which extends at least substantially parallel to the pane face of the first glass pane from the lateral front face to the rear face of the upper first functional end cap and which opens outwardly at least substantially vertically upwards and also opens outwardly in a direction away from the lateral front face and in a direction away from the rear face of the upper first functional end cap, a upper first hook element which is attached to the rear face of the first functional end cap and comprises a hooking element, an upper first sealing, which is at least partially received in the first upper frame body and is at least partly received in the sealing receiving groove of the first upper first functional end cap, and which comprises an upper first sealing housing having a housing front side and a housing longitudinal wall, which extends from the housing front side in a direction toward the first glass pane in a manner at least substantially parallel to the upper glass pane edge of the first glass pane and extends at least substantially transversely to the pane face of the first glass pane, wherein the housing longitudinal wall of the upper first sealing housing comprises a hooking element receiving groove which is provided therein at a distance from the housing front side of the upper first sealing housing and into which the hooking element of the upper first hook element can engage or engages by engaging the housing longitudinal wall of the upper first sealing housing from below to thereby hold the upper first sealing on the upper first functional end cap.

Optionally, the upper first functional end cap may have a stop portion protruding into the sealing receiving groove of upper first functional end cap, the housing front side of upper first sealing housing may be at least partially overlapped by the stop portion of upper first functional end cap and the upper second glass door leaf frame part may have: an oblong upper second frame body defining a longitudinal axis extending with its longitudinal axis along the upper glass pane edge of the second glass pane and having a right frame body longitudinal end and an upper second sealing, formed as an extractable sealing, which upper second sealing is at least partially disposed in the upper second frame body and has an upper second sealing housing having a housing front side, an extractable sealing profile, which, in a non-extracted state, is received in the upper second sealing housing and which at least substantially vertically protrudes upwards from the upper second sealing housing, and an actuating pin which protrudes outwards with respect to the housing front side of the upper second sealing housing and which is movably arranged in such a way that, during its displacement, at least a substantially vertical extraction of the extractable sealing profile of the upper second sealing upwards against the elastic reaction force takes place, wherein the glass door apparatus is arranged in such a way that the actuating pin of the upper second sealing abuts against the associated stop portion formed by the upper first functional cap during the closing process of the glass door apparatus, in order to thereby cause its displacement.

For example, the lower first glass door frame part may also comprise an oblong lower first frame body defining a longitudinal axis extending along its longitudinal axis along the lower glass pane edge of the first glass pane and having a left frame body longitudinal end, a lower first functional end cap by which the left frame body longitudinal end of the lower first frame body is covered and which is arranged horizontally at the level of the left glass pane edge of the first glass pane, defines a lateral outwardly exposed front face, defines a lateral rear face, which is disposed at a distance from the lateral front face in a direction toward the left frame body longitudinal end of the lower first frame body and is adjacent to the left frame body longitudinal end of the lower first frame body, and has a sealing receiving groove which is at least substantially parallel to the pane face of the first glass pane from the lateral front face to the rear face of the lower first functional end cap and opens outwardly at least substantially vertically downwards and also opens outwardly in the direction away from the lateral front face and in the direction away from the rear face of the lower first functional end cap, a lower first hook element attached to the rear face of the lower first functional end cap and comprising a hooking element, a lower first sealing which is at least partially received in the lower first frame body and is at least partially received in the sealing receiving groove of the lower first functional end cap and which comprises a lower first sealing housing having a housing front side and a housing longitudinal wall, which housing longitudinal wall extends from the housing front side in a direction toward the first glass pane in a manner at least substantially parallel to the lower glass pane edge of the first glass pane and extends at least substantially transversely to the pane face of the first glass pane, wherein the housing longitudinal wall of the lower first sealing housing comprises a hooking element receiving cavity, which is provided therein at a distance from the housing front side of the lower first sealing housing and into which the hooking element of the lower first hook element can engage or engages by engaging the lower first housing longitudinal wall of the lower first housing from below to thereby hold the lower first sealing on the lower first functional end cap.

Optionally, the lower first functional end cap may have a stop portion protruding into the sealing receiving groove, the housing front side of the lower first sealing housing may be at least partly overlapped by the stop portion of the lower first functional end cap, and the lower second glass door leaf frame part may have: an oblong, lower second frame body having a longitudinal axis, extending along the upper glass pane edge of the second glass pane with its longitudinal axis and having a right frame body longitudinal end, and a lower second sealing provided as an extractable sealing, which lower second sealing is at least partially housed in the lower second frame body and has a lower second sealing housing, which has a housing front side, an extractable sealing profile, which, in a non-extracted state, is received in the lower second sealing housing and which can be extracted at least substantially vertically out of the lower sealing housing against an elastic reaction force, and an actuating pin, which protrudes with respect to the housing front side of the lower second sealing housing to the outside (for instance in the direction of the first glass pane of the right glass door panel) and which is moveably arranged to effect, in the course of its displacement, at least a substantially vertical extraction of the extractable sealing profile of the lower second sealing against the elastic reaction force, the glass door being arranged in such a way that the actuating pin of the lower second sealing abuts against the associated stop portion formed by the lower first functional cap during the closing process of the glass door apparatus, thereby effecting its displacement.

The stop portion of the respective first functional end cap can be formed by a wall portion of the respective first functional end cap which has a lateral, outwardly exposed abutment surface which is, for example, a part of the lateral front face of the respective first functional end cap and against which the associated actuating pin abuts.

The respective (for example, the upper and/or the lower) second glass door leaf frame part may further have: a second functional end cap which covers the right frame body longitudinal end of the respective second frame body and which is arranged horizontally at the level of the right glass pane edge of the second glass pane, defines a lateral outwardly exposed front face, which, in a closed state of the glass door apparatus, is positioned near the lateral front face of the respective opposite first functional end cap, defines a lateral rear face which is spaced apart from the lateral front face in the direction of the right frame body longitudinal end of the respective second frame body and is near (e.g., adjacent to) the right frame body longitudinal end of the respective second frame body, and has a sealing receiving groove which extends at least substantially parallel to the pane face of the second glass pane from the lateral front face of the respective second functional end cap to the rear face of the respective second functional end cap and which opens at least substantially vertically and outwardly as well as opens outwardly in a direction away from the lateral front face and in a direction away from the rear face of respective second functional end cap, a second hook element attached to the rear face of the second functional end cap and comprising a hooking element, wherein the respective second sealing is at least partially received in the second frame body and is at least partly received in the sealing receiving groove of the respective second functional end cap, and wherein the second sealing housing of the respective second sealing has a housing longitudinal wall, which extends from the housing front side of the second sealing housing in the direction towards the second glass pane in a manner at least substantially parallel to the respective glass pane edge associated with the respective glass door leaf frame part among the upper and lower glass pane edges of the second glass pane and at least substantially transversally to the pane face of the second glass pane, and wherein the housing longitudinal wall of the second sealing housing may be provided, at a distance from the housing front side of the second sealing housing, with a hooking element receiving cavity into which the hooking element of the second hook element may engage or engages by engaging the housing longitudinal wall of the second sealing housing from below so as to hold the respective second sealing on the respective second functional end cap.

The respective hook element (for instance at least one of the respective first and second hook elements, or each of the respective first and second hook elements) may have at least a substantially L-shaped shape (for instance, a rounded L-shape), wherein the respective hook element comprises a first hook element portion which extends at least substantially vertically with respect to the housing longitudinal wall of the respective sealing housing along the rear face of the respective functional end cap and which is connected to the rear face of the respective functional end cap (for instance by means of a screw connection), and a second hook element portion which extends from an end of the first hook element portion at least substantially perpendicularly to the first hook element portion (and for instance at least substantially parallel to the associated glass pane edge from the upper and lower glass pane edges of the respective glass pane) in a direction, wherein the hooking element is formed by the second hook element portion.

The respective hook element may be provided with a nut welded to the respective hook element, whose threads engage with threads of a threaded bolt extending through the respective functional end cap from the front face to the rear face of the respective functional end cap, in order to fasten the respective hook element by means of a screw connection to the respective functional end cap.

The respective first sealing may also be provided as an extractable sealing and have an extractable sealing profile, which, in a non-extracted state, is received in the respective first sealing housing and which is at least substantially vertically and outwardly extractable from the respective first sealing housing towards the outside against an elastic reaction force, and an actuating pin, which is moveably arranged in order to cause, during its displacement, at least a substantially vertical extraction of the extractable sealing profile of the respective first sealing against the elastic reaction force.

### IV. BRIEF DESCRIPTION OF DRAWINGS

FIG. 1 is a view from an outer area of a glass door apparatus according to a first example embodiment of the present invention in a closed state of the glass door apparatus.

FIG. 2 is a plan view of a glass door apparatus according to a first alternative of the first example embodiment of the present invention in a closed state of the glass door apparatus.

FIGS. 3 to 5 are respectively a perspective view, a front side view and a plan view of a upper first functional end cap according to the first alternative of the first example embodiment of the present invention.

FIGS. 6 to 8 are respectively a perspective view, a front side view and a plan view of a upper second functional end cap according to the first alternative of the first example embodiment of the present invention.

FIG. 9 is a plan view of a glass door apparatus according to a second alternative of the first example embodiment of the present invention in a closed state of the glass door apparatus.

FIGS. 10 to 12 are respectively a perspective view, a front side view and a plan view of a lower first functional end cap according to the second alternative of the first example embodiment of the present invention.

FIGS. 13 to 15 are respectively a perspective view, a front side view and a plan view of a lower second functional end cap according to the second alternative of the first example embodiment of the present invention.

FIG. 16 is a view from an outer area of a glass door apparatus according to a second example embodiment of the present invention in a closed state of the glass door apparatus.

FIG. 17 is a plan view of a glass door apparatus according to a first alternative of the second example embodiment of the present invention in a closed state of the glass door apparatus.

FIGS. 18 to 20 are respectively a perspective view, a front side view and a plan view of a upper first functional end cap according to the first alternative of the second example embodiment of the present invention.

FIGS. 21 to 23 are respectively a perspective view, a front side view and a plan view of an upper second functional end cap according to the first alternative of the second example embodiment of the present invention.

FIG. 24 is a plan view of a glass door apparatus according to a second alternative of the second example embodiment of the present invention in a closed state of the glass door apparatus.

FIGS. 25 to 27 are respectively a perspective view, a front side view and a plan view of a lower first functional end cap according to the second alternative of the second example embodiment of the present invention.

FIGS. 28 to 30 are respectively a perspective view, an end view and a plan view of a lower second functional end cap according to the second alternative of the second example embodiment of the present invention.

FIG. 31 is a schematic view from an outer area of a glass door apparatus having four glass door leaves in a closed state of the glass door in which a first and second example embodiment of the present invention are provided.

FIG. 32 is a plan view of the glass door with four glass door leaves of FIG. 31.

FIG. 33 is a plan view of a glass door apparatus according to a first alternative according to another aspect of the present invention in a closed state of the glass door apparatus.

FIG. 34 is a partial sectional view taken along the line A-A in FIG. 33 in an open state of the glass door apparatus.

FIG. 35 is a plan view of a glass door apparatus according to a second alternative according to another aspect of the present invention in a closed state of the glass door apparatus.

FIG. 36 is a partial sectional view taken along line A-A in FIG. 35 in an open state of the glass door apparatus.

In the figures, the same references are used for the same or similar components.

### V. DETAILED DESCRIPTION

The present invention is explained in the following by means of example embodiments with reference to drawings.

The following explanations of aspects of the invention are provided with reference to a “left glass door leaf” and a “right glass door leaf” and their mutual relationship, wherein these refer to a lateral observation of the glass door apparatus from the outer area indicated in figures. It is to be noted that terms like “left glass door leaf” and “right glass door leaf” have been chosen only for explanation purposes and the present invention is not limited to it. The left and right glass door leaf may for instance be also exchanged/mirrored in a glass door apparatus according to the present invention.

The glass door apparatus 1 according to the embodiments of the present invention and their alternatives includes a right glass door leaf 10 and left glass door leaf 100.

The right glass door leaf 10 has a first glass pane 20, which defines a pane face 21. The first glass pane 20 also has a left glass pane edge 22, which is at least substantially vertical, an upper glass pane edge 24, which is at least substantially horizontal, and a lower glass pane edge 26, which is at least substantially horizontal.

The right glass door leaf 10 also has a upper first glass door leaf frame part 30a, which engages the upper glass pane edge 24 of first glass pane 20 (for instance through a frame body, indicated in the following), and a lower first glass door leaf frame part 30b, which engages the lower glass pane edge 26 of first glass pane 20 (for instance through a frame body, indicated in the following).

The left glass door leaf 100 has a second glass pane 120, which defines a pane face 121. The second glass pane 120 also has a right glass pane edge 122, which extends at least substantially in a vertical direction, an upper glass pane edge 124, which is at least substantially horizontal, and a lower glass pane edge 126, which is at least substantially horizontal.

The left glass door leaf 100 has a upper second glass door leaf frame part 130a, which engages the upper glass pane edge 124 of second glass pane 120 (for instance through a frame body, indicated in the following) and a lower second glass door leaf frame part 130b, which engages the lower glass pane edge 126 of second glass pane 120 (for instance through a frame body, indicated in the following).

According to the embodiments of the present invention and its alternatives, the upper first glass door leaf frame part 30a may have a first oblong frame body 32a, which defines a longitudinal axis 33a, extends with its longitudinal axis 33a along the upper glass pane edge 24 of first glass pane 20 and has a left frame body longitudinal end 34a. The upper first frame body 32a has a central frame body glass pane receiving groove, in which the upper glass pane edge 24 of the first glass pane 20 is inserted and in which the upper glass pane edge 24 of first glass pane 20 is held, for instance by clamping, so that the upper first glass door leaf frame part 30a engages the upper glass pane edge 24 of first glass pane 20.

The upper second glass door leaf frame part 130a may also have a second oblong upper frame body 132a, which defines a longitudinal axis 133a, extends with its longitudinal axis 133a along the upper glass pane edge 124 of second glass pane 120 and has a right frame body longitudinal end 134a. The upper second frame body 132a has, for example, a central frame body glass pane receiving groove, in which the upper glass pane edge 124 of second glass pane 120 is inserted and in which the upper glass pane edge 124 of second glass pane 120 is held, for instance by clamping, so that the upper second glass door leaf frame part 130a engages the upper glass pane edge 124 of second glass pane 120.

Moreover, the lower first glass door leaf frame part 30b may have a lower first frame body 32b, which defines a longitudinal axis 33b, extends with its longitudinal axis 33b along the lower glass pane edge 26 of first glass pane 20 and has a left frame body longitudinal end 34b. The lower first frame body 32b has, for example, a central frame body glass pane receiving groove, in which the lower glass pane edge 26 of first glass pane 20 is inserted and in which the lower glass pane edge 26 of first glass pane 20 is held, for instance by clamping, so that the lower first glass door leaf frame part 30b engages the lower glass pane edge 26 of first glass pane 20.

The lower second glass door leaf frame part 130b may have a lower second frame body 132b, which defines a longitudinal axis 133b, extends with its longitudinal axis 133b along the lower glass pane edge 126 of second glass pane 120 and has a right frame body longitudinal end 134b. The lower first frame body 132b has, for example, a central frame body glass pane receiving groove, in which the lower glass pane edge 126 of second glass pane 120 is inserted and in which the lower glass pane edge 126 of second glass pane 120 is held, for instance by clamping, so that the lower second glass door leaf frame part 130b engages the lower glass pane edge 126 of second glass pane 120.

Further, with respect to the embodiments of the present invention and their alternatives, first functional end caps 40a, 40b, 240a, 240b and second functional end caps 140a, 140b, 340a, 340b will be described in detail. Each of these functional end caps defines a lateral, outwardly exposed front face 42a, 42b, 142a, 142b, 242a, 242b, 342a, 342b and defines a lateral rear face 43a, 43b, 143a, 143b, 243a, 243b, 343a, which is disposed at a distance, in the direction from the lateral front face towards the respectively corresponding one of the left and right frame body longitudinal ends of the respective frame body, and is adjacent to the respectively corresponding one of the left and right frame body longitudinal ends of the respective frame body (wherein, for instance, the rear face is the cover of the respectively corresponding one of the left and right frame body longitudinal ends of the respective frame body). Each of these functional end caps also defines, e.g., an outwardly exposed upper face 44a, 44b, 144a, 144b, 244a, 244b, 344a, 344b, an outwardly exposed lower face 46a, 46b, 146a, 146b, 246a, 346a which, with respect to the corresponding one of the upper and lower glass pane edges of the corresponding glass pane, is disposed opposite the upper face of the respective functional end cap, and has a first outwardly exposed functional end cap side face 48a, 48b, 148a, 148b, 248a, 248b, 348a, 348b, which extends at least substantially parallel to the pane face of the corresponding glass pane, and a second outwardly exposed functional end cap side face 50a, 50b, 150a, 150b, 250a, 250b, 350a, 350b, which extends at least substantially parallel to the pane face of the corresponding glass pane and which is arranged, with respect to the pane face of the associated glass pane, opposite the respective functional end cap side face 48a, 48b, 148a, 148b, 248a, 248b, 348a, 348b of the respective functional end cap. Moreover, the lateral, outwardly exposed front face of a respective second functional end cap, is, in a closed state of the glass door apparatus 1, adjacent to the lateral front face of the respectively associated first functional end cap (for example, the lateral, outwardly exposed front face of a upper second functional end cap is, in a closed state of the glass door apparatus 1, adjacent to the lateral front face of the upper first functional end cap, etc.).

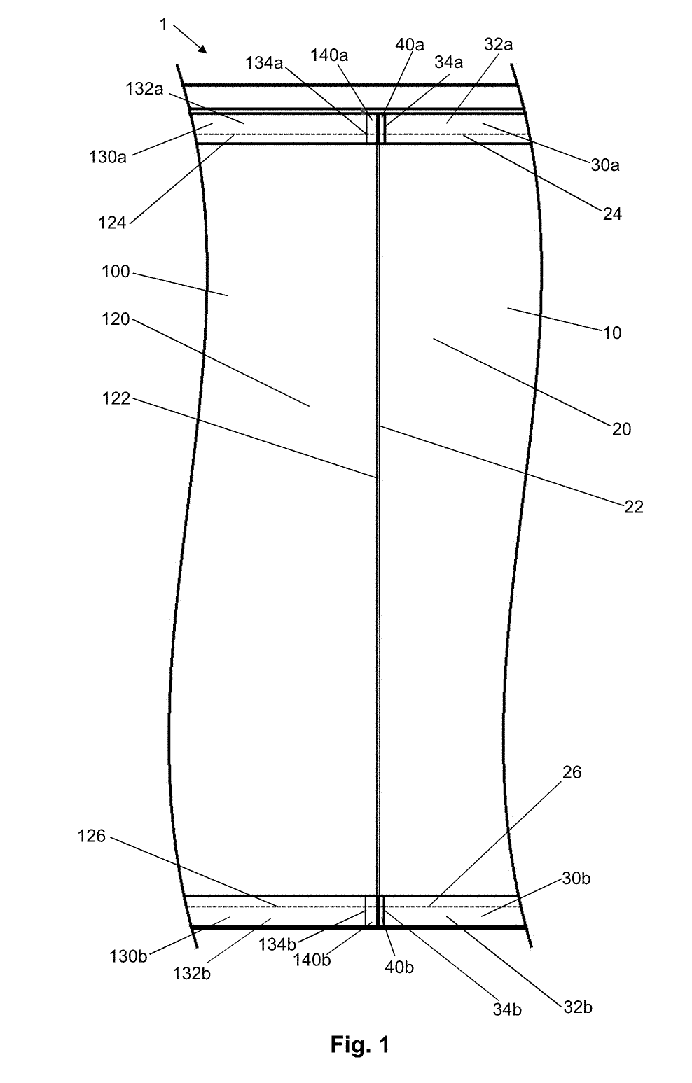

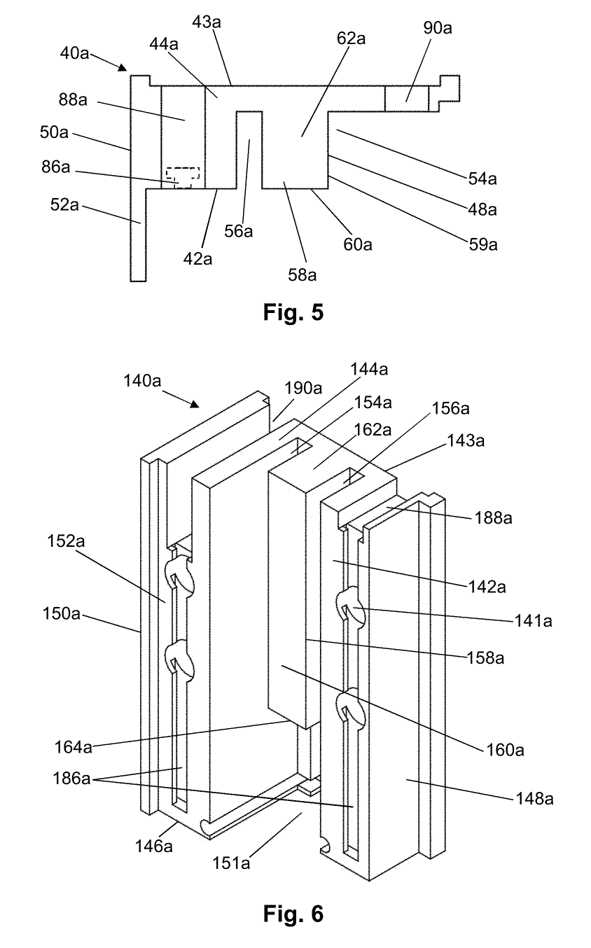

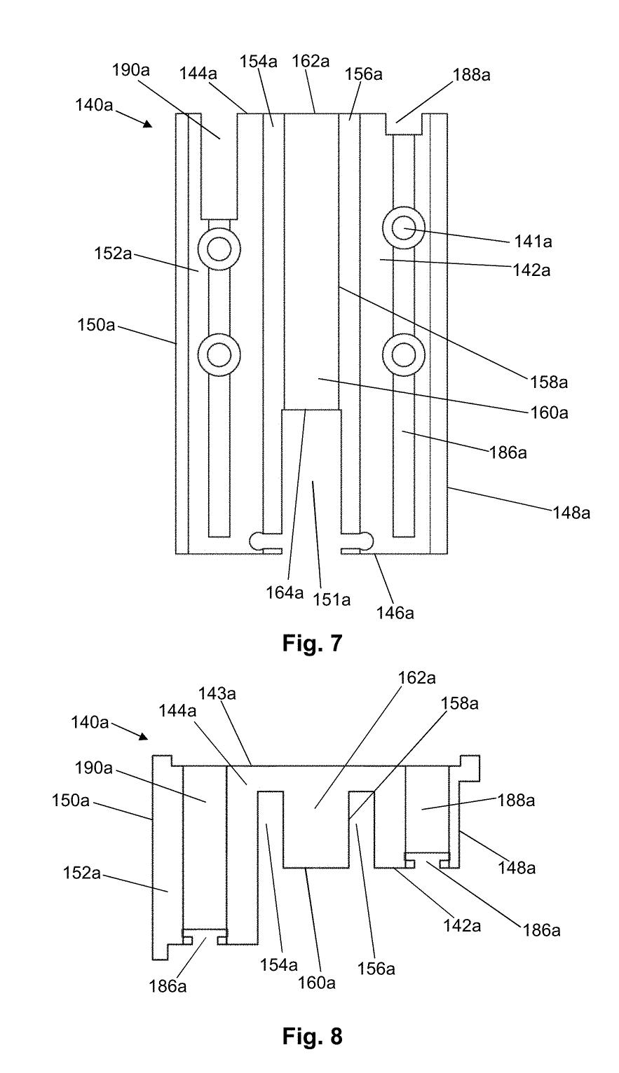

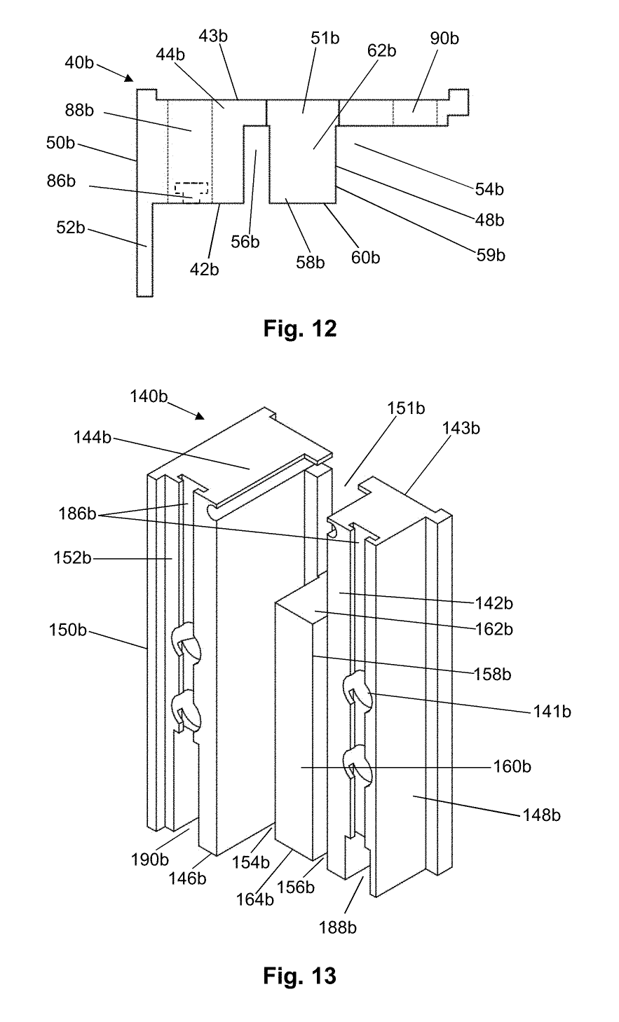

FIGS. 1 to 15 represent a glass door apparatus 1 according to a first example embodiment of the present invention.

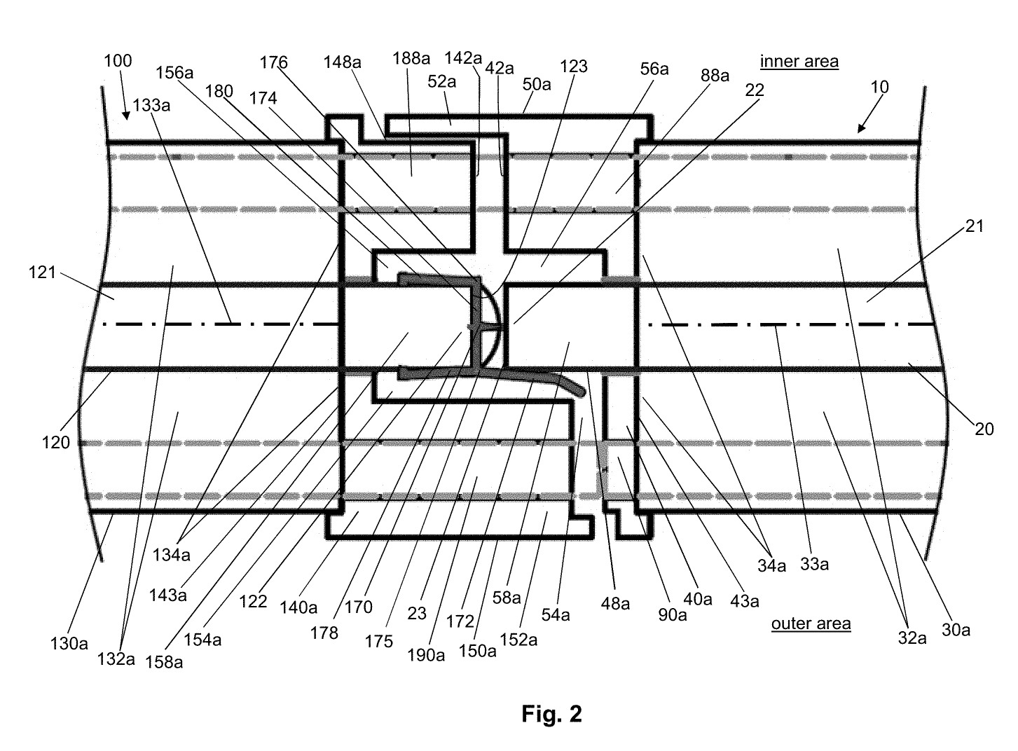

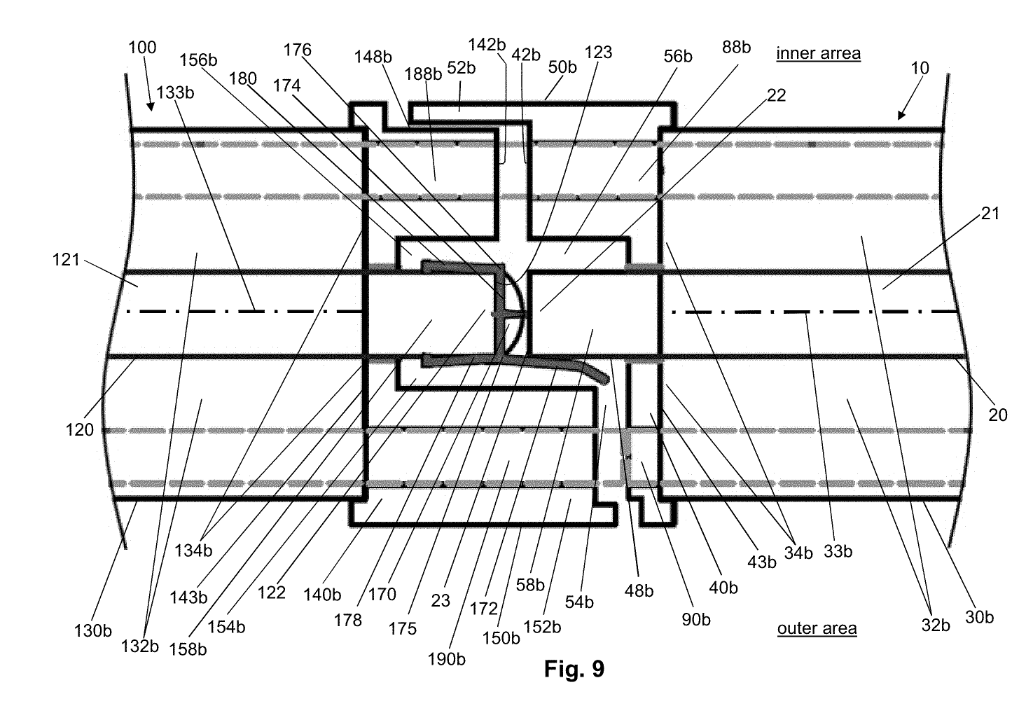

In the first example embodiment of the present invention, the left glass door leaf 100, as shown in FIGS. 2 and 9 in cross section, has an oblong weather strip 170, which defines a weather strip longitudinal axis and which is positioned on the right glass pane edge 122 of second glass pane 120 and which extends, with its weather strip longitudinal axis, along the right glass pane edge 122 of second glass pane 120. The weather strip 170 is made, for example, of an at least substantially transparent and UV-resistant synthetic material, such as polyethylene terephthalate glycol or also called glycol-modified polyethylene terephthalate (short PETG or PET-G). In the first embodiment of present invention, the weather strip 170 has a profile cross section (in the plan view) with a first leg 172, extending from the right glass pane edge 122 of second glass pane 120 in a manner at least substantially parallel to pane face 121 of second glass pane 120 and laterally away from the second glass pane 120.

According to a first example embodiment the weather strip 170 has an h-shaped cross section profile with a central transverse web 174, which has a first transverse web end 175 and a second transverse web end 176, wherein the first leg 172 extends from the first transverse web end 175, a second leg 178, which extends from the first transverse web end 175 in an opposite direction with respect to first leg 172 and overlaps the right glass pane edge 122 of second glass pane 120, and a third leg 180, which extends from the second transverse web end 176 in the same direction of second leg 178 and overlaps the right glass pane edge 122 of second glass pane 120. The second leg 178 and the third leg 180 surround (e.g., engage in a gripping manner) for example at least partially the pane face 121 of second glass pane 120, wherein the weather strip 170 is disposed through the second leg 178 and third leg 180 for instance by clamping on the second glass pane 120. As an alternative to the h-shaped transverse section profile, the weather strip may also have only an L-shaped profile cross section with the first leg and the central transverse web and may for instance be glued to the right glass pane edge of second glass pane 120.

The weather strip 170 extends, for instance, at least substantially over the major part of longitudinal extension or the entire longitudinal extension of right glass pane edge 122 of second glass pane 120 and/or the left glass pane edge 22 of second glass pane 20. The weather strip 170 may also protrude beyond the upper glass pane edge and/or the lower glass pane edge of respective glass pane. In the closed state of the glass door apparatus 1, the first leg 172 overlaps the left glass pane edge 22 of first glass pane 20 and the first leg 172 contacts the pane face 21 of first glass pane, so that the weather strip 170 at least substantially seals a gap between the left glass pane edge 22 of first glass pane 20 and right glass pane edge 122 of second glass pane 120. Above mentioned legs may be resilient, so that the first leg 172 is biased against the pane face 21 of first glass pane 20 and/or so that the second leg 178 and third leg 180 are biased against the pane face 121 of second glass pane 120.

In the following, a first and second alternative of first example embodiment are described. In a glass door apparatus according to the present invention the first or second alternative of first embodiment may be provided. Both alternatives of the first embodiment may also be simultaneously provided (i.e., in combination) in a glass door apparatus of the invention.

In the following, the first alternative of first example embodiment is described with reference to FIGS. 1 and 2 to 8.

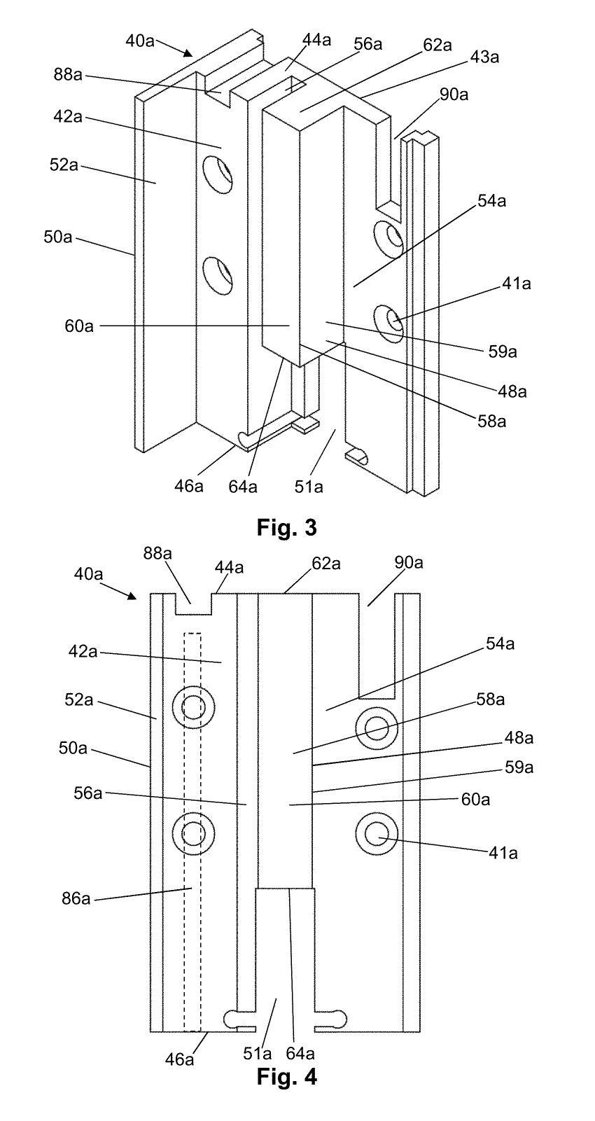

The upper first glass door leaf frame part 30a according to the first alternative has an upper first functional end cap 40a (detailed in FIGS. 3 to 5), by which the left frame body longitudinal end 34a of upper first frame body 32a is covered and which is horizontally positioned at level with left glass pane edge 22 of first glass pane 20. The upper first functional end cap 40a is connected to upper first frame body 32a for instance by screwing, wherein the upper first functional end cap 40a has at least one through-hole 41a (FIGS. 3 to 5 show four holes, as an example) for receiving a (respective) threaded pin, by which the upper first functional end cap 40a is connected to the upper first frame body 32a. The upper first functional end cap 40a may also be connected to upper first frame body 32a in another way, for instance by a clamping connection or a locking or latching connection (e.g., snap connection).

The upper first functional end cap 40a also has a central glass pane receiving groove 51a, which protrudes, with respect to lower face 46a of the upper first functional end cap 40a, inwards in a manner at least substantially in parallel to left glass pane edge 22 of first glass pane 20 as well as at least substantially vertical in a direction towards the upper face 44a of upper first functional end cap 40a and which, in the opposite direction, opens downwards and in which the first glass pane 20 is placed, wherein for instance buffer elements (for instance of elastic material) are introduced between the first glass pane 20 and the upper first functional end cap 40a in the glass pane receiving groove 51a.

The upper first functional end cap 40a also has a first protrusion 52a, which, with respect to lateral front face 42a of the upper first functional end cap 40a, protrudes laterally outwardly in a manner at least substantially in parallel to pane face 21 of first glass pane 20 and in a direction away from the first glass pane 20, wherein, in the closed state of glass door apparatus 1, the first protrusion 52a of the upper first functional end cap 40a overlaps with a complementary counterpiece of the left glass door leaf 100, said complementary counterpiece being associated with the first protrusion 52a of upper first functional end cap 40a. The first protrusion 52a may extend at least substantially in a vertical direction over a portion of the vertical extension or at least substantially the entire vertical extension of upper first functional end cap 40a between the upper face 44a and lower face 46a of upper first functional end cap 40a. The first protrusion 52a of upper first functional end cap 40a may also form, at least partially, the second functional end cap side face 50a of upper first functional end cap 40a. The upper first functional end cap side face 48a of upper first functional end cap 40a is also opposite to the first protrusion 52a of upper first functional end cap 40a with respect to pane face 21 of first glass pane 20.

The upper first functional end cap 40a also has a first cavity 54a, which, with respect to lateral front face 42a of upper first functional end cap 40a, protrudes laterally inwards in a manner at least substantially parallel to pane face 21 of first glass pane 20 and towards the first glass pane 20 and which, in the opposite direction, opens laterally and outwardly. In the first embodiment, the first cavity 54a of upper first functional end cap 40a also opens transversally with respect to pane face 21 of first glass pane 20 and away from pane face 21 of first glass pane 20, wherein a limiting contour which delimits the first cavity 54a of upper first functional end cap 40a has an at least substantially L-shaped section profile. The first cavity 54a of upper first functional end cap 40a may extend at least substantially in a vertical direction over a portion or at least entirely over the vertical extension of upper first functional end cap 40a between the upper face 44a and the lower face 46a of upper first functional end cap 40a. In the closed state of glass door apparatus, the first cavity 54a of upper first functional end cap 40a overlaps a complementary counterpiece of left glass door leaf 100, the complementary counterpiece being associated with first cavity 54a of upper first functional end cap 40a. In the first embodiment, the complementary counterpiece of left glass door leaf 100 associated with first cavity of upper first functional end cap 40a is formed by the first leg 172 of weather strip 170. As shown in FIG. 2, the first leg 172 overlaps, in the closed state of glass door apparatus 1, the left glass pane edge 22 of first glass pane 20 and engages, forming the corresponding complementary counterpiece of left glass door leaf 100 the first cavity 54a of upper first functional end cap 40a, wherein the first leg 172 overlaps a wall delimiting the first cavity 54a of upper first functional end cap 40a, which in the first embodiment is formed by the functional end cap side face 48a of upper first functional end cap 40a, and contacts the same, whereby the sealing may be improved. The first leg 172 of weather strip 170 extends, for example, over the upper glass pane edge 24 of first glass pane 20 at least substantially vertically (for instance upwards) and optionally extends at least substantially up to the upper face 44a of upper first functional end cap 40a.

The upper first functional end cap 40a also has a second cavity 56a, which, with respect to lateral front face 42a of upper first functional end cap 40a, protrudes laterally inwards in a manner at least substantially in parallel to pane face 21 of first glass pane 20 and towards the first glass pane 20 and which, in the opposite direction, opens laterally outwardly and which is positioned, with respect to pane face 21 of first glass pane 20, opposite to the first cavity 45a of upper first functional end cap 40a, so that a first functional block 58a is formed between the first cavity 54a and second cavity 56a of the upper first functional end cap 40a. The second cavity 56a of upper first functional end cap 40a has an at least substantially U-shaped profile cross-section. The second cavity 56a of upper first functional end cap 40a may also extend at least substantially vertically over a portion or the entirety of vertical extension of the upper first functional end cap 40a between the upper face 44a and lower face 46a of upper first functional end cap 40a.

The first functional block 58a of upper first functional end cap 40a has for instance a lateral outward exposed functional block front face 60a, which may be aligned with a lateral front face 23 of left glass pane edge 22 of first glass pane 20 and which may form an extension of lateral front face 23 of left glass pane edge 22. The functional block front face 60a of first functional block 58a of upper first functional end cap 40a may form the extension of the lateral front face 23 of left glass pane edge 22 while providing a gap or a distance to lateral front face 23 of left glass pane edge 22 or it may form the extension of a lateral front face 123 of left glass pane edge 22, by being flush with the lateral front face 23 of left glass pane edge 22. The functional block front face 60a also, for example, aligns with the lateral front face 42a of upper first functional end cap 40a. A lower functional block face 64a of first functional block 58a of upper first functional end cap 40a may also form the vertical termination of glass pane receiving groove 51a, and extends at least substantially in parallel to upper glass pane edge 24 of first glass pane 20 as well as transversally to functional block front face 60a of first functional block 58a.

As shown in FIGS. 3 and 4, the first functional block 58a and also functional block front face 60a of first functional block 58a may also extend at least substantially vertically from lower functional block face 64a of first functional block 58a to an upper functional block face 62a, which extends at least substantially in parallel to lower functional block face 64a of first functional block 58a, of first functional block 58a, the lower functional block face 64a being flush with the upper face 44a of upper first functional end cap 40a, and may thus form an extension of lateral front face 23 of left glass pane edge 22 up to the level of the upper face 44a of upper first functional end cap 40a. A wall 59a of first functional block 58a extending transversally to functional block front face 60a of first functional block 58a and to lower functional block face 64a (or at least substantially in parallel to pane face 21 of first glass pane 20) in first embodiment also forms the functional end cap side face 48a of upper first functional end cap 40a, which, in closed state of glass door apparatus 1 is overlapped by first leg 172 of weather strip 170 and is abutted by first leg 172 of weather strip 170. This means that the complementary counterpiece associated with first cavity of upper first functional end cap 40a interacts, in an overlapping and contacting manner, with the first functional block 58a of upper first functional end cap 40a. When the first glass pane 20 is inserted into the glass pane receiving groove 51a of upper first functional end cap 40a, pane face 21 of first glass pane 20 is flush with wall 59a of first functional block 58a and forms a portion, which is at least substantially parallel to pane face 21 of first glass pane 20, of the limiting contour of the first cavity 54a of the upper first functional end cap 40a.

The upper second glass door leaf frame part 130a has, for instance, a upper second functional end cap 140a (detailed in FIGS. 6 to 8), by which the right frame body longitudinal end 134a of upper second frame body 132a is covered and which is horizontally at level with right glass pane edge 122 of second glass pane 20. The connection between upper second functional end cap 140a and upper second frame body 132a is possible, as in the case of connection between upper first functional end cap 40a and upper first frame body 32a (for instance by means of through-holes 141a of upper second functional end cap 140a).

The upper second functional end cap 140a also has a central glass pane receiving groove 151a, which, with respect to lower face 146a of upper second functional end cap 140a protrudes, protrudes inwards in a manner at least substantially parallel to right glass pane edge 122 of second glass pane 120 and at least substantially vertical in a direction towards upper face 144a of upper second functional end cap 140a and which, in the opposite direction, opens downwards and in which the second glass pane 120 is introduced, wherein for instance buffer elements (e.g., of elastic material) are disposed between the second glass pane 120 and the upper second functional end cap 140a in the central glass pane receiving groove 151a.

The complementary counterpiece associated with the first protrusion 52a of upper first functional end cap 40a of left glass door leaf 100 is formed in this case by the first functional end cap side face 148a of upper second functional end cap 140a. As shown in FIG. 2, in closed state of glass door apparatus 1, the first protrusion 52a of upper first functional end cap 40a is overlapping with first functional end cap side face 148a of upper second functional end cap 140a, to improve sealing.

The upper second functional end cap 140a also has a second protrusion 152a, which, with respect to pane face 121 of second glass pane 120, is disposed opposite to the first functional end cap side face 148a of the upper second functional end cap 140a and which, with respect to lateral front face 142a of upper second functional end cap 140a, protrudes laterally outwardly in a manner at least substantially parallel to pane face 121 of the second glass pane 120 and in a direction away from the second glass pane 120. As shown in FIG. 2, in closed state of glass door apparatus 1, the second protrusion 152a of upper second functional end cap 140a overlaps with functional end cap side face 48a of upper first functional end cap 40a and also with left glass pane edge 22 of first glass pane 20. In the first embodiment, the second protrusion 152a of upper second functional end cap 140a engages first cavity 54a of upper first functional end cap 40a and forms a further complementary counterpiece of left glass door leaf 100 associated with first cavity 54a of upper first functional end cap 40a, thereby improving the sealing.

The second protrusion 152a of upper second functional end cap 140a may extend at least substantially in a vertical direction over a part of vertical extension or at least substantially over the entire vertical extension of upper second functional end cap 140a between the upper face 144a and lower face 146a of upper second functional end cap 140a. The second protrusion 152a of upper second functional end cap 140a may also at least partially form the second functional end cap side face 150a of upper second functional end cap 140a.

The upper second functional end cap 140a has, for instance, a first cavity 154a, which, with respect to front face 142a of upper second functional end cap 140a, protrudes laterally inwardly in a manner at least substantially parallel to pane face 121 of second glass pane 120 and towards second glass pane 120 and which, in the opposite direction, opens laterally outwardly. The upper second functional end cap 140a also has, for example, a second cavity 156a, which, with respect to front face 142a of upper second functional end cap 140a, protrudes laterally inwardly in a manner at least substantially in parallel to pane face 121 of second glass pane 120 and towards second glass pane 120 and which, in the opposite direction, opens laterally outwardly and which, with respect to pane face 121 of second glass pane 120, is disposed opposite to the first cavity 154a of the upper second functional end cap 140a, so that between cavity 154a and second cavity 156a of upper second functional end cap 140a a second functional block 158a is formed. The first cavity 154a and the second cavity 156a of upper second functional end cap 140a have for example at least substantially a U-shaped profile section, respectively. The first cavity 154a of upper second functional end cap 140a may also extend at least substantially vertically over a portion or at least substantially over the entire vertical extension of the upper second functional end cap 140a between the upper face 144a and lower face 146a of upper second functional end cap 140a. The second cavity 156a of upper second functional end cap 140a may extend at least substantially vertically over a portion or at least substantially the entire vertical extension of the upper second functional end cap 140a between the upper face 144a and lower face 146a of upper second functional end cap 140a.

The second leg 178 of the weather strip 170 engages the first cavity 154a of the upper second functional end cap 140a and the third leg 180 of the weather strip 170 engages the second cavity 156a of the upper second functional end cap 140a so that the second leg 178 and the third leg 180 of the weather strip 170 surround, for example the pane face 121 of the second glass pane 120 and the second functional block 158a. As a result, the weather strip 170 may be connected, e.g. by means of a clamping of the second leg 178 and of the third leg 180 of the weather strip 170 against the pane face 121 of the second glass pane 120 and against the second functional block 158a, with the pane face 121 of the second glass pane 120 and with the second functional block 158a.

The second functional block 158a, for example, has a lateral, outwardly exposed functional block face 160a which can be aligned with a lateral front face 123 of the right glass pane edge 122 of the second glass pane 120 and which can form an extension of the lateral front face 123 of the right glass pane edge 122. The functional block front face 160a of the second functional block 158a may form the extension of the lateral front face 123 of the right glass pane edge 122, while having a gap or distance to the lateral front face 123 of the right glass pane edge 122, or may form the extension of the lateral front face 123 of the right glass pane edge 122, while being flush with the lateral front face 123 of the right glass pane edge 122. Further, the functional block face 160a is aligned with the lateral front face 142a of the upper second functional end cap 140a. A lower functional block face 164a of the second functional block 158a of the upper second functional end cap 140a can also form the vertical termination of the glass pane receiving groove 151a and extend at least substantially parallel to the upper glass pane edge 124 of the second glass pane 120 as well as transversely to the functional block face 160a of the second functional block 158a. As shown in FIGS. 6 to 8, the second functional block 158a and also the functional block face 160a of the second functional block 158a can also extend at least substantially vertically from the lower functional block face 164a of the second functional block 158a to an upper functional block face 162a, which is at least substantially parallel to the lower functional block face 164a of second functional block 158a and which is aligned with the upper face 144a of the upper second functional end cap 140a, of the second functional block 158a and may thus form an extension of the lateral front face 123 of the right glass pane edge 122 to the level of the upper face 144a of the upper second functional end cap 140a.

In the following, the second alternative of first example embodiment is described with reference to FIGS. 1 and 9 to 15.

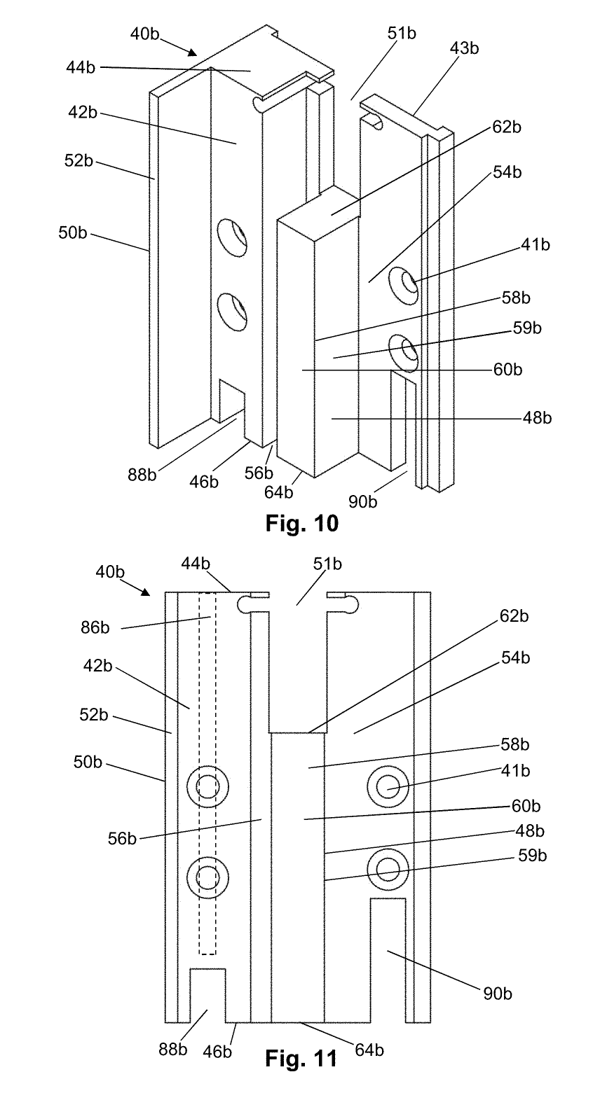

The lower first glass leaf frame part 30b according to the second alternative has a lower first functional end cap 40b (shown in more detail in FIGS. 10 to 12), by which the left frame body longitudinal end 34b of the lower first frame body 32b is covered, and which is positioned at level of left glass pane edge 22 of the first glass pane 20. The lower first functional end cap 40b is connected to the lower first frame body 32b, e.g. by means of a screwed connection, the lower first functional end cap 40b has, for example, at least one through-hole 41b (e.g., four through-holes shown in FIGS. 10-12) for receiving a threaded pin, by which the lower first functional end cap 40b is connected to the lower first frame body 32b. However, the lower first functional end cap 40b may also be otherwise connected to the lower first frame body 32a, e.g. by means of a clamping connection or by means of a locking or latching connection (e.g., snap connection).

The lower first functional end cap 40b also has a central glass pane receiving groove 51b, which, with respect to the upper face 44b of the lower first functional end cap 40b, protrudes inwards in a manner at least substantially parallel to the left glass pane edge 22 of the first glass pane 20 as well as at least substantially vertical in a direction towards the lower face 46b of the lower first functional end cap 40b and which, in the opposite direction, opens upwards and into which the first glass pane 20 is introduced, wherein, for example, buffer elements (for example, of elastic material) are arranged between the first glass pane 20 and the lower first functional end cap 40b in the glass pane receiving groove 51b.

The lower first functional end cap 40b also has a first protrusion 52b, which, with respect to the lateral front face 42b of the lower first functional end cap 40b, protrudes laterally outwards in a manner at least substantially parallel to the pane face 21 of the first glass pane 20 and in the direction away from the first glass pane 20, wherein, in the closed state of the glass door apparatus 1, the first protrusion 52b of the lower first functional end cap 40b is overlapped with a complementary counterpiece of the left glass door leaf 100, which is associated with the first protrusion 52b of the lower first functional end cap 40b. The first protrusion 52b may extend at least substantially in a vertical direction over a portion of the vertical extension or at least substantially over the entire vertical extension of the lower first functional end cap 40b between the upper face 44b and the lower face 46b of the lower first functional end cap 40b. Further, the first protrusion 52b of the lower first functional end cap 40b can at least partially form the second functional end cap side face 50b of the lower first functional end cap 40b. Further, the first functional end cap side face 48b of the lower first functional end cap 40b is disposed opposite to the first protrusion 52b of the lower first functional cap 40b with respect to the pane face 21 of the first glass pane 20.

Furthermore, the lower first functional end cap 40b has a first cavity 54b, which, with respect to the lateral front face 42b of the lower first functional end cap 40b, protrudes laterally inwards in a manner at least substantially parallel to the pane face 21 of the first glass pane 20 as well as in the direction towards the first glass pane 20 and which, in the opposite direction, opens laterally outwards. In the first embodiment, the first cavity 54b of the lower first functional end cap 40b also opens outwardly in a direction transversely to the pane face 21 of the first glass pane 20 and away from the pane face 21 of the first glass pane 20, wherein a limiting contour which delimits the first cavity 54b of the lower first functional end cap 40b of the lower first functional end cap 40b has an at least substantially L-shaped profile cross-section. The first cavity 54b of the lower first functional end cap 40b can extend at least substantially in a vertical direction over a part of the vertical extension or at least substantially over the entire vertical extension of the lower first functional end cap 40b between the upper face 44b and the lower face 46b of lower first functional end cap 40b. In the closed state of the glass door apparatus, the first cavity 54b of the lower first functional end cap 40b is overlapped with a complementary counterpiece of the left glass door leaf 100 which is associated with the first cavity 54b of the lower first functional end cap 40b. In the first example embodiment, the complementary counterpiece of the left glass door leaf 100, which is associated with the first cavity 54b of the lower first functional end cap 40b, is formed by the first leg 172 of the weather strip 170. As shown in FIG. 9, the first leg 172 overlaps the left glass pane edge 22 of the first glass pane 20 in the closed state of the glass door apparatus 1 and engages with the first complementary cavity 54b of the lower first functional end cap 40b, having the corresponding complementary counterpiece of the left glass door leaf 100, wherein the first leg 172 overlaps and abuts a first wall, which defines the first cavity 54b of the lower first functional end cap 40b and which, in the first embodiment, is formed by the functional end cap side face 48b of the upper first functional end cap 40b, thereby improving the sealing. The first leg 172 of the weather strip 170, for example, extends at least substantially vertically (for example, downwards) beyond the lower glass pane edge 26 of the first glass pane 20, and optionally extends at least substantially up to the lower face 46b of the lower first functional end cap 40b.

Moreover, the lower first functional end cap 40b has a second cavity 56b, which, with respect to the lateral front face 42b of the lower first functional end cap 40b, protrudes laterally inward in a manner at least substantially parallel to the pane face 21 of the first glass pane 20 as well as in the direction towards the first glass pane 20 and which, with respect to the pane face 21 of the first glass pane 20, is disposed opposite to the first cavity 54b of the lower first functional end cap 40b so that a first functional block 58b is formed between the first cavity 54b and the second cavity 56b of the lower first functional end cap 40b. The second cavity 56b of the lower first functional end cap 40b has, for example, an at least substantially U-shaped profile cross-section. The second cavity 56b of the lower first functional end cap 40b may extend at least substantially in a vertical direction over a portion of the vertical extension or at least substantially over the entire vertical extension of the lower first functional end cap 40b between the upper face 44b and the lower face 46b of the lower first functional end cap 40b.

The first functional block 58b has, for example, a lateral outwardly exposed functional block front face 60b which can be aligned with a lateral front face 23 of the left glass pane edge 22 of the first glass pane and which can form an extension of the lateral front face 23 of the left glass pane edge 22. The functional block front face 60b of the first functional block 58b may form the extension of the lateral front face 23 of the left glass pane edge 22, while having a gap or a distance from the lateral front face 23 of the left glass pane edge 22, or may form the extension of the lateral front face 23 of the left glass pane edge 22, while being flush with the lateral front face 23 of the left glass pane edge 22. Further, the functional block front face 260b is aligned with the lateral front face 242b of the lower first functional end cap 240b. An upper functional block face 62b of the first functional block 58b of the lower first functional end cap 40b can also form the vertical termination of the glass pane receiving groove 51b, and extend at least substantially parallel to the lower glass pane edge 24 of the first glass pane 20 as well as transversely to the functional block front face 60b of the first functional block 58b. As shown in FIGS. 10 and 11, the first functional block 58b and also the functional block front face 60b of the first functional block 58b can also extend at least substantially vertically from the upper functional block face 62b up to a lower functional block face 64b of the first functional block 58b, which lower functional block face 64b is at least substantially parallel to the upper functional block face 62b of first functional block 62b and is aligned with the lower face 46b of the lower first functional end cap 40b, and may thus form an extension of the lateral front face 23 of the left glass pane edge 22 to the level of the lower face 46b of lower first functional end cap 40b.

A wall 59b extending transversally to the functional block front face 60b of first functional block 58b and transversally to lower functional block face 64a (at least substantially parallel to pane face 21 of first glass pane 20) of first functional block 58b forms in the first embodiment also the functional end cap side face 48b of lower first functional end cap 40b, which in the closed state of glass door apparatus 1 is overlapped by first leg 172 of weather strip 170 and against which the first leg of weather strip 170 abuts. This means that the complementary counterpiece associated with the first cavity of lower first functional end cap 40b interacts with the first functional block 58b of lower first functional end cap 40b in overlapping and abutting fashion. When the first glass pane 20 is inserted into the glass pane receiving groove 51b of lower first functional end cap 40b, the pane face 21 of first glass pane 20 aligns with wall 59b of first functional block 58b and forms a portion, which is at least substantially parallel to pane face 21 of first glass pane 20, of the limiting contour of first cavity 54b of lower first functional end cap 40b.

Further, the lower second glass door leaf frame portion 130b has a lower second functional end cap 140b (shown in more detail in FIGS. 13 to 15) by which the right frame body longitudinal end portion 134b of the lower second frame body 132b is covered and which is horizontally aligned with the right glass pane edge portion 122 of second glass pane 20. The connection between the lower second functional end cap 140b and the lower second frame body 132b is analogous to the connection between the lower first functional end cap 40b and the lower first frame body 32b (for example, by means of the through holes 141b of the lower second functional end cap 140b).

The lower second functional end cap 140b also has a central glass pane receiving groove 151b, which protrudes, with respect to the upper face 144b of the lower second functional end cap 140b, inwards in a manner at least substantially parallel to the right glass pane edge 122 of the second glass pane 120 and at least substantially vertical in the direction toward the lower face 146b of the lower second functional end cap 140b and which, in the opposite direction, opens upwards and into which the second glass pane 120 is introduced, wherein, for example buffer elements (of an elastic material, for example) are arranged between the second glass pane 120 and the lower second functional end cap 140b in the glass pane receiving groove 151b.

The complementary counterpiece of the left glass door leaf 100 associated with the first projection 52b of the lower first functional end cap 40b is formed in this case by the first functional end cap side face 148b of the lower second functional end cap 140b. As shown in FIG. 9, in the closed state of the glass door apparatus 1, the first protrusion 52b of the lower first functional end cap 40b is overlapped with the functional end cap side face 148b of the lower second functional end cap 140b, whereby the sealing can be improved.

The lower second functional end cap 140b also has a second protrusion 152b which, with respect to the pane face 121 of the second glass pane 120, is disposed opposite the first functional end cap side face 148b of the lower second functional end cap 140b and which, with respect to the lateral front face 142b of the lower second functional end cap 140b, protrudes laterally outwards in a manner at least substantially parallel to the pane face 121 of the second glass pane 120 and in the direction away from the second glass pane 120. As shown in FIG. 9, in the closed state of the glass door apparatus 1, the second protrusion 152b of the lower second functional end cap 140b is overlapped with the first functional end cap side face 48b of the lower first functional cap 40b and also with the left glass leaf edge 22 of the first glass pane 20. In the first embodiment, the second protrusion 152b of the lower second functional end cap 140b engages the first cavity 54b of the lower first functional end cap 40b and forms a complementary counterpiece of the left glass door leaf 100 associated with the first cavity 54b of the lower first functional end cap 40b, whereby sealing can be further improved. Although it is shown in FIG. 9 that both the first leg 172 of the weather strip 170 and the second protrusion 152b of the lower second functional end cap 140b engage the first cavity 54b of the lower first functional end cap 40b, it is also possible that, in the first example embodiment, the weather strip 170 is absent, and that the complementary counterpiece of the left glass door leaf 100, which is associated with the first cavity 54b of the lower first functional end cap 40b, is formed only by the second protrusion 152b which engages the first cavity 54b of the lower first functional end cap 40b.

The second protrusion 152b of the lower second functional end cap 140b may extend, at least substantially, in a vertical direction along a portion of the vertical extension or at least substantially over the entire vertical extension of the lower second functional end cap 140b between the upper face 144b and the lower face 146b of the lower second end cap 140b. Furthermore, the second protrusion 152b of the lower second functional end cap 140b can at least partially form the second functional end cap side face 150b of the lower second functional end cap 140b.

The lower second functional end cap 140b comprises, for example a first cavity 154b, which, with respect to the lateral front face 142b of the lower second functional end cap 140b, protrudes laterally inwards in a manner at least substantially parallel to the pane face 121 of the second glass pane 122 as well as in the direction of the second glass pane 122 and which, in the opposite direction, opens laterally outwards. Further, the lower second functional end cap 140b includes, for example, a second cavity 156b, which, with respect to the lateral front face 142b of the lower second functional end cap 140b, protrudes laterally inwards in a manner at least substantially parallel to the pane face 121 of the second glass pane 122 as well as in the direction of the second glass pane 122 and which, in the opposite direction, opens laterally outwards and which, with respect to the pane face 121 of the second glass pane 122, is disposed opposite to the first cavity 154b of the lower second functional end cap 140b so that a second functional block 158b is formed between the first cavity 154b and the second cavity 156b of the lower second functional end cap 140b. The first cavity 154b and the second cavity 156b of the lower second functional end cap 140b include, for example, an at least a substantially U-shaped profile cross-section. The first cavity 154b of the lower second functional end cap 140b may extend in at least substantially vertical direction over a portion of the vertical extension or at least substantially over the entire vertical extension of the lower second functional end cap 140b between the upper face 144b and the lower face 146b of the lower second functional end cap 140b. The second cavity 156b of the lower second functional end cap 140b may extend at least substantially in vertical direction over a portion of the vertical extension or at least substantially over the entire vertical extension of the lower second functional end cap 140b between the upper face 144b and the lower face 146b of the lower second functional end cap 140b.

The second leg 178 of the weather strip 170 engages the first cavity 154b of the lower second functional end cap 140b and the third leg 180 of the weather strip 170 engages the second cavity 156b of the lower second functional end cap 140b so that the second leg 178 and the third leg 180 of the weather strip 170 surround (e.g., engage in a gripping manner) the pane face 121 of the second glass pane 120 and the second functional block 158b. As a result, the weather strip 170, may for example be connected to the pane face 121 of the second glass pane 120 and to the second functional block 158b by means of clamping of the second limb 178 and of the third limb 180 of the sealing cable 170 against the pane face 121 of the second glass pane 120 and against the second functional block 158b.

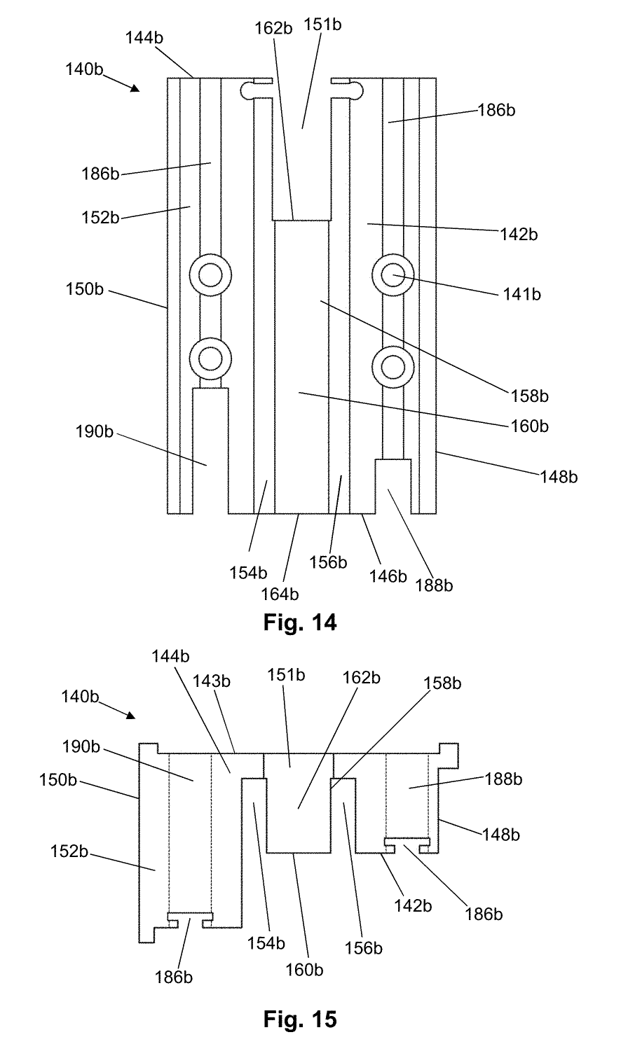

The second functional block 158b has, for example, a lateral, outwardly exposed functional block face 160b which is aligned with a lateral front face 123 of the right glass pane edge 122 of the second glass pane 120 and which can form an extension of the lateral front face 123 of the right glass pane edge 122. The functional block face 160b of the second functional block 158b may form the extension of the lateral front face 123 of the right glass pane edge 122, while having a gap with respect to the lateral front face 123 of the right glass pane edge 122, or may form the extension of the lateral front face 123 of the right glass pane edge 122, while being flush with the lateral front face 123 of the right glass pane edge 122. Further, the functional block face 160b is aligned with the lateral front face 142b of the lower second functional end cap 40b. An upper functional block face 162b of the second functional block 158b of the lower second functional end cap 140b can also form the vertical termination of the glass pane receiving groove 151b and extend at least substantially parallel to the lower glass pane edge 126 of the second glass pane 120 as well as transversely to the functional block face 160b of the second functional block 158b. In FIGS. 13 and 14, the second functional block 158b and also the functional block face 160b of the second functional block 58b can extend at least substantially vertically from the upper functional block face 162b of the second functional block 162b to a lower functional block face 164b of second functional block 58b, which lower functional block face 164b extends at least substantially parallel to the upper functional block face 162b of the second functional block 158b and is aligned with the lower face 146b of the lower second functional end cap 140b, and may thus form an extension of the lateral front face 123 of the right glass pane edge 122 to the level of the lower face 146b of the lower second functional end cap 140b.

The first embodiment described above is suitable for example for use on a rotating or tilting glass door leaf, since one (for example a single) leg of the weather strip engages in only one (for example the only) cavity of the respective first functional cap and since, due to the opening of the first cavity in a direction transversely with respect to the pane face of the first glass pane, the second protrusion of the respective second functional end cap can engage the first cavity during a pivoting movement of the right glass door leaf into the first cavity in a direction which is at least substantially transversal to the pane face of the first glass pane. By means of above said first embodiment of the present invention, sound/noise, moisture, and wind can be effectively prevented from penetrating through the glass door apparatus 1. Thus, the noise protection, moisture protection and wind protection properties of the glass device can be improved.

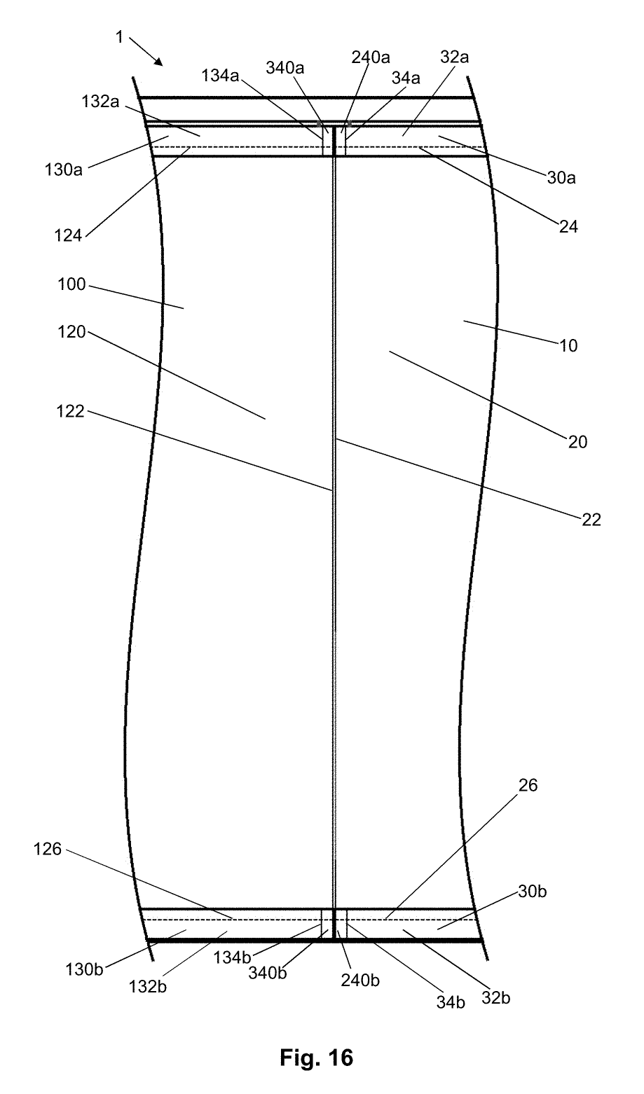

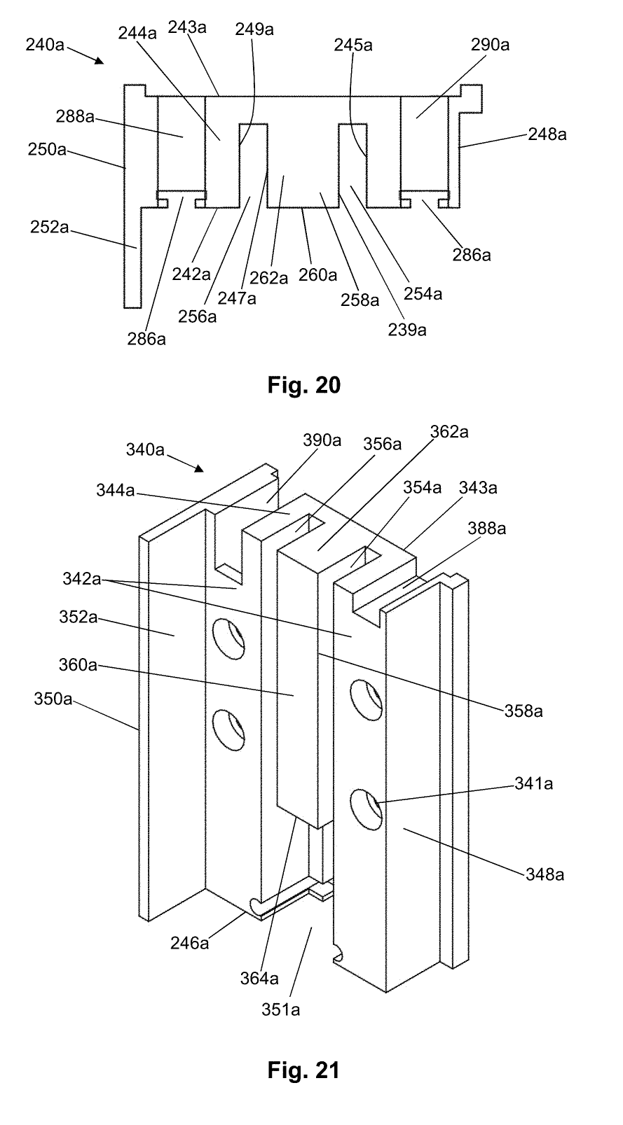

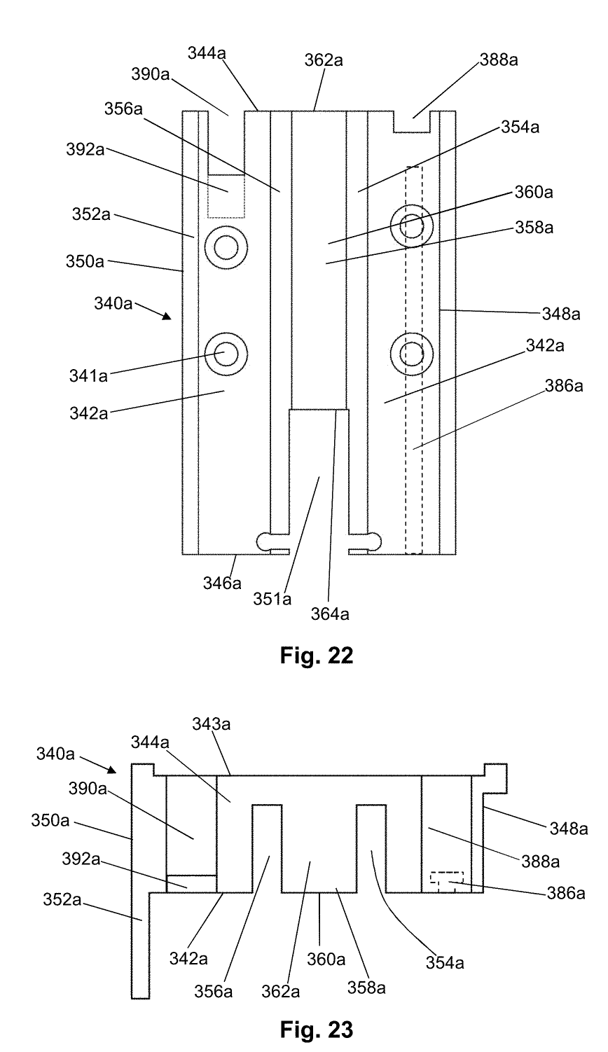

Next, a second embodiment of the present invention will be described with reference to FIGS. 16 to 23.

FIGS. 16 to 23 illustrate a glass door apparatus 1 according to a second example embodiment of the present invention.

The glass door apparatus 1 according to the second example embodiment generally has a right glass door leaf 10 and a left glass door leaf 100.

The right glass door 10 has the first glass pane 20, the upper first glass door leaf frame part 30a, and the lower first glass door leaf part 30b which are at least substantially the same as those of the first embodiment, and a detailed description thereof will be omitted.

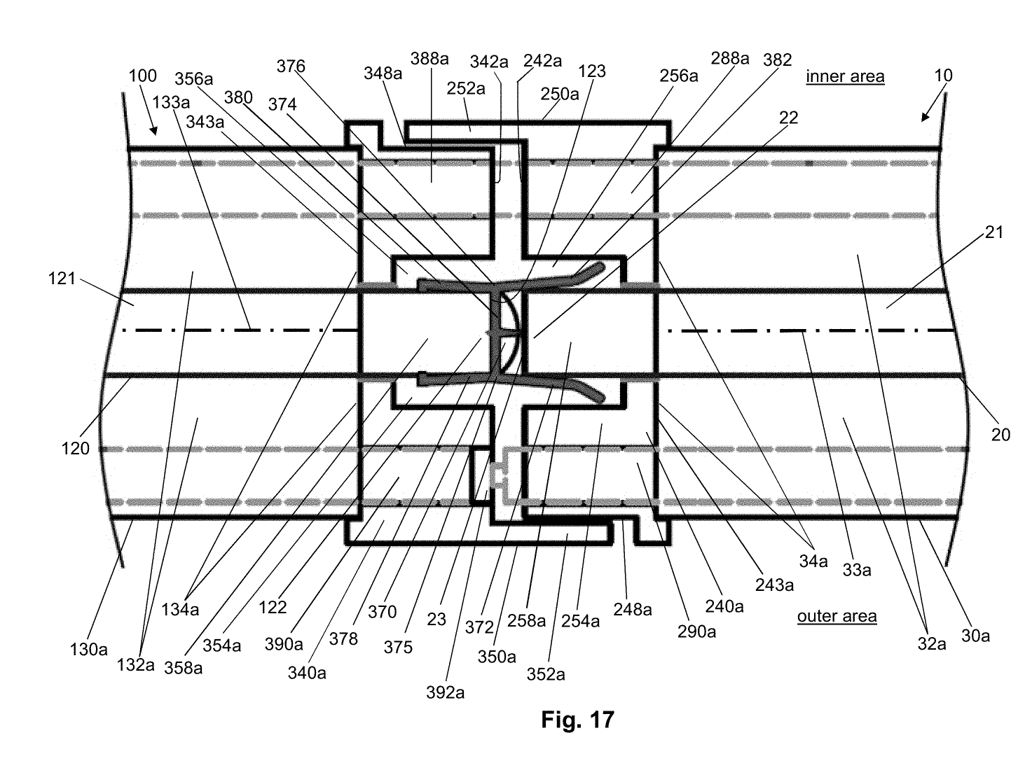

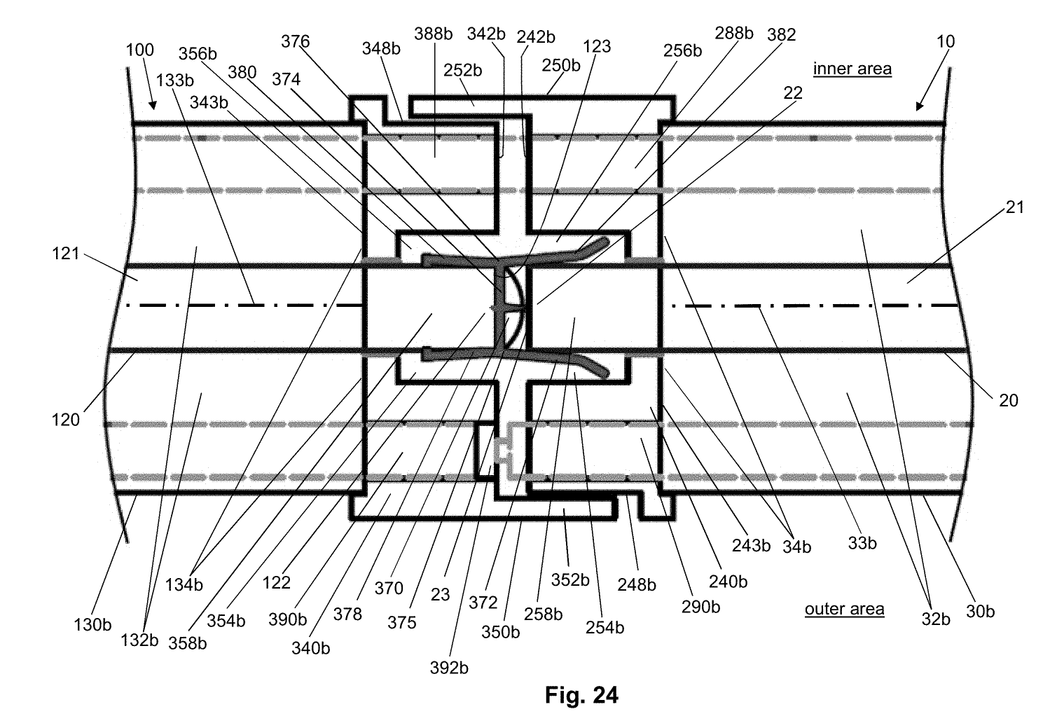

As shown in FIGS. 17 and 24 in a cross-section, the elongated weather strip 370, which defines a weather strip longitudinal axis and which is attached to the right glass pane edge 122 of the second glass pane 120 and extends with its longitudinal axis of the weather strip along the right glass pane edge 122 of the second glass pane 320. The weather strip 370 is for example made of a substantially transparent and UV-resistant plastic material, such as polyethylene terephthalate glycol or also called glycol-modified polyethylene terephthalate (short PETG or PET-G).

In the second embodiment of the present invention, the weather strip 370 has an H-shaped cross-section profile with, for example, a central transverse web 374 having a first transverse web end 375 and a second transverse web end 376, a first leg 372 extending from the right glass pane edge 122 of the second glass pane 120 (in particular from the first transverse web end 375), at least substantially parallel to the pane face 121 of the second glass pane 120, and laterally away from the second glass pane 120, a second leg 378 which extends from the first transverse web end 375 in a direction opposite to the first leg 372 and overlaps the right glass pane edge 122 of second glass pane 120, a third leg 380 which extends from the second transverse web end 376 in the same direction as the second leg 378 and overlaps the right glass pane edge 122 of the second glass pane 120, and a fourth leg 382, which extends from the second transverse web end 376 in a direction opposite the third leg 380. The second leg 378 and the third leg 380 at least partially surround the pane face 121 of the second glass pane 120, the weather strip 370 being supported by the second leg 378 and the third leg 180, for example, being provided by means of clamping to the second glass pane 120.

The weather strip 370 extends for example at least substantially over most of the longitudinal extension or over the entire longitudinal extension of the right glass pane edge 122 of the second glass pane 120 and/or of the left glass pane edge 22 of the second glass pane 20. Furthermore, the weather strip 370 can extend beyond the upper glass pane edge and/or respective glass pane. In the closed state of glass door apparatus 1, the first leg 372 overlaps the left glass pane edge 22 of the first glass pane 20 and the first leg 372 abuts the pane face 21 of the first glass pane 20 and the fourth leg 382 overlaps the left glass pane edge 22 of the first glass pane 20 and the fourth leg 382 abuts, opposite the first leg 372 with respect to the pane face 21 of the first glass pane 20, against the pane face 21 of the first glass pane 20 so that the weather strip 170 at least substantially seals a gap between the left glass pane edge 22 of the first glass pane 20 and the right glass pane edge 122 of the second glass pane 120. The aforementioned legs can be elastic so that the first leg 372 and the fourth leg 382 are biased against the pane face 21 of the first glass pane 20 and/or so that the second leg 378 and the third leg 380 are biased against the pane face 321 of the second glass pane 320.

In the following, a first and second alternative of the second example embodiment are described. In a glass door apparatus according to the present invention, either the first or the second alternative of the second embodiment can be provided. However, both alternatives of the second embodiment can also be provided simultaneously (i.e., in combination) in a glass door apparatus according to the present invention.

The first alternative of the second example embodiment will be described with reference to FIGS. 16 to 23.

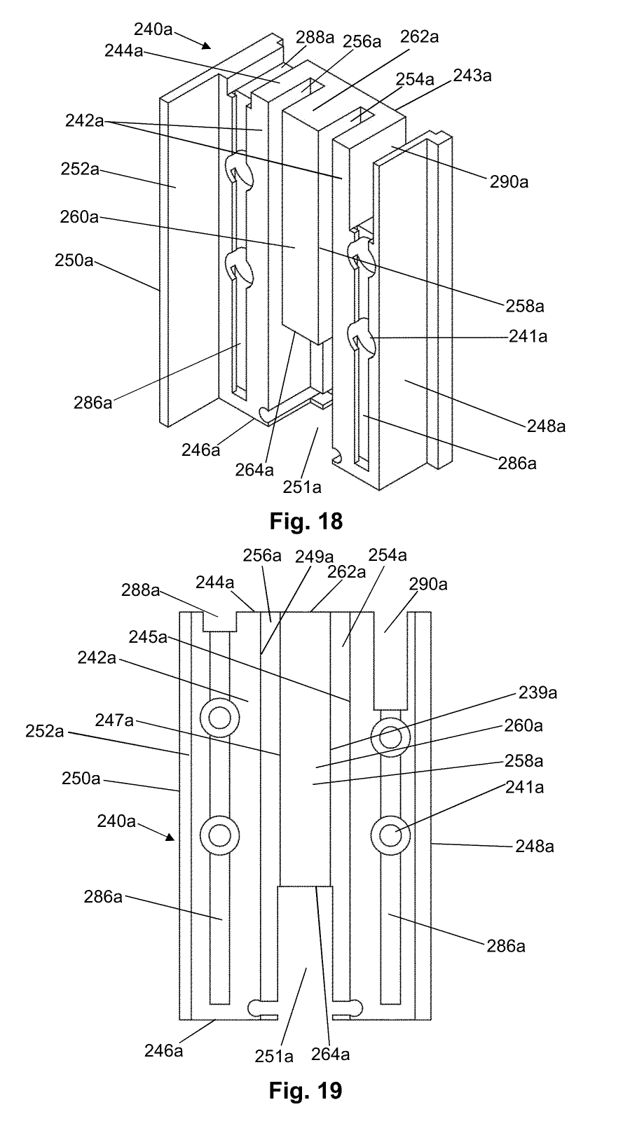

As shown in FIGS. 16 and 17, the upper first glass leaf frame part 30a according to the first alternative of the second example embodiment has a upper first functional end cap 240a (shown in more detail in FIGS. 18 to 20) by which the left frame body longitudinal end 34a of the upper first frame body 32a is covered and which is arranged horizontally at the level of the left glass pane edge 22 of the first glass pane 20. The upper first functional end cap 240a is connected to the upper first frame body 32a, for example by means of a screwed connection, the upper first functional end cap 240a being, for example, at least one through hole 241a (as an example, four through-holes are shown in FIGS. 18 to 20) for receiving a threaded pin by which the upper first functional end cap 240a is connected to the upper first frame body 32a. However, the upper first functional end cap 240a may also be otherwise connected to the upper first frame body 32a, for example by means of a clamping connection or a locking or latching connection (e.g., snap connection).

The upper first functional end cap 240a also has a central glass pane receiving groove 251a, which protrudes, with respect to the lower face 246a of the upper first functional end cap 240a, inwards in a manner at least substantially parallel to the left glass pane edge 22 of the first glass pane 20 and at least substantially vertical in a direction toward the upper face 244a of the upper first functional end cap 240a and which, in the opposite direction, opens downwards and into which the first glass pane 20 is introduced, wherein, for example, buffer elements (of an elastic material, for example) are arranged between the first glass pane 20 and the upper first functional end cap 240a in the glass pane receiving groove 251a.

The upper first functional end cap 240a also has a first protrusion 252a, which, with respect to the lateral front face 242a of the upper first functional end cap 240a, protrudes laterally outwardly in a manner at least substantially parallel to the pane face 21 of the first glass pane 20 and in the direction away from the first glass pane 20, wherein, in the closed state of the glass door apparatus 1, the first protrusion 252a of the upper first functional end cap 240a is overlapped with a complementary counterpiece of the left glass door leaf 100 associated with the first protrusion 252a of the upper first functional end cap 240a. The first protrusion 252a may extend at least substantially in a vertical direction over a portion of the vertical extension or at least substantially over the entire vertical extension of the upper first functional end cap 240a between the upper face 244a and the lower face 246a of the upper first functional end cap 40a. Further, the first protrusion 252a of the upper first functional end cap 240a can at least partially form the second functional end cap side face 250a of the upper first functional end cap 240a. Further, the first functional end cap side face 248a of the upper first functional end cap 240a is disposed opposite to the first protrusion 252a of the upper first functional cap 240a with respect to the pane face 21 of the first glass pane 20.

Furthermore, the upper first functional end cap 240a has a first cavity 254a, which, with respect to the lateral front face 242a of the upper first functional end cap 240a, protrudes laterally inwards in a manner at least substantially parallel to the pane face 21 of the first glass pane 20 and in the direction toward the first glass pane 20 and which, in the opposite direction, opens laterally outwardly. In the first alternative of the second embodiment, the first cavity 254a is arranged in the direction of the pane face 21 of the first glass pane 20 at a distance from the first functional end cap side face 248a. The first cavity 254a of the upper first functional end cap 240a comprises for example an at least substantially U-shaped cross-section. The first cavity 254a is at least partially limited by a first inner wall 239a, which extends at least substantially parallel to the pane face 21 of the first glass pane 20, preferably also in alignment with the first pane face 21 of the first glass pane 20, as well as in the direction towards the the first glass pane 20, and by a second inner wall 245a of the upper first functional end cap 240a, said second inner wall 245a being disposed at a distance from the first inner wall 239a of the upper first functional end cap 240a in the direction transverse to the pane face 21 of the first glass pane 20 and opposite to the first inner wall 239a and extending at least substantially parallel to the pane face 21 of the first glass pane 20, preferably also in alignment with the first pane face 21 of the first glass pane 20. The first cavity 254a of the upper first functional end cap 240a may extend at least substantially in a vertical direction over a portion of the vertical extension or at least substantially over the entire vertical extension of the upper first functional end cap 240a between the upper face 244a and the lower face 246a of the upper first end cap 240a. In the closed state of the glass door apparatus 1, the first cavity 254a of the upper first functional end cap 240a is overlapped with a complementary counterpiece of the left glass door leaf 100, which is associated with the first cavity 254a of the upper first functional end cap 240a. In the example second embodiment, the complementary counterpiece of the left glass door leaf 100, which is associated with the first cavity 254a of the upper first functional end cap 40a, is formed by the first leg 372 of the weather strip 370. As shown in FIG. 17, the first leg 372 of the weather strip 370 overlaps the left glass pane edge 22 of the first glass pane 20 in the closed state of the glass door apparatus 1 and engages the first cavity 254a of the upper first functional end cap 240a to form the corresponding complementary counterpiece of the left glass door leaf 100, the first leg 372 overlapping and abutting the first inner wall 239a of the upper first functional end cap 240a, whereby the sealing can be improved. The first leg 378 can also optionally be curved such that it additionally abuts the second inner wall 245a of the upper first functional end cap 240a. The first leg 372 of the weather strip 370, for example, extends at least substantially vertically (for example upwards) beyond the upper glass pane edge 24 of the first glass pane 20, and optionally extends at least substantially up to the upper face 244a of the upper first functional end cap 240a.

The upper first functional end cap 240a also has a second cavity 256a, which, with respect to the lateral front face 242a of the upper first functional end cap 240a, protrudes laterally inwards in a manner at least substantially parallel to the pane face 21 of the first glass pane 20 as well as in the direction towards the first glass pane 20 and which, in the opposite direction, opens laterally outwardly and which is disposed, with respect to face 21 of first glass pane 20, opposite to the first cavity 254a of the upper first functional end cap 240a so that a first functional block 258a is formed between the first cavity 254a and the second cavity 256a of the upper first functional end cap 240a. The second cavity 256a of the upper first functional end cap 240a includes, for example, an at least substantially U-shaped cross-section. The second cavity 254a is at least partially limited by a third inner wall 247a of the upper first functional end cap 240a, which third inner wall 247a extends at least substantially parallel to the pane face 21 of the first glass pane 20, preferably also in alignment with the first pane face 21 of the first glass pane 20, and in the direction towards the first glass pane 20 and is spaced apart from the first inner wall 239a of the upper first functional end cap 240a (for instance with respect to the pane face 21 of the first glass pane 20), and by a fourth inner wall 249a of the upper first functional end cap 240a, which fourth inner wall 249a is spaced apart from the third inner wall 247a of the first upper functional end cap 240a in a direction transverse to the pane face 21 of the first glass pane 20 and is opposite to the third inner wall 247a and which extends at least substantially parallel to the pane face 21 of the first glass pane 20, preferably also in alignment with the first pane face 21 of the first glass pane 20, as well as in the direction towards the first glass pane 20. The second cavity 256a of the upper first functional end cap 240a may extend in the vertical direction over a portion of the vertical extension or at least substantially over the entire vertical extension of the upper first functional end cap 240a between the upper face 244a and the lower face 246a of the upper first functional end cap 240a respectively. In FIG. 17, the fourth leg 382 of the weather strip 370 overlaps the left glass pane edge 22 of the first glass pane 20 in the closed state of the glass door apparatus 1 and engages with the formation of a complementary counterpiece of the second cavity 254a of the upper first functional end cap 240a of left glass door leaf 100 into the second cavity 256a of the upper first functional cap 240a with the fourth leg 382 overlapping and engaging the third inner wall 247a of the upper first functional end cap 240a, whereby the sealing can be improved. The fourth leg 382 may also optionally be curved such that it additionally abuts the fourth inner wall 249a of the upper first functional end cap 240a. The fourth leg 382 of the weather strip 370 extends, for example, over the upper glass pane edge 24 of the first glass pane 20 at least substantially vertically (for example, upwards) and optionally extends at least substantially up to the upper face 244a of the upper first functional end cap 240a.

The first functional block 258a of the upper first functional end cap 240a has, for example, a lateral outwardly exposed functional block front face 260a which can be aligned with a lateral front face 23 of the left glass pane edge 22 of the first glass pane 20 and which can form an extension of the lateral front face 23 of the left glass pane edge 22. The functional block front face 260a of the first functional block 258a of the upper first functional end cap 40a may form the extension of the lateral front face 23 of the left glass pane edge 22, while having a gap or a distance to the lateral front face 23 of the left glass pane edge 22, or may form the extension of the lateral front face 23 of the left glass pane edge 22, while being flush with the lateral front face 23 of the left glass pane edge 22. Further, the functional block front face 260a is aligned with the lateral front face 242a of the upper first functional end cap 240a. A lower functional block front face 64a of the first functional block 258a of the upper first functional end cap 40a can also form the vertical termination of the glass pane receiving groove 251a and at least substantially extend parallel to the upper glass pane edge 24 of the first glass pane 20 and transversely to the functional block front face 260a of the first functional block 258a. As shown in FIGS. 18 and 19, the first functional block 258a and also the functional block front face 260a of the first functional block 258a can also extend vertically from the lower functional block face 264a of the first functional block 258a to an upper functional block face 262a of the first functional block 258a, which upper functional block face 262a extends at least substantially parallel to the lower functional block face 264a of the first functional block 258a and is aligned with the upper face 244a of the upper first functional end cap 240a, and can thus form an extension of the lateral front face 23 of the left glass pane edge 22 to the level of the upper face 244a of the upper first functional end cap 240a.

Further, a first wall of the first functional block 258a extending transversely to the functional block front face 260a of the first functional block 258a and transversely to the lower functional block face 264a (or at least substantially parallel to the pane face 21 of the first glass pane 20) forms the first inner wall 239a of the upper first functional end cap 240a, which first inner wall 239a, in the closed state of the glass door apparatus 1, is overlapped by the first leg 372 of the weather strip 370 and against which the first leg 372 of the weather strip 370 abuts. A second wall of the first functional block 258a, which extends transversely to the functional block front face 260a of the first functional block 258a and transversely to the lower functional block face 264a (or at least substantially parallel to the pane face 21 of the first glass pane 20) and which, with respect to pane face 21 of first glass pane 20, is opposite said first wall of the first functional block 258a, further forms the third inner wall 247a of the upper first functional end cap 240a, which third inner wall 247a, in the closed state of the glass door apparatus 1, is overlapped by the fourth leg 382 of the weather strip 370 and against which the fourth leg 382 of the weather strip 370 abuts. When the first glass pane 20 is inserted into the glass pane receiving groove 251a of the upper first functional end cap 240a, the pane face 21 of the first glass pane 20 is aligned with the first inner wall 239a and the third inner wall 247a of the upper first functional end cap 240a, and forms a portion of the delimiting contour t lest substantially parallel to the face 21 of first glass pane 20 of the first cavity 254a of the upper first functional end cap 240a.

Further, the upper second glass door leaf frame part 130a has a upper second functional end cap 340a (shown in more detail in FIGS. 21 to 23) by which the right frame body longitudinal end 134a of the upper second frame body 132a is covered and which is horizontally at level with the right glass pane edge 122 of second glass pane 20. The connection between the upper second functional end cap 340a and the upper second frame body 132a is analogous to the connection between the upper first functional end cap 240a and the upper first frame body 32a (for example, through the through holes 341a of the upper second functional end cap 340a).

The upper second functional end cap 340a also has a central glass pane receiving groove 351a, which, with respect to the lower face 346a of the upper second functional end cap 340a, protrudes inwards in a manner at least substantially parallel to the right glass pane edge 122 of the second glass pane 120 and at least substantially vertical in a direction toward the upper face 344a of the upper second functional end cap 340a and which, in the opposite direction, opens downwards and into which the second glass pane 120 is inserted, wherein, for example buffer elements (for example, of an elastic material) are positioned between the second glass pane 120 and the upper second functional end cap 340a in the glass pane receiving groove 351a.

The complementary counterpiece of the left glass door leaf 100 associated with the first protrusion 252a of the upper first functional end cap 240a is formed here by the first functional end cap side face 348a of the upper second functional end cap 340a. As shown in FIG. 17, in the closed state of the glass door apparatus 1, the first protrusion 252a of the upper first functional end cap 240a is overlapped with the functional end cap side face 348a of the upper second functional end cap 340a, whereby the sealing can be improved. However, it is also possible that the face of the upper second functional end cap 340a which forms the complementary counterpiece of the left glass door leaf 100 associated with the first protrusion 252a of the upper first functional end cap 240a is not exposed to the outside but forms an inner wall of a further cavity of upper second functional end cap 340a, which further cavity protrudes, with respect to the lateral front face 342a of the upper second functional end cap 340a, laterally inwards in a manner at least substantially parallel to the pane face 121 of the second glass pane 120 and in the direction of the second glass pane 120 laterally inwards and which, in the opposite direction opens laterally outwards.

The upper second functional end cap 340a also has a second protrusion 352a, which is disposed, with respect to the pane face 121 of the second glass pane 120, opposite to the first functional end cap side face 348a of the upper second functional end cap 340a and which, with respect to the lateral front face 342a of the upper second functional end cap 340a, protrudes laterally outwards in a manner at least substantially parallel to the pane face 121 of the second glass pane 120 and in a direction away from the second glass pane 120. As shown in FIG. 17, the second protrusion 352a of the upper second functional end cap 340a is overlapped with the first functional end cap side face 248a of the upper first functional end cap 240a, whereby the seal can be improved.

The second protrusion 352a of the upper second functional end cap 340a may extend at least substantially in a vertical direction over a portion of the vertical extension or at least substantially over the entire vertical extension of the upper second functional end cap 340a between the upper face 344a and the lower face 346a of the upper second functional end cap 340a. Further, the second protrusion 352a of the upper second functional end cap 340a can at least partially form the second functional end cap side face 350a of the upper second functional end cap 340a.

The upper second functional end cap 340a includes, for example, a first cavity 354a, which, with respect to the lateral front face 342a of the upper second functional end cap 340a, protrudes laterally inwards in a manner at least substantially parallel to the pane face 121 of the second glass pane 122 as well as in the direction of the second glass pane 122 and which, in the opposite direction, opens laterally and outwards. Further, the upper second functional end cap 340a includes, for example, a second cavity 356a, which, with respect to the lateral front face 342a of the upper second functional end cap 340a, protrudes laterally inwards in a manner at least substantially parallel to the pane face 121 of the second glass pane 122 as well as in the direction of the second glass pane 122 and which, in the opposite direction, opens laterally and outwards and which is positioned, with respect to face 121 of second glass pane 122, opposite the first cavity 354a of the upper second functional end cap 340a such that a second functional block 358a is formed between the first cavity 354a and the second cavity 356a of the upper second functional end cap 340a. The first cavity 354a and the second cavity 356a of the upper second functional end cap 340a comprise, for example, an at least substantially U-shaped cross-section, respectively. Furthermore, the first cavity 354a of the upper second functional end cap 340a can extend at least substantially in the vertical direction over a part of the vertical extension or at least substantially over the entire vertical extension of the upper second functional end cap 340 between the upper face 344a and the lower face 346a of the upper second functional end cap 340a. The second cavity 356a of the upper second functional end cap 340a may extend at least substantially in vertical direction over a portion of the vertical extension or at least substantially over the entire vertical extension of the upper second functional end cap 340 between the upper face 344a and the lower face 346a of the upper second functional end cap 340a.

The second leg 378 of the weather strip 370 engages the first cavity 354a of the upper second functional end cap 340a and the third leg 380 of the weather strip 370 engages the second cavity 356a of the upper second functional end cap 340a so that the second leg 378 and the third leg 380 of the weather strip 370 surround (e.g., engage in a gripping manner) the pane face 121 of the second glass pane 120 and the second functional block 358a. As a result, the weather strip 370, for example, may be connected to the pane face 121 of the second glass pane 120 and to the second functional block 358a by means of a clamping of the second leg 378 and the third leg 380 of the weather strip 370 against the pane face 121 of the second glass pane 120 and against the second functional block 358a.

The second functional block 358a has, for example, a lateral outwardly exposed functional block front face 360a which can be aligned with a lateral front face 123 of the right glass pane edge 122 of the second glass pane 120 and which can form an extension of the lateral front face 123 of the right glass pane edge 122. The functional block front face 360a of the second functional block 358a may form the extension of the lateral front face 123 of the right glass pane edge 122, while having a gap or distance from the lateral front face 123 of the right glass pane edge 122, or may form the extension of the lateral front face 123 of the right glass pane edge 122, while being flush with the lateral front face 123 of the right glass pane edge 122. Furthermore, the functional block front face 360a of the second functional block 358a is aligned with the lateral front face 342a of the upper second functional end cap 240a. A lower functional block face 364a of the second functional block 358a of the upper second functional end cap 140a can also form the vertical termination of the glass pane receiving groove 151a and extend at least substantially parallel to the upper glass pane edge 124 of the second glass pane 120 as well as transversely to the functional block front face 360a of the second functional block 358a. As shown in FIGS. 21-23, the second functional block 358a and also the functional block front face 360a of the second functional block 358a may also extend at least substantially in a vertical direction from the lower functional block face 364a of the second functional block 358a to an upper functional block face 362a, which is at least substantially parallel to the lower functional block face 364a of second functional block 358a and which is aligned with the upper face 344a of the upper second functional end cap 340a, and may thus form an extension of the lateral front face 123 of the right glass pane edge 122 to the level of the upper face 344a of the upper second functional end cap 340a.

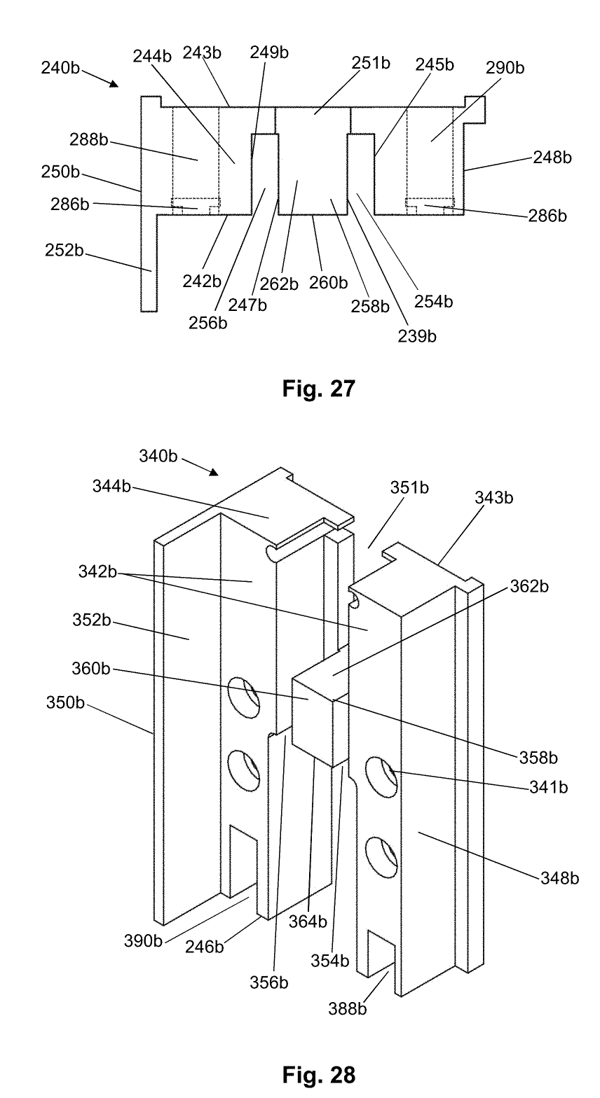

Next, the second alternative of the second example embodiment will be described with reference to FIGS. 16 and 24 to 30.

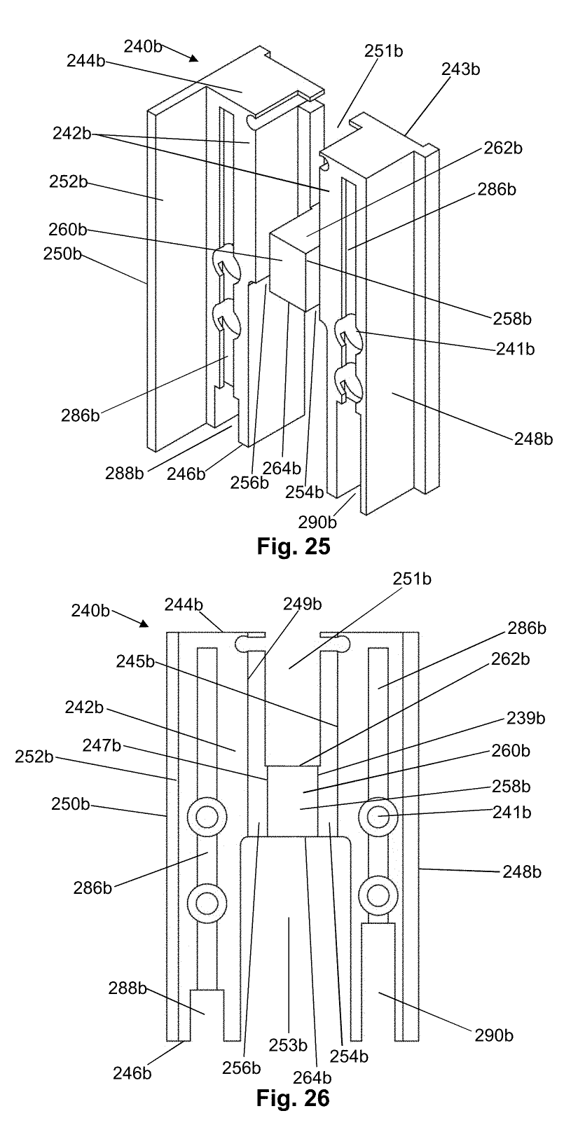

The lower first glass leaf frame part 30b according to the second alternative has a lower first functional end cap 240b (shown in more detail in FIGS. 25 to 27), by which the left frame body longitudinal end 34b of the lower first frame body 32b is covered, and which is horizontally positioned at level of left glass pane edge 22 of the first glass pane 20. The lower first functional end cap 240b is connected to the lower first frame body 32b, for example by means of a screwed connection, the lower first functional end cap 240b being, for example, at least one through hole 241b (for example, four through-holes are shown in FIGS. 10-12) for receiving a threaded pin or bolt through which the lower first functional end cap 240b is connected to the lower first frame body 32b. However, the lower first functional end cap 240b may also be otherwise connected to the lower first frame body 32a, for example by means of a clamping connection or by means of a locking or latching connection (e.g., snap connection).

The lower first functional end cap 240b also has a central glass pane receiving groove 251b, which, with respect to the upper face 244b of the lower first functional end cap 240b, protrudes inwards in a manner at least substantially parallel to the left glass pane edge 22 of the first glass pane 20 as well as at least substantially vertical in a direction toward the lower face 246b of the lower first functional end cap 240b and which, in opposite direction, opens upwards and into which the first glass pane 20 is inserted, wherein for example buffer elements (for example, of an elastic material) are arranged between the first glass pane 20 and the lower first functional end cap 240b in the glass pane receiving groove 251b.

Furthermore, the lower first functional end cap 240b has a central cavity 253b (indicated in FIG. 26) which, with respect to the lower face 246b of the lower first functional end cap 240b, protrudes inwards in a manner at least substantially parallel to the left glass pane edge 22 of the first glass pane 20 as well as at least substantially vertical toward the upper face 244b of the lower first functional end cap 240b and which, in the opposite direction, opens outwardly towards the bottom. The central cavity 253b may be used, for example for receiving and/or as a passage for functional parts (for example, a wedge) of an automatic locking device for the glass door apparatus.

The lower first functional end cap 240b also has a first protrusion 252b, which, with respect to the lateral front face 242b of the lower first functional end cap 240b, protrudes laterally outwards in a manner at least substantially parallel to the pane face 21 of the first glass pane 20 and in the direction away from the first glass pane 20, wherein in the closed state of the glass door apparatus 1, the first protrusion 252b of the lower first functional end cap 240b is overlapped with a complementary counterpiece of the left glass door leaf 100, which is associated with the first protrusion 252b of the lower first functional end cap 240b. The first protrusion 252b may extend at least substantially in a vertical direction over a portion of the vertical extension or at least substantially over the entire vertical extension of the lower first functional end cap 240b between the upper face 244b and the lower face 246b of the lower first functional end cap 240b. The first protrusion 252b of the lower first functional end cap 240b can at least partially form the second functional end cap side face 250b of the lower first functional end cap 240b. The first functional end cap side face 248b of the lower first functional end cap 240b also is disposed opposite to the first protrusion 252b of the lower first functional cap 240b with regard to the pane face 21 of the first glass pane 20.

The lower first functional end cap 240b also has a first cavity 254b, which, with respect to the lateral front face 242b of the lower first functional end cap 240b, protrudes laterally inward in a manner at least substantially parallel to the pane face 21 of the first glass pane 20 as well as in the direction towards the first glass pane 20 and which opens, in the opposite direction, laterally outwards. In the second alternative of the second embodiment, the first cavity 254b is arranged in the direction of the pane face 21 of the first glass pane 20 at a distance from the first functional end cap side face 248b. The first cavity 254b of the lower first functional end cap 240b includes, for example, an at least substantially U-shaped profile cross-section. The first cavity 254b of the lower first functional end cap 240b is at least partially delimited by a first inner wall 239b of the lower first functional end cap 240b, said first inner wall 239b extending at least substantially parallel to the pane face 21 of the first glass pane 20 and at least substantially parallel with the first pane face 21 of the first glass pane 20, preferably also in alignment with the first pane face 21 of the first glass pane 20, and in the direction toward the first glass pane 20, and by a second inner wall 245b of the lower first functional end cap 240b, which second inner wall 245b is spaced apart from the first inner wall 239b of the lower first functional end cap 240b in the direction transverse to the pane face 21 of the pane and is opposite to the first inner wall 239b and extends at least substantially parallel to the pane face 21 of the first glass pane 20, preferably also in alignment with the first pane face 21 of the first glass pane 20, and in the direction of the first glass pane 20. The first cavity 254b of the lower first functional end cap 240b can extend at least substantially in vertical direction over a portion of the vertical extension or in the vertical direction at least substantially from the upper face 244b of the lower first functional end cap 240b to the vertically upper end of the central cavity 253b of the lower first end cap 240b. In the closed state of the glass door apparatus 1, the first cavity 254b of the lower first functional end cap 240b is overlapped with a complementary counterpiece of the left glass door leaf 100, which is associated with the first cavity 254b of the lower first functional end cap 240b. In the second example embodiment, the complementary counterpiece of left glass door leaf 100 associated with first cavity 254b of the lower first functional end cap 40b is formed by the first leg 372 of the weather strip 370. As shown in FIG. 24, the first leg 372 of the weather strip 370 overlaps the left glass pane edge 22 of the first glass pane 20 in the closed state of the glass door apparatus 1 and engages the first cavity 254b of the lower first functional end cap 240b to form the corresponding complementary counterpiece of the left glass door leaf 100, wherein the first leg 372 overlaps and abuts the first inner wall 239b of the lower first functional end cap 240b, whereby the sealing can be improved. The first leg 378 can also optionally be curved such that it additionally abuts against the second inner wall 245b of the lower first functional end cap 240b. The first leg 372 of the weather strip 370 extends, for example, beyond the lower glass pane edge 26 of the first glass pane 20 at least substantially vertically (for instance downwards) and optionally extends up to the vertical upper end of the central cavity 253b of the lower first functional end cap 240b, or at least substantially up to the lower face 246b of the lower first functional end cap 240b.

The lower first functional end cap 240b also has a second cavity 256b which, with respect to the lateral front face 242b of the first lower functional end cap 240b, protrudes laterally inwards in a manner at least substantially parallel to the pane face 21 of the first glass pane 20 as well as in the direction towards the first glass pane 20 and which, in the opposite direction, opens laterally outwards and which is disposed, with respect to the pane face 21 of the first glass pane 20, opposite to the first cavity 254b of the lower first functional end cap 240b so that a first functional block 258b is formed between the first cavity 254b and the second cavity 256b of the lower first functional end cap 240b. The second cavity 256b of the lower first functional end cap 240b includes, for example, an at least substantially U-shaped profile cross-section, respectively. The second cavity 256b of the lower first functional end cap 240b is at least partially limited by a third inner wall 247b of the lower first functional end cap 240b, which third inner wall 247b extends at least substantially parallel to the pane face 21 of the first glass pane 20, preferably also in alignment with the first pane face 21 of the first glass pane 20, as well as in the direction of the first glass pane 20 and is positioned (for instance with respect to pane face 21 of the first glass pane 20) at a distance from the first inner wall 239b of the lower first functional end cap 240b, and by a fourth inner wall 249b of the lower first functional end cap 240b, which fourth inner wall 249b is spaced apart from the third inner wall 247b of the lower first functional end cap 240b in a direction transverse to the pane face 21 of the first glass pane 20 and is opposite to the third inner wall 247b and extends at least substantially parallel to the pane face 21 of the first glass pane 20, preferably flush with first pane face 21 of the first glass pane 20, as well as in the direction towards the first glass pane 20. The second cavity 256b of the lower first functional end cap 240b may extend at least substantially in a vertical direction over a portion of the vertical extension or in the vertical direction at least substantially from the upper face 244b of the lower first functional end cap 240b to the vertical upper end of the central cavity 253b of the lower first functional end cap 240b. As shown in FIG. 24, the fourth leg 382 of the weather strip 370 overlaps the left glass pane edge 22 of the first glass pane 20 in the closed state of the glass door apparatus 1 and engages with the formation of a further complementary counterpiece of the second cavity 254b of the lower first functional end cap 240b the left glass door leaf 100 into the second cavity 256b of the lower first functional end cap 240b with the fourth leg 382 overlapping and abutting the third inner wall 247b of the lower first functional end cap 240b whereby the sealing can be improved. The fourth leg 382 may also optionally be curved such that it additionally abuts against the fourth inner wall 249b of the lower first functional end cap 240b. The fourth leg 382 of the weather strip 370 extends, for example, over the lower glass pane edge 26 of the first glass pane 20 at least substantially vertically (for instance downwards) and optionally extends up to the vertically upper end of the central cavity 253b of the lower first functional end cap 240b or at least substantially up to the lower face 246b of the lower first functional end cap 240b.

The first functional block 258b of the lower first functional end cap 240b has, for example, a lateral outwardly exposed functional block front face 260b which can be aligned with a lateral front face 23 of the left glass pane edge 22 of the first glass pane and which can form an extension of the lateral front face 23 of the left glass pane edge 22. The functional block front face 260b of the first functional block 258b may form the extension of the lateral front face 23 of the left glass leaf edge 22, while having a gap to the lateral front face 23 of the left glass leaf edge 22, or may form the extension of the lateral front face 23 of the left glass leaf edge 22, while being flush with the lateral front face 23 of the left glass pane edge 22. Further, the functional block front face 260b is aligned with the lateral front face 242b of the lower first functional end cap 240b. An upper functional block face 262b of the first functional block 258b of the lower first functional end cap 240b can also form the vertical termination of the glass pane receiving groove 251b and extends at least substantially parallel to the lower glass pane edge 26 of the first glass pane 20 and transversely to the functional block front face 260b of the first functional block 258b. As shown in FIGS. 25 and 26, the first functional block 258b, and hence the functional block front face 260b of the first functional block 258b, can also extend at least substantially vertically from the upper functional block face 262b of the first functional block 262b to a lower functional block face 264b of the first functional block 262b, which lower functional block face 264b extends at least substantially parallel to the upper functional block face 262b of first functional block 258b and forms the vertical termination of the central cavity 253b, and can thus form an extension of the lateral front face 23 of the left glass pane edge 22 to the level of the lower functional block face 264b.

Further, a first wall of the first functional block 258b extending transversely to the functional block front face 260b of the first functional block 258b (or at least substantially parallel to the pane face 21 of the first glass pane 20) forms the first inner wall 239b of the lower first functional end cap 240b which in the closed state of the glass door apparatus 1 is overlapped by the first leg 372 of the weather strip 370 and on which the first leg 372 of the weather strip 370 rests. A second wall of the first functional block 58b, which extends transversely to the functional block front face 260b of the first functional block 258b and transversely to the lower functional block face 264b (or at least substantially parallel to the pane face 21 of the first glass pane 20) and which, with respect to the pane face 21 of the first glass pane 20, is disposed opposite to the first wall of the first functional block 258b, forms the third inner wall 247b of the lower first functional end cap 240b, which in the closed state of the glass door apparatus 1 is overlapped by the fourth leg 382 of the weather strip 370 and against which the fourth leg 382 of the weather strip 370 rests. When the first glass pane 20 is inserted into the glass pane receiving groove 251b of the lower first functional end cap 240a, the pane face 21 of the first glass pane 20 is aligned with the first inner wall 239b and the third inner wall 247b of the lower first functional end cap 240b and forms a portion of the delimiting contour of first cavity 254b of lower first functional end cap 240b at least substantially parallel to pane face 21 of first glass pane 20.

The lower second glass door leaf frame part 130b also has a lower second functional end cap 340b (shown in more detail in FIGS. 28 to 30) by which the right frame body longitudinal end 134b of the lower second frame body 132b is covered and which is positioned horizontally at the level of the right glass pane edge 122 of the second glass pane 20. The connection between lower second functional end cap 340b and lower second frame body 132b is possible in a way similar to the connection between the lower first functional end cap 240b and the lower first frame body 32b (for example, by means of the through holes 341b of the lower second functional end cap 340b).

The lower second functional end cap 340b also has a central glass pane receiving groove 351b, which, with respect to the upper face 344b of the lower second functional end cap 340b, protrudes inwards in a manner at least substantially parallel to the right glass pane edge 122 of the second glass pane 120 and at least substantially vertical in the direction toward the lower face 346b of the lower second functional end cap 340b and which, in the opposite direction, opens upwards and into which the second glass pane 120 is introduced, wherein, for example, buffer elements (of an elastic material) are positioned between the second glass pane 120 and the lower second functional end cap 340b in the glass pane receiving groove 351b.

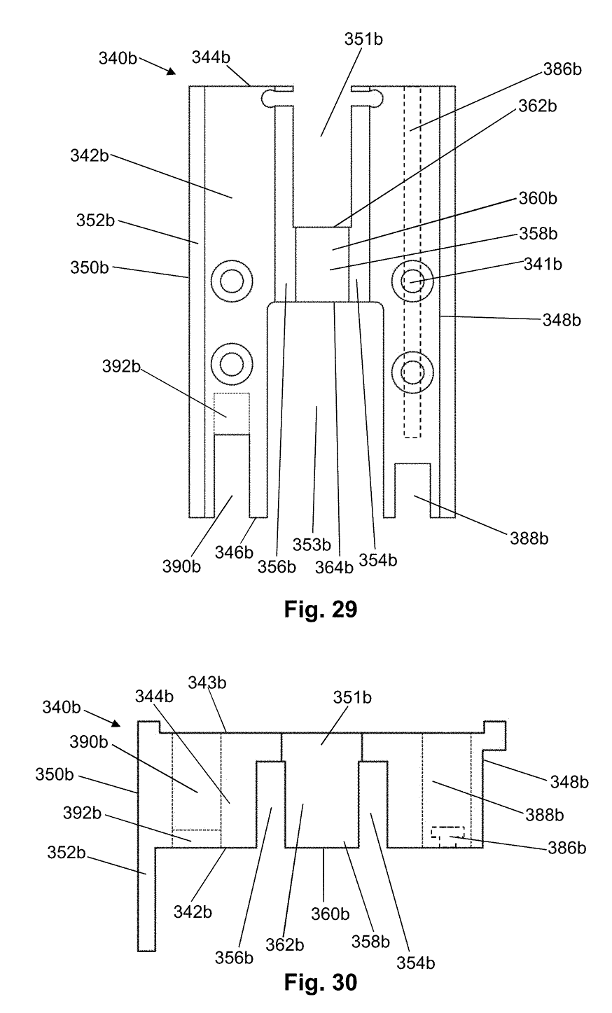

Further, the lower second functional end cap 340b has a central cavity 353b (indicated in FIG. 29), which, with respect to the lower face 346b of the lower second functional end cap 340b, protrudes inwards in a manner at least substantially parallel to the right glass pane edge 122 of the second glass pane 120 and at least substantially vertical in a direction toward the upper face 344b of the lower second functional end cap 340b and which, in the opposite direction, opens outwardly downwards. The central cavity 353b may for example be used for receiving and/or as a passage for functional parts (for example, a wedge) of an automatic locking device for the glass door apparatus.

The complementary counterpiece of the left glass leaves 100 associated with the first protrusion 252b of the lower first functional end cap 240b is formed here by the first functional end cap side face 348b of the lower second functional end cap 340b. As shown in FIG. 24, in the closed state of the glass door apparatus 1, the first protrusion 252b of the lower first functional end cap 240b is overlapped with the functional end cap side face 348b of the lower second functional end cap 340b, whereby the sealing can be improved. However, it is also possible that the face of the lower second functional end cap 340b, which forms the complementary counterpiece of the left glass door leaf 100 associated with the first protrusion 252b of the lower first functional end cap 240b, is not exposed to the outside, but forms an inner wall of a further cavity which, with respect to the lateral front face 342b of the lower second functional end cap 340b, is at least substantially parallel to the pane face 121 of the second glass pane 120, as well as protrudes laterally outwards in the direction of the second glass pane 120, of lower second functional end cap 340b.

The lower second functional end cap 340b also has a second protrusion 352b which, with respect to face 121 of second glass pane 120, is disposed opposite to the first functional end cap side face 348b of the lower second functional end cap 340b and which, with respect to lateral front face 342b of lower second functional end cap 340b, protrudes laterally outwards in a manner at least substantially parallel to the pane face 121 of the second glass pane 120 and away from the second glass pane 120. As shown in FIG. 24, in the closed state of the glass door apparatus 1, the second protrusion 352b of the lower second functional end cap 340b is overlapped with the first functional end cap side face 248b of the lower first functional cap 240b and also with the left glass pane edge 22 of the first glass pane 20, so that the sealing can be improved.

The second protrusion 352b of the lower second functional end cap 340b may extend at least substantially in a vertical direction over a portion of the vertical extension or at least substantially over the entire vertical extension of the lower second functional end cap 340b between the upper face 344b and the lower face 346b of the lower second end cap 340b. Furthermore, the second protrusion 352b of the lower second functional end cap 340b can at least partially form the second functional end cap side face 350b of the lower second functional end cap 340b.

The lower second functional end cap 340b has, for example a first cavity 354b, which, with respect to the front face 342b of the lower second functional end cap 140b, protrudes laterally inwards in a manner at least substantially parallel to the pane face 121 of the second glass pane 122 as well as in the direction of the second glass pane 122 and which, in the opposite direction, opens laterally outwardly. Further, the lower second functional end cap 340b includes, for example, a second cavity 356b, which, with respect to the front face 342b of the lower second functional end cap 340b, protrudes laterally inwardly in a manner at least substantially parallel to the pane face 121 of the second glass pane 122 as well as in the direction of the second glass pane 122 and which, in the opposite direction, opens laterally outwardly and which, with respect to pane face 121 of the second glass pane 122, is arranged opposite the first cavity 354b of the lower second functional end cap 340b so that a second functional block 358b is formed between the first cavity 354b and the second cavity 356b of the lower second functional end cap 340b. The first cavity 354b and the second cavity 356b of the lower second functional end cap 340b have, for example, an at least substantially U-shaped cross-section, respectively. Furthermore, the first cavity 354b of the lower second functional end cap 340b can extend at least substantially in vertical direction over a part of the vertical extension or can extend in the vertical direction, from the upper face 344b of the lower second functional end cap 340b to the vertically upper end of the central cavity 353b of the lower second functional end cap 340b. The second cavity 356b of the lower second functional end cap 340b can extend at least substantially in vertical direction over a portion of the vertical extension or in the vertical direction at least substantially from the upper face 344b of the lower second functional end cap 340b to the vertically upper end of the central cavity 353b of the lower second functional end cap 340b.

The second leg 378 of the weather strip 370 engages in the first cavity 354b of the lower second functional end cap 340b and the third leg 380 of the weather strip 370 engages in the second cavity 356b of the lower second functional end cap 340b so that the second leg 378 and the third leg 380 of the weather strip 370 enclose (e.g., engage in a gripping manner) the pane face 121 of the second glass pane 120 and the second functional block 358b. The weather strip 370 can be connected to the pane face 121 of the second glass pane 120 and to the second functional block 358b by means of a clamping of the second leg 378 and the third leg 180 of the weather strip 370 against the pane face 121 of the second glass pane 120 and against the second functional block 358b.

The second functional block 358b has, for example, a lateral, outwardly exposed functional block front face 360b which can be aligned with a lateral front face 123 of the right glass pane edge 122 of the second glass pane 120 and which can form an extension of the lateral front face 123 of the right glass pane edge 122. The functional block front face 360b of the second functional block 358b may form the extension of the lateral front face 123 of the right glass pane edge 122, while forming a gap or distance to the lateral front face 123 of the right glass pane edge 122, or may form the extension of the lateral front face 123 of the right glass pane edge 122, while being flush with lateral front face 123 of the right glass pane edge 122. Further, the functional block front face 360b is aligned with the lateral front face 342b of the lower second functional end cap 340b. An upper functional block face 362b of the second functional block 358b of the lower second functional end cap 340b can also form the vertical termination of the glass pane receiving groove 351b and extend at least substantially parallel to the lower glass pane edge 126 of the second glass pane 120 as well as transversely to the functional block front face 360b of the second functional block 358b.

As shown in FIGS. 28 and 29, the second functional block 358b and consequently the functional block front face 360b of the second functional block 358b can also extend at least substantially vertically from the upper functional block face 362b of the second functional block 362b to a lower functional block face 364b, which extends at least substantially parallel to the upper functional block face 362b of the second functional block 358b and which forms the vertical termination of the central cavity 353b of the lower second functional end cap 340b, and can thus forms an extension of the lateral front face 123 of the right glass pane edge 122 to the level of the lower functional block face 364b.

Above described second embodiment is suitable for example for use of a right glass door leaf 10 which can be displaced in the direction towards the left glass door leaf 100, since two legs of the weather strip engage on both sides of the pane face 21 of the glass pane 20 of the right glass door leaf 10 in two cavities of the respective first functional cap and on the glass pane 20 as well as on the inner walls of the respective first functional cap. By means of the above-described second embodiment of the present invention, sound/noise, moisture and wind can be effectively prevented from penetrating through the glass door apparatus 1. Thus, the noise protection, moisture protection and wind protection properties of the glass door apparatus 1 can be improved.

In each of the previously described embodiments, a gap between the respective first protrusion and the respective complementary counterpiece of the left glass door leaf in a direction transverse to the pane faces of the first and second glass panes can be less than or equal to one fifth of an overlapping length of the respective first protrusion with the respectively corresponding complementary counterpiece of left glass door leaf, and/or a gap between the first cavity of first functional end cap and the corresponding complementary counterpiece of left glass door leaf in a transverse direction with respect to pane faces of first and second glass panes may be less than or equal to one fifth of the overlapping length of the first cavity of the respective first functional end cap with the respective complementary counterpiece of the left glass door leaf.

Furthermore, in the closed state of the glass door apparatus, a gap between the second cavity of the respective first functional end cap and the further associated, complementary counterpiece of the left glass door leaf in a direction transverse to the pane faces of the first and second glass panes can be less than or equal to one fifth of the overlapping length of the second cavity of the respective first functional end cap with the further associated, complementary counterpiece of the left glass door leaf.

In the upper and/or lower first functional end cap 40a, 40b, 240a, 240b according to the previously described embodiments, additionally or alternatively a (for example, at least one) sealing element receiving vertical groove (e.g., a first sealing element receiving vertical groove and a second sealing element receiving vertical groove) 86a, 86b, 286a, 286b, which extends at least substantially parallel to the left glass pane edge 22 of the first glass pane 20, protrudes, at the front face (for example, on the lateral front face), laterally inwardly in a manner at least substantially parallel to the pane face 21 of the first glass pane 20 as well as in the direction towards the first glass pane 20 and which opens in the opposite direction laterally outwards and in which a (vertical) sealing element (for example, a sealing lip, a brush, etc.) is received, which sealing element protrudes laterally outwards from the sealing element receiving vertical groove 86a, 86b, 286a, 286b in a manner at least substantially parallel to the pane face 21 of the first glass pane 20 as well as in the direction away from the first glass pane 20 and which sealing element, in the closed state of the glass door apparatus 1, interacts with the left glass door leaf 100 in an abutting way. For example, in the closed state of the glass door apparatus 1, the sealing element can cooperate with the second functional end cap opposite the respective first functional end cap (for example, with a front face thereof) in an adjoining way.

In the upper and/or lower second functional end cap 140a, 140b, 340a, 340b in accordance with the above-described embodiments, additionally or alternatively, a (e.g., at least one) sealing element receiving vertical groove (a first sealing element receiving vertical groove and a second sealing element receiving vertical groove) 186a, 186b, 386a, 386b may be formed, which extends at least substantially parallel to the right glass pane edge 122 of the second glass pane 120, protrudes, at the front face (for example, at the lateral front face), laterally inwards in a manner at least substantially parallel to the pane face 121 of the second glass pane 120 and in the direction towards the second glass pane 120 and which opens in the opposite direction laterally outwards and in which a (vertical) sealing element (a sealing lip, a brush, etc.) is received, which sealing element protrudes laterally outwards from the sealing element receiving vertical groove 186a, 186b, 386a, 386b in a manner at least substantially parallel to the pane face 121 of the second glass pane 120 as well as in the direction away from the second glass pane 120 and which sealing element, in a closed state of the glass door apparatus 1, interacts with the first functional end cap opposite the respective second functional end cap in an abutting way (for instance against a front face of the respectively opposing first functional end cap).

In each of the above-described functional end caps, there may also be formed a sealing element receiving horizontal groove 88a, 88b, 188a, 188b, 288a, 288b, 388a, 388b, which extends at least substantially parallel to the pane face of the associated glass pane from the lateral front face to the rear face through the respective functional end cap, opens vertically outwards (for instance the sealing element receiving horizontal groove 88a, 188a, 288a, 388a of upper functional end caps opens vertically upwards, and the sealing element receiving horizontal groove 88b, 188b, 288b, 388b of the lower second end caps 140b opens vertically downwardly) and opens laterally outwards in the direction away from the lateral front face and in the direction away from the rear face of the respective functional end cap and in which a sealing element (for example, a sealing lip, a brush, etc.) is received, which sealing element protrudes vertically outwards out of the sealing element receiving horizontal groove in a manner at least substantially parallel to the pane face of the associated glass pane and in the direction away from the associated glass pane (for instance the sealing element of the sealing element receiving horizontal groove 88a, 188a, 288a, 388a of the upper functional end cap protrudes vertically upwardly and the sealing element of the sealing element receiving horizontal groove 88b, 188b, 288b, 388b of the lower functional end caps 140b protrudes vertically downward).

In the closed state of the glass door apparatus 1, the sealing element receiving horizontal grooves of the upper first functional end cap and the upper second functional end cap adjacent to each other and the sealing elements received therein can be aligned with one another and can receive the sealing element receiving horizontal grooves of the lower first and lower second functional end caps, which are adjacent, and the sealing elements received therein are aligned with each other.

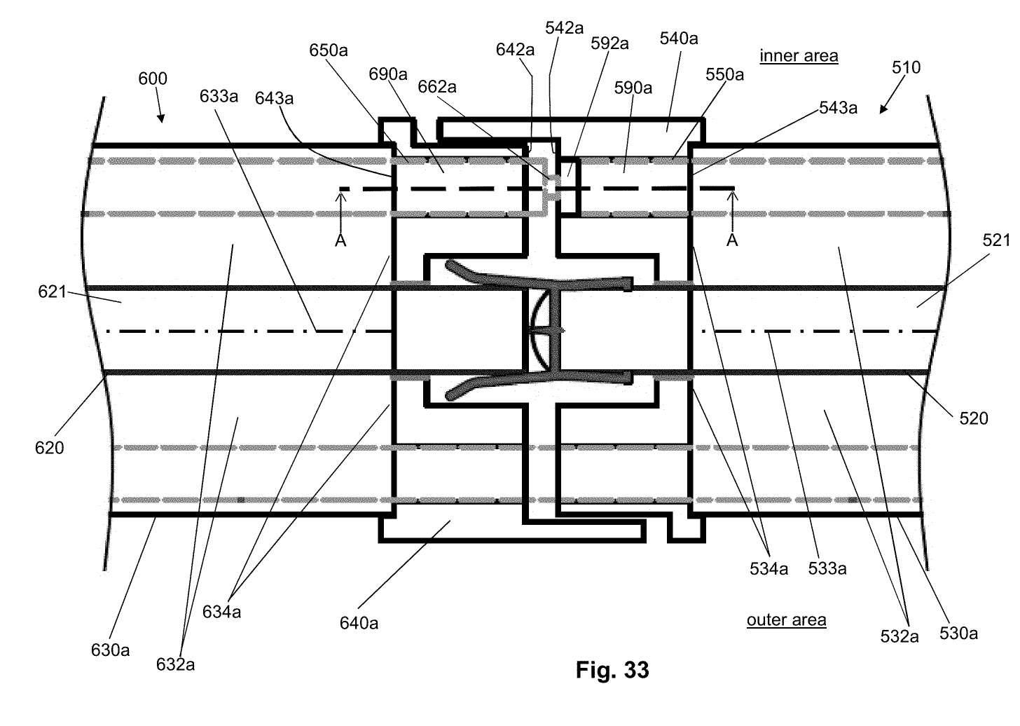

In each of the above-described functional end caps, a sealing receiving groove 90a, 90b, 190a, 190b, 290a, 290b, 390a, 390b can also be formed, which is disposed opposite to the respective sealing element receiving horizontal groove with respect to the pane face of the associated glass pane, extends at least substantially parallel to the pane face of the associated glass pane from the front face to the rear face through the respective functional end cap, opens vertically outwards (for example, the sealing receiving grooves 90a, 190a, 290a, 390a of the upper functional end caps open vertically upwards, and the sealing receiving groove 90b, 190b, 290b, 390b of the lower first functional end caps open vertically downwards) and opens laterally outwards in the direction away from the front face and in the direction away from the rear face of the respective functional end cap and in which a sealing (for example, a sealing as described in connection with FIGS. 33 to 36) is received, which sealing can include a sealing profile (for instance an extractable (or extendible) sealing lip) which can be extracted (e.g., moved out) from a sealing housing, wherein the glass door apparatus is configured in such a way that the extractable sealing profile can be moved vertically out of the sealing receiving groove in the direction away from the associated glass pane by an extraction (or extension) mechanism (for example, the sealing profile of the sealing in the sealing receiving groove of upper functional end caps can be moved vertically upwards and the sealing profile of sealing in the groove of lower functional end cap can be moved vertically downwards).

The sealing receiving groove 390a, 390b of the respective second functional end cap 340a, 340b of the second embodiment may be different from the sealing receiving groove 190a, 190b of the respective second functional end cap 140a, 140b of the first embodiment for instance because the respective second functional end cap 340a, 340b of second embodiment may have a wall portion 392a, 392b, which at least substantially vertically protrudes into the sealing receiving groove 390a, 390b and which, in its function and effect, corresponds to a stop portion according to the later aspect of the present invention (see FIGS. 33 to 36 and description thereof).

In the closed state of the glass door apparatus 1, the sealing receiving grooves of the upper first and the upper second functional end cap, which are adjacent to each other, may be aligned with one another, and the extraction mechanism of the associated seals can be actuated such that the extendible sealing profiles of the associated seals are moved out at least substantially vertically upwards; and the sealing receiving grooves of the lower first and lower second functional end caps which are adjacent to each other may be aligned with one another and the extension mechanism of the associated seals can be actuated so that the extractable sealing profiles of the associated seals are moved out at least substantially vertically downwardly.

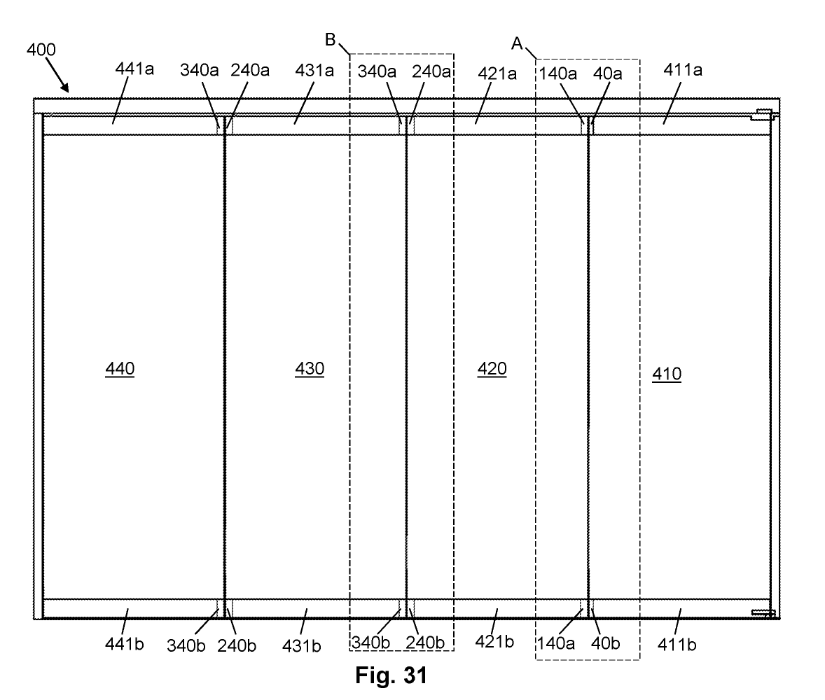

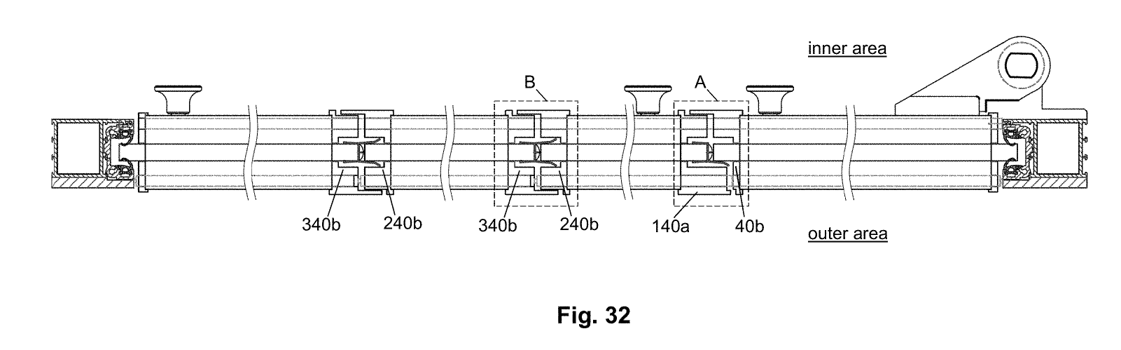

The elements of the glass door apparatus according to the first and second embodiments (and according to their alternatives) of the present invention can also be provided combined in a glass door apparatus according to the present invention. Such an example glass door apparatus 400 is shown in FIG. 31 and FIG. 32. This apparatus has four glass leaves 410, 420, 430, 440, which delimit an inner region from an outer region and each of which has a glass pane. Further, the glass leaves 410, 420, 430 and 440 each have an upper glass leaf frame part 411a, 421a, 431a and 441a, and a lower glass leaf frame part 411b, 421b, 431b and 441b which engage, as previously described, the respective glass pane.

In the glass door apparatus 400, the glass door 410 is designed as a rotary leaf which pivots towards the interior, and the glass door leaves 420, 430 and 440 are designed as sliding leaves. In a region A shown in FIGS. 31 and 32, the first embodiment is implemented in its two alternatives. In the region A, the glass door 410 corresponds to a right glass door leaf described with reference to the first embodiment, and the glass door 420 corresponds to a left glass door leaf described with reference to the first embodiment, wherein the glass door 410 includes an upper first functional cap 40a and a lower first functional cap 40b and the glass door 420 includes an upper second functional cap 140a and a lower second functional cap 140b according to the first embodiment of the present invention. Further, in a region B shown in FIGS. 31 and 32, the second embodiment is implemented in its two alternatives. In the region B, the glass door 420 corresponds to a right glass door leaf described with reference to the second embodiment, and the glass door leaf 430 corresponds to a left glass door leaf described with reference to the second embodiment, which door leaves comprise a upper first functional cap 240a and a upper second functional cap 340a as well as a lower first functional cap 240b and lower second functional cap 340b according to the second embodiment of the present invention. The second embodiment of the present invention is also implemented correspondingly between the glass panes 430 and 440 in the case of the glass door apparatus 400.

It is also possible for a glass door apparatus according to the present invention to have more than four or less than four glass leaves. For example, it is conceivable for the glass door apparatus to have only two or three glass door leaves, but also five, six, seven, eight, etc. glass door leaves. In the embodiment shown by way of example in FIGS. 31 and 32, the glass door leaves 420, 430, 440 are respectively designed as sliding leaves, and the glass door 410 is designed as a rotating leaf. However, the glass door leaves can be designed as a fixed leaf, a sliding leaf, a rotating leaf or a sliding-and-rotating leaf, in accordance with their function as prescribed for the glass door apparatus. For example, the glass leaves 420, 430, 440 can also be sliding-rotating leaves or fixed leaves, and the glass door leaf 410 can also be designed as a rotating leaf. In principle, a plurality of possible embodiments with different combinations of leaf types are conceivable and the invention is not limited to the possibilities described herein.

A different aspect according to the present invention will now be described with reference to FIGS. 33-36, which may be implemented in a glass door apparatus according to the present invention in addition or alternatively to the aspects of the present invention previously described with respect to FIGS. 1 to 32.

When later referring to a respective first and second functional end cap, these functional end caps can at least be substantially similar to the functional end caps shown above in FIGS. 1 to 32. Further, the “top” and “bottom” indications are the same as those shown in FIGS. 1 to 32 according to the present invention.

As shown in FIGS. 33 to 36, a glass door apparatus 500 has a right glass door leaf 510 and a left glass door leaf 600.

The right glass door leaf 510 includes a first glass pane 520 defining a pane face 521 and having a left glass pane edge 522 extending at least substantially vertically, an upper glass pane edge 524 extending at least substantially horizontally and a lower glass pane edge 526, which extends at least substantially horizontally.

The right glass leaf 510 has a upper first glass leaf frame part 530a which is engaged with the upper glass pane edge 524 of the first glass pane 520 and a lower first glass leaf frame part 530b which is engaged with the lower glass pane edge 526 of the first glass pane 520.

The left glass door leaf 600 has a second glass pane 620 defining a pane face 621 and having a right glass pane edge 622 extending at least substantially vertically and adjacent to the left glass pane edge 522 of the first glass pane 520 in a closed state of the glass door, an upper glass pane edge 624 extending at least substantially horizontally, and a lower glass pane edge 626 extending at least substantially horizontally.

The left glass leaves 600 has a upper second glass leaf frame part 630a which is engaged with the upper glass pane edge 624 of the second glass pane 620 and a lower second glass leaves frame part 630b which is engaged with the lower glass pane edge 626 of the second glass pane 620.

A first and a second alternative according to the other aspect of the present invention shown in FIGS. 33 to 36 will be described in the following. In a glass door apparatus according to the present invention, either the first or the second alternative of the other aspect of the present invention may be provided. However, both alternatives of the other aspect of the present invention may also be simultaneously provided (i.e., in combination) in a glass door apparatus according to the present invention. In addition, the two alternatives of the other aspect of the present invention can also be provided in combination with the features of the embodiments and configurations described above with reference to FIGS. 1 to 32 in a glass door apparatus according to the present invention.

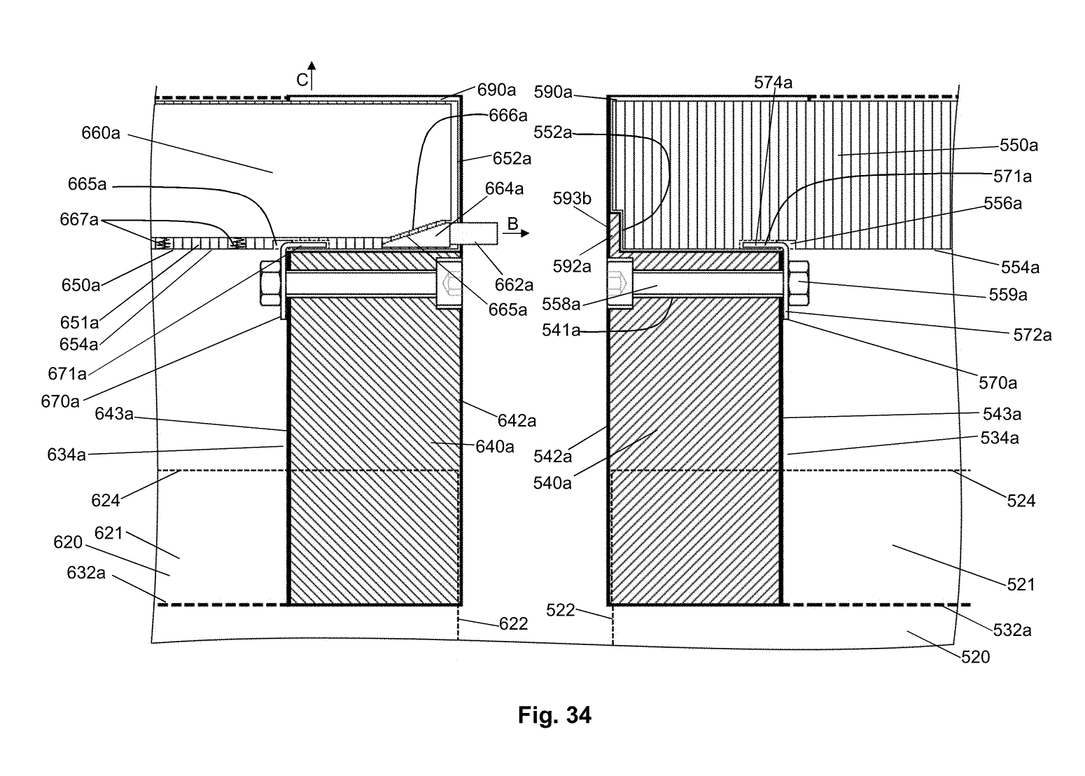

The first alternative according to the other aspect of the present invention will be described with reference to FIGS. 33 and 34, wherein FIG. 33 is a plan view of a right and a left glass leaf in the closed state of the glass door apparatus, and FIG. 34 is a partial section along the line A-A shown in FIG. 33 in a (partial) open state of the glass door apparatus from an outer area.

The upper first glass leaf frame part 530a has an elongated upper first frame body 532a defining a longitudinal axis extending with its longitudinal axis along the upper glass pane edge 524 of the first glass pane 520 and having a left frame body longitudinal end 534a which is at least substantially similar to the upper first frame body 632a previously described for FIGS. 1 to 32.

Further, the upper first glass door frame part 530a has a upper first functional end cap 540a (which is at least substantially similar to the upper second functional end cap shown in FIGS. 21 to 23) by which the left frame body longitudinal end 534a of the upper first frame body 532a is covered and which is arranged horizontally at the level of the left glass pane edge 522 of the first glass pane 520.

The upper first functional end cap 540a defines a lateral outwardly exposed front face 542a and a lateral rear face 543a which is spaced apart from the lateral front face 542a in the direction toward the left frame body longitudinal end 534a of the upper first frame body 532a and which is adjacent to the left frame body longitudinal end 534a of the upper first frame body 532a (wherein, for example, the rear face 543a forms the cover of the left frame body end 534a).

Furthermore, the upper first functional end cap 540a has a sealing receiving groove 590a which extends at least substantially parallel to the pane face 521 of the first glass pane 520 from the lateral front face 542a to the rear face 543a and which opens vertically upwards and which opens laterally outwards in a direction away from the front face and laterally outwards in a direction away from the rear face of the upper first functional end cap 540a.

The upper first glass leaf frame part 530a further includes an upper first hook element 570a, which is attached to the rear face 543a of the upper first functional end cap 540 and has a hooking element 571a, and an upper first sealing 550a, which is at least partly contained in the upper first frame body 532a and is at least partially received in the sealing receiving groove 590a of the upper first functional end cap 540a and which comprises an upper first sealing housing 551a, for example of a metal material (for example, aluminum material). The upper first sealing housing 551a has a housing front face 552a (which is disposed, for example, horizontally at the level of the left glass pane edge 522 of the first glass pane 520 and extends at least substantially parallel to the left glass pane edge 522 of the first glass pane 520) and a lower housing longitudinal wall 554a, which extends from the housing front face 552a in the direction toward the first glass pane 520 at least substantially parallel to the upper glass pane edge 524 of the first glass pane 520 and extends substantially transversely to the pane face 521 of the first glass pane 520.

Furthermore, the lower housing longitudinal wall 554a of the upper first sealing housing 551a is recessed (for example, by means of milling) at a position that is spaced apart from the housing front face 552a of the upper first sealing housing 551a so that the hooking element 571a of the upper first hook element 570a engages (e.g., reaches or grips under) the lower housing longitudinal wall 554a of the upper first sealing housing 551a from below and thereby holds the upper first sealing 550a on the upper first functional end cap 540a (particularly in the at least substantially vertical direction). To this purpose, the lower housing longitudinal wall 554a has a hooking element receiving cavity (for example, a milled groove) 556a, which is provided therein at a distance from the housing front face 552a and into which the hooking element 571a of the first hook element 570a can engage or engages by reaching or gripping under the housing longitudinal wall 554a of the upper first sealing housing 551a to thereby hold upper first sealing 550a on the upper first functional end cap 540a. For example, the hooking element receiving cavity 556a is dimensioned in such a way that the hooking element 571a can be inserted therein and is at least substantially slidable therein substantially in parallel to the lower housing longitudinal wall 554a so that the hooking element 571a can reach under and engage the lower housing longitudinal wall 554a. The hooking element 571a can be attached to the rear face of the rear face 543a of the upper first functional end cap 540. For example, the hooking element 571a of the upper first hook element 570a may be inserted into the hooking element receiving cavity 556a so as to extend toward the upper first functional end cap 540a and run, for example, in the sealing receiving groove 590a of the upper first functional end cap 540a (for example, also engages the first functional end cap 540a from below). However, it can also be inserted in such a way that it extends from the upper first functional end cap 540a. In the state in which the hooking element 571a reaches under and engages the lower housing longitudinal wall 554a, the upper first hook element 570a can also be attached to the rear face 543a of the upper first functional end cap 540a.

For example, the upper first hook element 570a, as shown in FIG. 34, has a (rounded) L shape having a first hook element portion 572a, which extends at least substantially vertically to the housing longitudinal wall 554a of the upper first sealing housing 551a of the upper first sealing 550a along the rear face 543a of the upper first functional end cap 540a and which is connected to the rear face 543a of the respective functional end cap 540a, and having a second hook element portion 574a extending in a transversal direction of the first hook element portion 572a from an end of the first hook element portion 574a, wherein the hook element 571a is formed by the second hook element portion 574a.

The first hook element portion 572a may be connected, for example, to the rear face 543a of the upper first functional end cap 540a by means of a screw connection. As shown in FIG. 34, at least one threaded pin or screw bolt 558a can extend through a through hole 541a (which, for example, corresponds to one of the through-holes 41a, 241 of the upper first functional end caps 40a, 240a previously described in connection with FIGS. 1 to 32) in the upper first functional end cap 540a, and the first hook element portion 572a may have a screw connection counterpiece 559a, preferably a threaded nut 559a welded to the first hook element portion 572a, for engaging the first hook element portion 572a by engagement between the threads of the thread pin 558a and the nut 559a at the rear face 543a of the upper first functional end cap 540a. However, it may also be provided that the first hook element section 572a has holes which each have an internal thread which is complementary to the thread of the threaded pin 558a to be inserted therein, so that no nuts are required.

However, the upper first hook element 570a may also have other shapes and may also be connected in other ways to the rear face 543a of the upper first functional end cap 540a, for example by welding, gluing, etc. The upper first hook element 570a may be made of any material, for example a plastic material, or a metal material (for example, steel, iron, aluminum, or alloys thereof).

The upper first functional end cap 540a also has a stop portion 592a protruding into the sealing receiving groove 590a (for example, integrally formed therefrom), against which an actuating pin, still to be described, of an extractable (or extendible) sealing of the left glass door leaf 600 abuts. For example, as shown in FIG. 34, the stop portion 592a is formed by a wall portion of the upper first functional end cap 540a, which wall portion has a laterally outwardly exposed stop face 593a which is part of the lateral front face 542a of the upper first functional end cap 540a. The housing front face 552a of the upper first sealing housing 551a is at least partially overlapped by the abutment portion 592a of the upper first functional end cap 540a. As shown in FIG. 34, the abutment portion 592a extends as a wall portion of the upper first functional end cap 540a at least over a portion of the housing front face 552a of the upper first sealing housing 551a, which portion of the housing front face 552a is offset in a manner at least substantially parallel to the pane face 521 of the first glass pane 520 as well as in a direction toward the first glass pane 520. For example, by the offset portion of the housing front face 552a, a (for example, right angled) shoulder is formed on the housing front face 552a. The upper first sealing housing 551a may for example abut with the shoulder against the stop portion 592a.

Furthermore, the upper second glass door leaf frame part 630a has an elongated upper second frame body 632a defining a longitudinal axis 633a extending with its longitudinal axis 633a along the upper glass pane edge 624 of the second glass pane 620 and having a right frame body longitudinal end 634a.

The upper second glass door leaf frame part 630a also has a upper second sealing 650a designed as an extractable seal, which is received at least partially in the upper second frame body 632a. The upper second sealing 650a has an upper second sealing housing 651a which has a housing front face 652a (for example, at least substantially parallel to the right glass pane edge 622 of the second glass pane 620) and has an upper housing longitudinal wall 654a which extends from the housing front face 652a in the direction to the second glass pane 620 at least substantially parallel to the upper glass pane edge 624 of the second glass pane 620 and which extends at least substantially transversely to the pane face 621 of the second glass pane 620. The upper second sealing 650a also has an extractable sealing profile 660a (for example, an extractable sealing lip) which, in a non-extracted state, is housed in the upper second sealing housing 651a and is at least substantially vertically extended from the upper second sealing housing 651a (in the arrow direction C shown in FIG. 34) against a resilient reaction force applied by resetting means 667a.

The upper second sealing 650a also has an actuating pin 662a which protrudes outwards (in the direction of the first glass pane of the right glass door) with respect to the housing front face 652a of the upper second sealing housing 651a and which is movably configured (e.g., through the housing front face 652a of the upper second sealing housing 651a into the upper second sealing housing 651a) in such a way as to effect, in the course of its displacement, an at least substantially vertical extraction of the extractable sealing profile 660a of the upper second sealing 650a upwards against the elastic restoring force. In the case of a closing operation of the glass door apparatus, the two glass door leaves 510 and 600 move relative to one another (for example, the left glass door leaf moves towards the right glass door leaf, as indicated by the arrow direction B in FIG. 34 or the right glass door leaf moves towards the left glass door panel), and before the closing operation is completed, the actuating pin 662a of the upper second sealing 650a abuts against the abutment portion 592a formed by the upper first functional cap. When the closing operation is finally completed, the actuating pin 662a is pressed against the stop portion 592a against the arrow direction B into the upper second sealing housing 651a, which causes the extractable sealing profile 660a of the upper second sealing 650a to be extended upwards.

FIG. 34 schematically shows an example extraction mechanism through which the actuating pin 662a can effect an extraction of the sealing profile 660a upwards, the present invention not being limited to this example. In FIG. 34, a wedge element 664a having an inclination is received in the upper second sealing housing 651a, is fixedly connected to the actuating pin 662a, and is displaceable in the upper second sealing housing 651a in a manner at least substantially parallel to the housing longitudinal wall 654a of the upper second sealing housing 651a. If the actuating pin 662a is pushed into the upper second sealing housing 651a in a direction opposite to the arrow direction B shown in FIG. 34, the wedge element 664a moves together with the actuating pin 662a, and the inclination 665a of the wedge element 664a comes into abutment against an associated bevel 666a of the sealing profile 660a and pushes, by the interaction of the inclination 665a and the bevel 666a and against the restoring force of the restoring means 667a (as resetting springs shown in FIG. 34), the sealing profile 660a upwards so that the sealing profile 660a is extended upwards from the upper second sealing housing 651a. When the left and right glass doors are moved away from one another again, and the glass door opens in the open state shown in FIG. 34, the restoring means 667a cause the upwardly extended sealing profile 660a to be at least substantially vertically moved into the upper second sealing housing, so that, by interaction of both the inclination 665a and the bevel 666a, the actuating pin 662 is moved in the direction B again out of the upper second sealing housing 651a and the extraction mechanism is ready for a new actuation.

As also shown in FIG. 34, the upper second glass leaf frame element 630a may have an upper second functional end cap 640a covered by the right frame body longitudinal end 634a of the upper second frame body 632a and horizontally aligned with the right glass pane edge 622 of the second glass pane 620. The upper second functional end cap 640a defines a lateral, externally exposed front face 642a, which, in a closed state of the glass door apparatus, becomes the front face 542a of the opposing upper first functional end cap 542a, and a side rear face 643a which is spaced apart from the lateral front face 642a in a direction toward the right frame body longitudinal end 634a of the upper second frame body 632a and which is adjacent to the right frame body longitudinal end 634a of the upper second frame body 632a (wherein, for example, the rear face 643a forms the cover of the right frame body longitudinal end 634a).

Further, the upper second functional end cap 640a has a sealing receiving groove 690a, which extends at least substantially parallel to the pane face 621 of the second glass pane 620 from the lateral front face 642a of the upper second functional end cap 640a to the rear face 643a of the upper second functional end cap 640a and which opens vertically upwards and opens laterally outwardly in a direction away from the lateral front face 642a of the upper second functional end cap 640a, and a direction away from the rear face 643a of the upper second functional end cap 640a, wherein the upper second sealing 650a is partially received in the sealing receiving groove 690a. The upper second sealing 560a can be at least partially received in the upper second frame body 632a and at least partially received in the sealing receiving groove 690a of the upper second functional end cap 640a. For example, the sealing front face 652a of the upper second sealing 650a is received in its entirety in the sealing receiving groove 690a of the upper second functional end cap 640a.

The upper second glass door leaf element 630a may further include a upper second hook element 670a which is mounted on the rear face 643a of the upper second functional end cap 640a and has a hooking element 671a, wherein the housing longitudinal wall 654a of the upper second sealing housing 651a includes a hooking element receiving cavity 656a which is provided therein spaced apart from the housing front face 652a and into which the second hooking element 670a can engage or engages by reaching or gripping under the housing longitudinal wall 654a to thereby hold the upper second sealing 650a on the upper second functional end cap 640a. The interaction of the upper second hook element 670a with the upper second sealing 650a, as well as the shape and operation of the upper second hook element 670a and the hooking element receiving cavity 656a are at least substantially the same as those of the upper first hook element 570a and the hooking element receiving cavity 556a, so that a detailed description thereof is omitted.

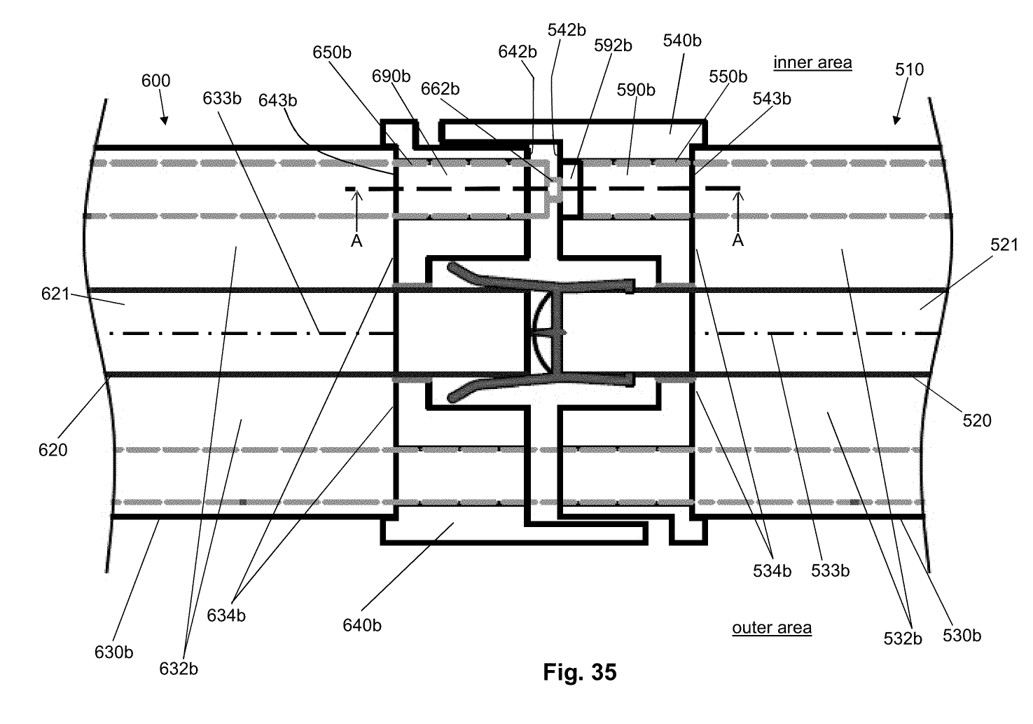

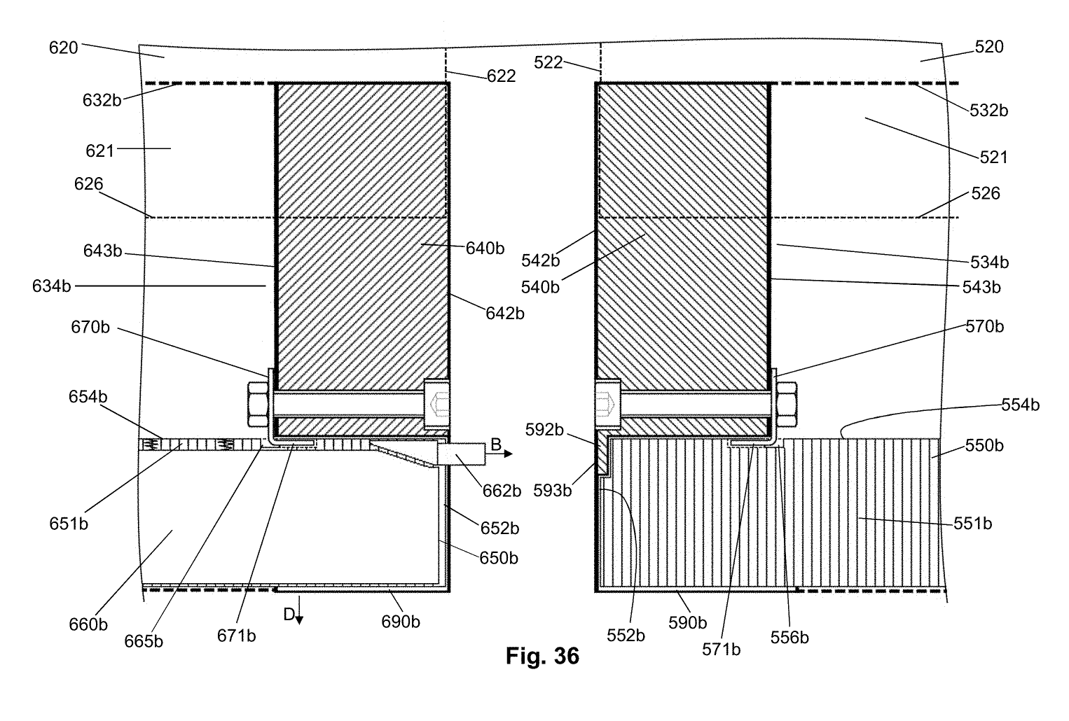

In the following, the second alternative according to the other aspect of the present invention will be described with reference to FIGS. 35 and 36, wherein FIG. 35 is a plan view of right and left glass door leaves in the closed state of the glass door, and wherein FIG. 36 is a partial sectional view along the line A-A shown in FIG. 35, in a (partial) open state of the glass door apparatus from an outer area.

The lower first glass leaf frame part 530b has an elongate lower first frame body 532b defining a longitudinal axis extending along its lower glass pane edge 526 of the first glass pane 520 along its lower glass pane edge 526 and having a left frame body longitudinal end 534b which is at least substantially similar to the lower first frame body 632b previously described in FIGS. 1 to 32.

Furthermore, the lower first glass door frame part 530b has a lower first functional end cap 540b (which is formed, for example, at least substantially as the lower second functional end cap shown in FIGS. 28 to 30) by which the left frame body longitudinal end 534b of the lower first frame body 532b is covered and which is arranged horizontally at the level of the left glass pane edge 522 of the first glass pane 520.

The lower first functional end cap 540b defines a lateral outwardly exposed front face 542b and a lateral rear face 543b which is spaced from the lateral front face 542b toward the left frame body longitudinal end 534b of the lower first frame body 532b and which is adjacent to the left frame body longitudinal end 534b of the lower first frame body 532b (wherein for instance the rear face 543b forms the cover of the left frame body longitudinal end 534b).

Furthermore, the lower first functional end cap 540b has a sealing receiving groove 590b, extending at least substantially parallel to the pane face 521 of the first glass pane 520 from the lateral front face 542b to the rear face 543b and opening vertically downwards as well as opening in the direction away from the lateral front face and away from the rear face of the lower first functional end cap 540b.

The lower first glass door frame part 530b also has a lower first hook element 570b, which is fixed to the rear face 543b of the lower first functional end cap 540 and has a hooking element 571b, and has a lower first sealing 550b which is at least partially housed in the lower first frame body 532b and is at least partially received in the sealing receiving groove 590b of the lower first functional end cap 540b and which has a lower first sealing housing 551b, for example of a metal material (for example, of aluminum material). The lower first sealing housing 551b has a housing front face 552b horizontally disposed at the level of the left glass pane edge 522 of the first glass pane 520 and extending at least substantially parallel to the left glass pane edge 522 of the first glass pane 520, and has an upper housing longitudinal wall 554b extending from the housing front face 552b in the direction toward the first glass pane 520 at least substantially parallel to the lower glass pane edge 526 of the first glass pane 520.

The upper housing longitudinal wall 554b of the lower first sealing housing 551b is recessed at a position that is spaced apart from the housing front face 552b of the lower first sealing housing 551b so that the hooking element 571b of the lower first hook element 570b engages (e.g., by reaching under) the upper housing longitudinal wall 554b of the lower first sealing housing 551b from below and thereby the lower first sealing 550b is held on the lower first functional end cap 540b (in particular in the vertical direction). For this purpose, the upper housing longitudinal wall 554b has a hooking element receiving cavity (for instance a milled groove) 556b, which is provided therein at a distance from in the housing lateral face 552b and into which the hooking element 571b of the first hook element 570b can engage or engages by reaching or gripping under the housing longitudinal wall 554b of the lower first sealing housing 551b to thereby hold the lower first sealing 550b on the lower first functional end cap 540a. The hooking element receiving cavity 556b may be dimensioned in the same manner as the hooking element receiving cavity 556a. Further, the hooking element 571b of the lower first hook element 570b can be inserted into the hooking element receiving cavity 556b in the same different manner as the hooking element 571a of the upper first hook element 570a. The lower first hook element 570b may further be formed in an analogous manner to the upper first hook element 570a, and similarly to the upper first hook element 570a may be connected to the rear face 543a of the upper first functional end cap 540a, so that a detailed description thereof will be omitted.

The lower first functional end cap 540b also has a stop portion 592b protruding into the sealing receiving groove 590b, against which an actuating pin, which is still to be described, of an extractable seal of the left glass door leaf 600 abuts. In FIG. 36, the stop portion 592b is formed by a wall portion of the lower first functional end cap 540b having a lateral outwardly exposed abutment face 593b which is part of the lateral front face 542b of the lower first functional end cap 540b. The housing front face 552b of the lower first sealing housing 551b is at least partially overlapped by the stop portion 592b of the lower first functional end cap 540b. As shown in FIG. 36, the stop portion 592b extends as a wall portion of the lower first functional end cap 540b at least over a portion of the lower first sealing housing 552b of lower first sealing housing 551b, which portion is offset in a manner at least substantially parallel to the pane face 521 of the first glass pane 520 as well as in a direction toward the first glass pane 520. By the offset portion of the housing front face 552b, a (for example, right angled) shoulder is formed on the housing front face 552b. The lower first sealing housing 551b may abut, for example, with the shoulder against the stop portion 592b.

Further, the lower second glass door leaf frame part 630b has an elongated lower second frame body 632b defining a longitudinal axis 633b extending with its longitudinal axis 633b along the lower glass pane edge 626 of the second glass pane 620 and having a right frame body longitudinal end 634b.

The lower second glass door leaf frame part 630b also has a lower second sealing 650b formed as an extractable seal, which sealing 650b is at least partially received in the lower second frame body 632b. The lower second sealing 650b has a lower second sealing housing 651b, which has a housing front face 652b (for example, at least substantially parallel to the right glass pane edge 622 of the second glass pane 620) and has an upper housing longitudinal wall 654b which extends from the housing front face 652b in the direction to the second glass pane 620 at least substantially parallel to the lower glass pane edge 626 of the second glass pane 620 and which extends substantially transversely to the pane face 621 of the second glass pane 620. The lower second sealing 650b also has an extractable sealing profile 660b (for example, an extractable sealing lip) which, in a non-extracted (or non-deployed) state, is received in the lower second sealing housing 651b and which can be moved at least substantially vertically upwards out of the lower second sealing housing 651b (in the direction of arrow D shown in FIG. 36) against an elastic restoring force.

The lower second sealing 650b also has an actuating pin 662b which protrudes outwards (for example in the direction of the first glass pane of the right glass door) with respect to the housing front face 652b of the lower second sealing housing 651b and which is movably configured (for example through the housing front face 652b of the lower second sealing housing 651b into the lower second sealing housing 651b) in such a way as to effect, in the course of its displacement, at least a substantially vertical extraction of the extractable sealing profile 660b of the lower second sealing 650b downwards against the elastic restoring force. The cooperation of the extractable sealing profile 660b and the actuating pin 662b of the lower second sealing 650b and the operation of the extraction mechanism are at least substantially analogous to the interaction of the extractable sealing profile 660a and the actuating pin 662a of the upper second sealing 650a and the functional of the extraction mechanism described (see FIG. 34), so that a detailed description thereof is omitted.

As shown in FIG. 36, the lower second glass leaves frame element 630b may have a lower second functional end cap 640b by which the right frame body longitudinal end 634b of the lower second frame body 632b is covered and which is horizontally positioned at the level of the right glass pane edge 622 of the second glass pane 620. The lower second functional end cap 640b defines a lateral outwardly exposed front face 642b which, in a closed state of the glass door apparatus, is adjacent to the lateral front face 542b of the opposing lower first functional end cap 542b, and defines a lateral rear face 643b which is spaced apart from the lateral front face 642b in the direction of the right frame body longitudinal end 634b of the lower second frame body 632b and is adjacent to the right frame body longitudinal end 634b of the lower second frame body 632b (wherein for example, the rear face 643b forms the cover of the right frame body longitudinal end 634b).

Further, the lower second functional end cap 640b has an sealing receiving groove 690b which extends at least substantially parallel to the pane face 621 of the second glass pane 620 from the lateral front face 642b of the lower second functional end cap 640b to the rear face 643b of the lower second functional end cap 640b and which opens vertically downwards and opens in the direction away from lateral front face 642b and the direction away from the rear face 643b of the lower second functional end cap 640b, wherein the lower second sealing 650b is partially received in the sealing receiving groove 690b. The lower second sealing 560b can be at least partially received in the lower second frame body 632b and can be at least partially received in the sealing receiving groove 690b of the lower second functional end cap 640b. For example, in particular, the sealing face 652b of the lower second sealing 650b is received in its entirety in the sealing receiving groove 690b of the lower second functional end cap 640b.

The lower second glass door frame element 630b may further include a lower second hook element 670b which is attached to the rear face 643b of the lower second functional end cap 640b and includes a hooking element 671b, wherein the housing longitudinal wall 654b of the lower second sealing housing 651b includes a hooking element receiving groove 656b which is provided therein spaced apart from the housing front face 652b of the lower second sealing housing 651b, so that the hook element 671b of the lower second hook element 670b engages (e.g., by reaching or gripping under) the housing longitudinal wall 654b of the lower second sealing housing 651b, and thereby the lower second sealing 650b is held on the lower second functional end cap 640b. The cooperation of the lower second hook element 670b with the lower second sealing 650b as well as the shape and operation of the lower second hook element 670b are at least substantially the same as those of the lower first hook element 570a, so that a detailed description thereof will be omitted.

The two alternatives of the other aspect of the present invention shown in FIGS. 33 to 36 can also be realized in a mirror image manner, in a similar manner, whereby the stop portion is formed on the left glass door, and the actuating pin of the extractable seal is provided on the right glass door leaf. Such a realization is for example shown in FIGS. 16 to 30, in which the upper and lower second functional end caps 340a, 340b of the left glass door leaf 100 have a wall portion 392a, 392b, which is constructed as shown in FIGS. 33 to 36.

Both in the first alternative as well as in the second alternative of the glass door apparatus according to the other aspect of the present invention, the respective first sealing 540a, 540b can be designed analogously to the respective second sealing as an extractable sealing. In the case of a glass door apparatus with more than two glass door leaves, for example with the exception of the outermost left and outermost right glass leaves, each glass door leaf is formed on its right side like the above-described left glass leaf 600, and on its left side like the right glass leaf 500 described above, wherein the outermost right glass leaf may be provided as the above said right leaf 600 only on its left side, and the outermost left glass door leaf can be formed only on its right side as the above-described left glass door leaf 600. It goes without saying that such a configuration is also possible in a correspondingly reversed manner (i.e., left to right, right to left).

According to the other aspect of the present invention, the durability and reliability of a glass door apparatus according to the other aspect of the present invention can be improved by forming an abutment portion so that an actuating pin of an extractable sealing of a second functional end cap does not abut against a front face of a first sealing opposite the actuating pin of first functional end cap, so that damage to the first sealing of the first functional end cap can be prevented. In particular, the use of the other aspect of the present invention is advantageous in the case of glass door leaves, of which at least one is designed as a sliding leaf or a rotary-sliding leaf, and their adjoining glass panes are moved toward each other by a sliding movement.

The functional end caps described throughout this application may be made, for example, of a plastic material and/or a metal material, such as an aluminum material. For example, the above-described functional end caps can be formed as a single piece (for example, from a single block of material). The functional end caps may be formed in various ways, for example by means of casting (for example, by injection molding) or extrusion, the manufacturing techniques not being limited to the foregoing. However, the functional end caps and/or individual elements thereof can also be produced by means of milling, drilling, etc. However, the functional end caps can also be composed of several parts, these parts being for example screwed together, welded, soldered and/or glued, etc. The frame bodies described throughout this application may be made, for example, of a plastic material and/or a metal material, such as an aluminum material (e.g., extruded aluminum).

According to the present invention a glass door apparatus is provided, wherein, according to one aspect, improved acoustic insulation, humidity and wind insulation characteristics are achieved, thereby providing a protection against noise, humidity (for instance pounding rain) and wind or currents, wherein according to another aspect, an improved durability and reliability of glass door apparatus are achieved.

1. A glass door apparatus, comprising:
a right glass door leaf (10), which has
a first glass pane (20) having a pane face (21) and which has a left glass pane edge (22), which extends at least substantially vertically; an upper glass pane edge (24), which extends at least substantially horizontally; and a lower glass pane edge (26), which extends at least substantially horizontally;
an upper first glass door leaf frame part (30a), which engages the upper glass pane edge (24) of the first glass pane (20); and
a lower first glass door leaf frame part (30b), which engages the lower glass pane edge (26) of the first glass pane (20), and
a left glass door leaf (100), which has
a second glass pane (20) having a pane face (121) and which has a right glass pane edge (122), which extends at least substantially vertically and which, in a closed state of the glass door apparatus, is near the left glass pane edge (22) of the first glass pane (20), wherein the second glass pane further has an upper glass pane edge (124), which extends at least substantially horizontally, and a lower glass pane edge (126), which extends at least substantially horizontally;
wherein at least one of the upper first glass door leaf frame part (30a) and the lower first glass door leaf frame part (30b) has a first oblong frame body (32a, 32b), which defines a longitudinal axis (33a, 33b), extends with its longitudinal axis (33a, 33b) along the glass pane edge belonging to the respective glass door leaf frame part of the upper and lower glass pane edges (24, 26) of the first glass pane (20) and has a left frame body longitudinal end (34a, 34b), and a first functional end cap (40a, 40b, 240a, 240b), by which the left frame body longitudinal end (34a, 34b) of the first frame body is covered and which
is horizontally positioned at level of left glass pane edge (22) of the first glass pane (20),
defines a lateral outwardly exposed front face (42a, 42b; 242a, 242b), and
has a first protrusion (52a, 52b; 252a, 252b), which, with respect to the lateral front face (42a, 42b; 242a, 242b) of the first functional end cap (40a, 40b; 240a, 240b), protrudes laterally outwards in a manner at least substantially parallel to the pane face (21) of the first glass pane (20) as well as in a direction away from the first glass pane (20), and/or a first cavity (54a, 54b; 254a, 254b) which, with respect to the lateral front face (42a, 42b; 242a, 242b) of the first functional end cap (40a, 40b; 240a, 240b), protrudes laterally inwardly in a manner at least substantially parallel to the pane face (21) and in a direction towards the first glass pane (20) and which, in the opposite direction, opens laterally outwardly; and
wherein, in the closed state of the glass door apparatus, the first protrusion (52a, 52b; 252a, 252b) and/or the first cavity (54a, 54b; 254a, 254b) of the first functional end cap (40a, 40b; 240a, 240b) is/are overlapped with a respectively corresponding complementary counterpiece of the left glass door leaf (120).

2. The glass door apparatus of claim 1, wherein the upper first glass door leaf frame part (30a) has a first oblong upper frame body (32a), which defines a longitudinal axis (33a), extends with its longitudinal axis (33a) along the upper glass pane edge (24) of first glass pane (20) and has a left frame body longitudinal end (34a), and an upper first functional end cap (40a; 240a), by which the left frame body longitudinal end (34a) of the upper first frame body (32a) is covered and which
is horizontally positioned at level of the left glass pane edge (22) of the first glass pane (20),
defines a lateral outwardly exposed front face (42a, 242a), and
has a first protrusion (52a, 252a), which, with respect to the lateral front face (42a, 242a) of the upper first functional end cap (40a, 240a), protrudes laterally outwards in a manner at least substantially parallel to the pane face (21) of the first glass pane (20) as well as in a direction away from the first glass pane (20), and/or a first cavity (54a, 254a) which, with respect to the lateral front face (42a, 242a) of the upper first functional end cap (40a, 240a), protrudes laterally inwardly in a manner at least substantially parallel to the pane face (21) and in a direction towards the first glass pane (20) and which, in the opposite direction, opens laterally outwardly, and
the lower first glass door leaf frame part (30b) has a first oblong lower frame body (32b), which defines a longitudinal axis (33b), extends, with its longitudinal axis (33b) along the lower glass pane edge (24) of the first glass pane (20) and has a left frame body longitudinal end (34b), and a lower first functional end cap (40b; 240b), by which the left frame body longitudinal end (34b) of the lower first frame body (32b) is covered and which
is horizontally positioned at the level of the left glass pane edge (22) of the first glass pane (20),
defines a lateral outwardly exposed front face (42b, 242b), and
has a first protrusion (52b, 252b), which, with respect to the lateral front (42b, 242b) of the lower first functional end cap (40b, 240b), protrudes laterally outwards in a manner at least substantially parallel to the pane face (21) of the first glass pane (20) as well as in a direction away from the first glass pane (20), and/or a first cavity (54b, 254b) which, with respect to the lateral front (42b, 242b) of the lower first functional end cap (40b, 240b), protrudes laterally inwardly in a manner at least substantially parallel to the pane face (21) and in a direction towards the first glass pane (20) and which, in the opposite direction, opens laterally outwardly; and
wherein, in the closed state of the glass door apparatus, the first protrusion (52a, 52b; 252a, 252b) and/or the first cavity (54a, 54b; 254a, 254b) of the respective first functional end cap (40a, 40b; 240a, 240b) is/are overlapped with a respectively corresponding complementary counterpiece of the left glass door leaf (100).

3. The glass door apparatus of claim 1, wherein the left glass door leaf (100) has an oblong weather strip (170; 370), which defines a weather strip longitudinal axis and which is positioned on the right glass pane edge of the second glass pane and which extends with its weather strip longitudinal axis along the right glass pane edge (122) of the second glass pane (120) and which has a profile cross-section with a first leg (172; 372), which extends at least substantially from the right glass pane edge (122) of the second glass pane (120) in a manner at least substantially parallel to the pane face (121) of the second glass pane (120) and laterally away from the second glass pane (120) so that, in the closed state of the glass door apparatus, the first leg (172; 372) overlaps the left glass pane edge (22) of the first glass pane (20) and engages, while forming a corresponding complementary counterpiece of the left glass door leaf, the first cavity (54a, 54b; 254a, 254b) of the respective first functional end cap (40a, 40b; 240a, 240b).

4. The glass door apparatus of claim 3, wherein the weather strip (170) has an h-profile cross-section comprising a central transverse web (174), which has a first transverse web end and a second transverse web end (175, 176), wherein the first leg (172) extends from the first transverse web end (175); a second leg (178), which extends from the first transverse web end (175) opposite to the first leg (172) and overlaps the right glass pane edge (122) of the second glass pane (120); and a third leg (180), which extends from the second transverse web end (176) in the same direction of the second leg (178) and overlaps the right glass pane edge (122) of the second glass pane (120).

5. The glass door apparatus of claim 4, wherein the respective first functional end cap (40a, 40b; 240a, 240b) also has a second cavity (56a, 56b; 256a, 256b) which, with respect to the lateral front (42a, 42b; 242a, 242b) of the respective first functional end cap (40a, 40b; 240a, 240b), protrudes laterally inwardly in a manner at least substantially parallel to the pane face (21) of the first glass pane (20) and in a direction towards the first glass pane (20) and which opens, in the opposite direction, laterally outwardly, and which, with respect to the pane face (21) of the first glass pane (20), is disposed opposite the first cavity (54a, 54b; 254a, 254b) of the respective first functional end cap (40a, 40b; 240a, 240b), so that a first functional block (58a, 58b; 258a, 258b) is formed between the first cavity and the second cavity of the respective first functional end cap (40a, 40b; 240a, 240b), with which first functional block the complementary counterpiece associated with the first cavity (54a, 54b; 254a, 254b) of the respective first functional end cap (40a, 40b; 240a, 240b) interacts, in the closed state of glass door apparatus, in an overlapping and abutting way.

6. The glass door apparatus of claim 5, wherein the first functional block (58a, 58b; 258a, 258b) has a lateral outwardly exposed functional block front face (60a, 60b; 260a, 260b) which is flush with a lateral front face (23) of the left glass pane edge (22) of the first glass pane (20) and forms an extension of the front face (23) of the left glass pane edge (22).

7. The glass door apparatus of claim 5, wherein the weather strip (370) has an H-profile cross-section with a fourth leg (382), which extends from the second transverse web end (376) away from the third leg (380) and which, in the closed state of the glass door apparatus, overlaps the left glass pane edge (22) of the first glass pane (20), and engages the second cavity (56a, 56b; 256a, 256b) of the respective first functional end cap (40a, 40b; 240a, 240b), while forming a further corresponding complementary counterpiece of the left glass door leaf (100).

8. The glass door apparatus of claim 7, wherein, in the closed state of the glass door apparatus, a gap formed between the second cavity (56a, 56b; 256a, 256b) of the respective first functional end cap (40a, 40b; 240a, 240b) and the further respective complementary counterpiece of the left glass door leaf (100) in a transversal direction with respect to the pane faces (21, 121) of the first and second glass panes (20, 120) is less or equal to a fifth of an overlapping length of the second cavity (56a, 56b; 256a, 256b) of the respective first functional end cap (40a, 40b; 240a, 240b) and the further respective complementary counterpiece of left glass door leaf (100).

9. The glass door apparatus of claim 2, wherein the left glass door leaf (100) also has an upper second glass door leaf frame part (130a), which engages the lower glass pane edge (124) of second glass pane (120), and
wherein the upper second glass door leaf frame part (130a) has an oblong upper second frame body (132a), which defines a longitudinal axis (133a), extends with its longitudinal axis (133a) along the upper glass pane edge (124) of the second glass pane (120) and has a right frame body longitudinal end (134a), and an upper second functional end cap (140a, 340a), by which the right frame body longitudinal end (134a) of the upper second frame body (132a) is covered and which
is horizontally positioned at level of the right glass pane edge (122) of the second glass pane (120),
defines a lateral outwardly exposed front face (142a; 342a), which, in a closed state of glass door apparatus, is near the lateral front face (42a; 141a) of the upper first functional end cap (40a; 240a), and
has a functional end cap side face (148a; 348a), which extends at least substantially parallel to the pane face (121) of the second glass pane (120); and
wherein the complementary counterpiece of the left glass door leaf associated with the first protrusion (52a; 252a) of the upper first functional end cap (40a; 240a) is formed by the functional end cap side face (148a, 348a) of the upper second functional end cap (140a; 340a), and wherein, in the closed state of glass door apparatus, the first protrusion (52a; 252a) of the upper first functional end cap (40a; 240a) is overlapping with the functional end cap side face (148a; 348a) of the upper second functional end cap (140; 340a).

10. The glass door apparatus of claim 9, wherein the upper second functional end cap (140a; 340a) also has a second protrusion (152a; 352a), which with respect to the pane face (121) of the second glass pane (120), is opposite the functional end cap side face (148a; 348a) of the upper second functional end cap (140a; 340a) and which, with respect to the lateral front face (142a; 342a) of the upper second functional end cap (140a; 340a), protrudes laterally outwards in a manner at least substantially parallel to the pane face (121) of the second glass pane (120) and in a direction away from the second glass pane (120),
wherein the upper first functional end cap (40a; 240a) has a functional end cap side face (48a; 248a), which, with respect to the pane face (21) of the first glass pane (20), is disposed opposite to the first protrusion (52a; 252a) of the upper first functional end cap (40a; 240a) and extends at least substantially parallel to the pane face (21) of the first glass pane (20), and
wherein, in the closed state of the glass door apparatus, the second protrusion (152a; 352a) of the upper second functional end cap (140a; 340a) overlaps with the functional end cap side face of the upper first functional end cap.

11. The glass door apparatus of claim 10, wherein the complementary counterpiece or a further complementary counterpiece of the left glass door leaf (100) associated with the first cavity (54a; 254a) of the upper first functional end cap (40a; 240a) is further formed by the second protrusion (52a; 352a) of the upper second functional end cap (140a; 340a).

12. The glass door apparatus of claim 9, wherein the left glass door leaf (100) has an oblong weather strip (170; 370), which defines a weather strip longitudinal axis and which is positioned on the right glass pane edge of the second glass pane and which extends with its weather strip longitudinal axis along the right glass pane edge (122) of the second glass pane (120) and which has a profile cross-section with a first leg (172; 372), which extends at least substantially from the right glass pane edge (122) of the second glass pane (120) in a manner at least substantially parallel to the pane face (121) of the second glass pane (120) and laterally away from the second glass pane (120) so that, in the closed state of the glass door apparatus, the first leg (172; 372) overlaps the left glass pane edge (22) of the first glass pane (20) and engages, while forming a corresponding complementary counterpiece of the left glass door leaf, the first cavity (54a, 54b; 254a, 254b) of the respective first functional end cap (40a, 40b; 240a, 240b).

13. The glass door apparatus of claim 12, wherein the weather strip (170) has an h-profile cross-section with a central transverse web (174), which has a first transverse web end and second transverse web end (175, 176), wherein the first leg (172) extends from the first transverse web end (175); a second leg (178), which extends from the first transverse web end (175) opposite to the first leg (172) and overlaps the right glass pane edge (122) of the second glass pane (120); and a third leg (180), which extends from the second transverse web end (176) in the same direction of the second leg (178) and overlaps the right glass pane edge (122) of the second glass pane (120).

14. The glass door apparatus of claim 13, wherein the respective second functional end cap (140a, 140b; 340a, 340b) also has a first cavity (154a, 154b; 354a, 354b), which, with respect to the lateral front face (142a, 142b; 342a, 342b) of the respective second functional end cap (140a, 140b; 340a, 340b), protrudes laterally inwards in a manner at least substantially parallel to the pane face (121) of the second glass pane (120) and in a direction towards the second glass pane (120) and which opens, in the opposite direction, laterally outwards, and a second cavity (156a, 156b; 356a, 356b), which, with respect to the lateral front face (142a, 142b; 342a, 342b) of the respective second functional end cap (140a, 140b; 340a, 340b), protrudes laterally inwards in a manner at least substantially parallel to the pane face (121) of the second glass pane (120) and in a direction towards the second glass pane (120) and which opens, in the opposite direction, laterally outwards and which, with respect to the pane face (121) of the second glass pane (120), is disposed opposite the first cavity (154a, 154b; 354a, 354b) of the respective second functional end cap (140a, 140b; 340a, 340b), so that a second functional block (158a, 158b; 358a, 358b) is formed between the first cavity and the second cavity of the respective second functional end cap (140a, 140b; 340a, 340b), wherein the second leg (178; 378) of the weather strip (170; 370) engages the first cavity (154a, 154b; 354a, 354b) of the respective second functional end cap (140a, 140b; 340a, 340b), and the third leg (180; 380) of the weather strip (170; 370) engages the second cavity (156a, 156b; 356a, 356b) of the respective second functional end cap (140a, 140b; 340a, 340b), wherein, optionally, the second functional block (158a, 158b; 358a, 358b) has a lateral outwardly exposed functional block front face (160a, 160b; 360a, 360b) which is flush with a lateral front face (123) of the right glass pane edge (122) of the second glass pane (120) and forms an extension of the front face (123) of the right glass pane edge (122).

15. The glass door apparatus of claim 9, wherein, in the respective second functional end cap (140a, 140b; 340a, 340b), at least one sealing element receiving vertical groove (186a, 186b; 386a, 386b) is formed, which extends at least substantially parallel to the right glass pane edge (122) of the second glass pane (120), protrudes laterally inwardly at the front face in a manner at least substantially parallel to the pane face (121) of second glass pane (120) as well as in a direction towards the second glass pane (120) and which opens, in the opposite direction, laterally outwardly and in which a sealing element is received, which sealing element protrudes laterally outwardly from the sealing element receiving groove (186a, 186b; 386a, 386b) of the respective second functional end cap (140a, 140b; 340a, 340b) in a manner at least substantially parallel to the pane face (121) of the second glass pane (120) and in a direction away from the second glass pane (120), and which sealing element, in a closed state of the glass door apparatus, interacts with the first functional end cap (40a, 40b; 240a, 240b), which is opposite the respective second functional end cap (140a, 140b; 340a, 340b).

16. The glass door apparatus of claim 2, wherein the left glass door leaf (100) also has a lower second glass door leaf frame part (130b), which engages the lower glass pane edge (126) of second glass pane (120), and
wherein the second lower glass door leaf frame part (130b) has an oblong lower second frame body (132b), which defines a longitudinal axis (133b), extends with its longitudinal axis (133b) along the lower glass pane edge (126) of the second glass pane (120) and has a right frame body longitudinal end (134b), and a lower second functional end cap (140a, 340b), by which the right frame body longitudinal end (134b) of the lower second frame body (132b) is covered and which
is horizontally positioned at level of the right glass pane edge (126) of the second glass pane (120),
defines a lateral outwardly exposed front face (142b; 342b), which, in a closed state of glass door apparatus, is near the lateral front face (42b; 141b) of the lower first functional end cap (40b; 240b), and
has a functional end cap side face (148b; 348b), which extends at least substantially parallel to the pane face (121) of the second glass pane (120); and
wherein the complementary counterpiece of the left glass door leaf associated with the first protrusion (52b; 252b) of the lower first functional end cap (40b; 240b) is formed by the functional end cap side face (148a, 348b) of the lower second functional end cap (140b; 340b), and wherein, in the closed state of glass door apparatus, the first protrusion (52b; 252b) of the lower first functional end cap (40b; 240b) is overlapping with the functional end cap side face (148b; 348b) of the lower second functional end cap (140; 340b).

17. The glass door apparatus of claim 16, wherein the lower second functional end cap (140b; 340b) also has a second protrusion (152b; 352b), which, with respect to the pane face (121) of the second glass pane (120), is disposed opposite to the functional end cap side face (148b; 348b) of the lower second functional end cap (140b; 340b) and which, with respect to the lateral front face (142b; 342b) of the lower second functional end cap (140b; 340b), protrudes laterally outwards in a manner at least substantially parallel to the pane face (121) of the second glass pane (120) and in a direction away from the second glass pane (120),
wherein the lower first functional end cap (40b; 240b) also has a functional end cap side face (48b; 248b), which, with respect to the pane face (21) of the first glass pane (20) is opposite the first protrusion (52b; 252b) of the lower first functional end cap (40b; 240b) and extends, at least substantially, parallel to the pane face (21) of the first glass pane (20), and
wherein, in the closed state of glass door apparatus, the second protrusion (152b; 352b) of the lower second functional end cap (140b; 340b) overlaps with the functional end cap side face (48b; 248b) of the lower first functional end cap (40b; 240b).

18. The glass door apparatus of claim 17, wherein the complementary counterpiece or a further complementary counterpiece of left glass door leaf (100) associated with the respective first cavity (54b; 254b) of the lower first functional end cap (40b; 240b) is further formed by the second protrusion (152b; 352b) of the lower second functional end cap (140b; 340b).

19. The glass door apparatus of claim 1, wherein, in the closed state of the glass door apparatus, a gap is formed between the respective first protrusion (52a, 52b; 252a, 252b) and the respective complementary counterpiece of the left glass door leaf (100) in a transversal direction with respect to the pane faces (21, 121) of the first and second glass panes (20, 120), wherein said gap is less or equal to a fifth of an overlapping length of the respective first protrusion (52a, 52b; 252a, 252b) with the corresponding complementary counterpiece of the left glass door leaf (100) and/or a gap is formed between the first cavity (54a,54b; 254a,254b) of the respective first functional end cap (40a, 40b; 240a, 240b) and the respective complementary counterpiece of the left glass door leaf (100) in a transversal direction with respect to the pane faces (21, 121) of the first and second glass panes (20, 120), wherein said gap is less or equal to a fifth of an overlapping length of the first cavity (54a,54b; 254a,254b) of the respective first functional end cap (40a, 40b; 240a, 240b) and the respective complementary counterpiece of the left glass door leaf (100).

20. The glass door apparatus of claim 1, wherein, in the respective first functional end cap (40a, 40b; 240a, 240b) at least one sealing element receiving vertical groove (86a, 86b; 286a, 286b) is also formed, which extends at least substantially parallel to the left glass pane edge (22) of the first glass pane (20), protrudes laterally inwardly at the front face in a manner at least substantially parallel to the pane face (21) of the first glass pane (20) as well as in a direction towards the first glass pane (20) and which opens, in opposite direction, laterally outwardly and in which a sealing element is received, which sealing element protrudes laterally outwardly from the sealing element receiving groove (86a, 86b; 286a, 286b) of the respective first functional end cap (40a, 40b; 240a, 240b) in a manner at least substantially parallel to the pane face (21) of the first glass pane (120) and in a direction away from the first glass pane (20), and which, in a closed state of the glass door apparatus, interacts with the left glass door leaf (100) in an abutting way.
